(19) United States
(12) Patent Application Publication
(10) Pub. No.: US 2026/0091356 A1
(43) Pub. Date: Apr. 2, 2026

(54) SYSTEMS AND METHODS FOR EXTENDING WATER FILTRATION MEMBRANE LIFETIME IN SELF-MEDIATED SALTLESS WHOLE HOME WATER TREATMENT SYSTEMS

(71) Applicant: Pentair Residential Filtration, LLC, Brookfield, WI (US)

(72) Inventors: Derek Sajdak, Fountain Hills, AZ (US); Robert Orvin Crowder, Lino Lakes, MN (US); Charles Bulger, Falcon Heights, MN (US); Ezra Coughlin, Minneapolis, MN (US); Vaughn Stetter, Maplewood, MN (US); Qirong Ke, Essen (DE)

(21) Appl. No.: 19/280,830

(22) Filed: Jul. 25, 2025

Related U.S. Application Data
(60) Provisional application No. 63/702,364, filed on Oct. 2, 2024.

(51) Int. Cl. B01D 65/02; C02F 1/00; C02F 1/44; C02F 1/68; C02F 9/00

(52) U.S. Cl. CPC B01D 65/02; C02F 9/00; B01D 2321/12; B01D 2321/16; B01D 2321/2066; B01D 2321/28; B01D 2321/282; B01D 2321/40; C02F 1/004; C02F 1/44; C02F 1/685; C02F 2201/005; C02F 2303/16

(57) ABSTRACT

A water treatment system includes a source of inlet water, a prefiltration unit, a feeder, a pump, and a membrane element. The prefiltration unit is in fluid communication with the source and provides a prefiltered water to a prefiltered water line. The feeder is in fluid communication with the prefiltered water line and is positioned downstream of the prefiltration unit. The feeder is designed to deliver a chemical additive to the prefiltered water. The pump is in fluid communication with the prefiltered water line and a permeate flush line, and the pump is designed to increase a flow rate of water in a membrane feed line. The membrane element includes an inlet that is in fluid communication with the pump via the membrane feed line. The membrane element produces a permeate imparted with a first concentration of solutes and a retentate imparted with a second concentration of solutes.

### CROSS-REFERENCE TO RELATED APPLICATIONS

This application claims priority to U.S. Provisional Patent Application Ser. No. 63/702,364, filed on Oct. 2, 2024, entitled “SYSTEMS AND METHODS FOR EXTENDING WATER FILTRATION MEMBRANE LIFETIME IN SELF-MEDIATED SALTLESS WHOLE WATER TREATMENT SYSTEMS AND METHODS,” currently pending, the entire disclosure of which is incorporated herein by reference.

### FIELD OF DISCLOSURE

The present disclosure relates generally to systems and methods for extending water filtration membrane lifetime in water treatment systems, and more specifically to extending water filtration membrane lifetime in self-mediated saltless whole home water treatment systems.

### BACKGROUND

Hard water, which is water that contains a high concentration of mineral ions, is a common problem. The most common mineral ions found in hard water are calcium and magnesium, although other metals such as iron, aluminum, manganese, lead, and copper may also be found in hard water. According to the American National Standards NSF/ANSI 44 and NSF/ANSI 330, measured water hardness values of 1 grain per gallon (or 17.1 milligrams per liter) or higher is indicative of hard water. Water may be characterized based on various levels of hardness as shown in Table 1 below.

TABLE 1

| | MILLIGRAMS | |
|---|---|---|
| GRAINS PER GALLON | PER LITER | WATER HARDNESS |
| Less than 1 | Less than 17.1 | Soft |
| 1-3.5 | 17.1-60 | Slightly Hard |
| 3.5-7 | 60-120 | Moderately Hard |
| 7-10 | 120-180 | Hard |
| Over 10 | Over 180 | Very Hard |

The use of hard water can cause several issues including, among others: dry skin and hair, strange odor or taste to water, dingy cloths, spots on dishes, low water pressure, scale deposits in plumbing and bathroom fixtures, and/or premature appliance breakdown.

Currently, several technologies are available to soften hard water for use in residential or commercial properties. The most common water softening technology is a resin water softener system, which uses an ion exchange resin to remove hard water minerals such as calcium and magnesium from the water. In a resin water softener system, resin beads are placed inside a tank of the water softener system to form a “bed”. Over time, however, the resin bed becomes saturated with the exchanged hardness ions. To regenerate the resin bed for repeated use, a monovalent salt or brine must be added to the tank to flush out the saturated ions. The regenerated water is drained out of the softener tank and the resin is then ready for reuse.

While resin-based water softeners are effective at removing hardness from water, there are several disadvantages. First, the resin bed needs to be regenerated for repeated use to remove hardness from the water, which increases maintenance costs. Second, resin-based systems require additional water for flushing the resin bed during the regeneration process and a drain for removing the regenerated water; thus, wastewater is produced and a larger footprint in a residence or commercial space is required for the system.

Another technology that may be used to combat hard water is template assisted crystallization (TAC) technology. However, TAC technology is a water conditioning technology and does not soften water. More specifically, TAC systems do not remove calcium and magnesium ions from water. Rather, they provide nucleation sites that induce the formation of microscopic crystals of calcium and magnesium, the microscopic crystals then freely pass through the media and do not readily attach to pipes or appliances.

The benefits of TAC technology include that such systems do not need to be regenerated with salt and do not need to be connected to a drain for flushing out retentate water as with resin water softening systems. Some disadvantages of TAC water conditioners is that they are not well suited for extremely hard water. Resin water softeners are currently the best option for softening extremely hard water. In addition, TAC water conditioners do not remove iron. Thus, TAC water conditioners require an iron purifier to remove iron from hard water. TAC water conditioners also still allow for some hard water to form scale, though only in small amounts. Finally, the benefits to skin, hair, clothing, and dishes are also negligible with TAC systems.

To meet environmental regulation and customer demand for meaningful saltless water softening membrane technology has been developed for softening water for residential and commercial use. In particular, Reverse Osmosis (RO) and Nanofiltration (NF) membrane technology have been applied as these membranes remove both total dissolved solids (TDS) and hardness, although to different degrees depending on the operating conditions. Reverse osmosis (RO) systems remove ions, TDS, unwanted particles, micropollutants, bacteria, viruses, and other contaminants by using pressure to force the untreated water through a partially permeable water filtration membrane. As the untreated water passes through the partially permeable membrane, the ions, TDS, unwanted particles, micropollutants, bacteria, viruses, and other contaminants may be trapped by the RO membrane. However, current RO membrane system designs are complex, require a large footprint, and/or are expensive, which hinders their acceptance by homeowners or commercial end users. In addition, many current systems lack features which can protect the RO membrane or reverse RO membrane degradation, especially as unwanted substances accumulate within the membrane, which in turn can reduce the membrane's performance and lifetime. Moreover, operating current RO membrane systems at high recoveries increases the rate at which the membranes foul, which may increase the costs of the systems for consumers.

Furthermore, membrane-based saltless whole home water treatment systems typically rely on either a pressurized bladder tank or an atmospheric tank to deliver the softened water to the point of use (POU). If a bladder tank is used, the tank pressure and the line pressure drop when water is dispersed, and the water supply may be interrupted. If an atmospheric tank is used, the water must be repressurized with a pump to meet the required line pressure for water delivery to the POU. The filling and emptying of an atmospheric tank also require air exchange, which offers a possibility for contaminants such as airborne bacteria to enter the system and may have a limited supply of filtered water depending on the size of the reservoir.

Therefore, to overcome the drawbacks of the current water treatment systems and methods, the present disclosure recognizes the need for an improved saltless whole home water treatment for residential and commercial uses. Additionally, there is a need for systems and methods for extending water filtration membrane lifetime in self-mediated saltless whole home water treatment systems.

### SUMMARY

The present systems, methods, and apparatuses overcome many of the shortcomings and limitations of the prior art devices and systems described above. The systems, methods, and apparatuses described include several embodiments of a saltless water treatment system and associated methods.

In one aspect, a water treatment system is provided in the form of a source of inlet water, a prefiltration unit, a feeder, a pump, and a membrane element. The prefiltration unit is in fluid communication with the source and is designed to provide a prefiltered water to a prefiltered water line. The feeder is in fluid communication with the prefiltered water line and is positioned downstream of the prefiltration unit, and the feeder is designed to deliver a chemical additive to the prefiltered water. The pump is in fluid communication with the prefiltered water line and a permeate flush line, and the pump is designed to increase a flow rate of water in a membrane feed line. The membrane element includes an inlet that is in fluid communication with the pump via the membrane feed line. The membrane element produces a permeate comprising water imparted with a first concentration of solutes and a retentate comprising water imparted with a second concentration of solutes.

In some instances, the water treatment system also includes a first sensor, a second sensor, and a controller. The first sensor is in fluid communication with the source and is designed to measure a first parameter of the inlet water, and the second sensor is in fluid communication with the membrane element and is designed to measure a second parameter of the permeate. The controller is in communication with the first sensor and the second sensor, and is designed to receive the first parameter and the second parameter. The controller determines whether to initiate a chemical cleaning or a physical cleaning of the membrane element based at least partially on the first parameter and the second parameter. In addition, each of the chemical cleaning and the physical cleaning is designed to mitigate membrane fouling. In some such instances, the chemical cleaning of the membrane element is selected from the group consisting of a membrane flush, a membrane rinse, a membrane soak, a clean-in-place process, and combinations thereof. In such instances, the controller directs delivery of the chemical additive to the membrane element during the chemical cleaning of the membrane element and also directs delivery of the permeate to the inlet of the membrane element during the chemical cleaning of the membrane element.

In certain instances, the feeder is designed to provide the chemical additive during a chemical cleaning of the membrane element, and the chemical additive is selected from the group consisting of a polyphosphate compound, a chelating agent, an acidic compound, an antiscalant compound, a caustic compound, an oxidizing compound, a prebiotic, an enzymatic cleaner, and combinations thereof.

In some instances, the permeate flush line is in fluid communication with the membrane feed line and a valve is in fluid communication with the permeate flush line. The valve is designed to selectively provide the permeate to the inlet of the membrane element during a physical cleaning and a chemical cleaning of the membrane element.

In certain instances, the water treatment system also includes a controller designed to initiate a physical cleaning of the membrane element. The physical cleaning is selected from the group consisting of a membrane flush, a membrane rinse, a membrane soak, and combinations thereof. In some such instances, the water treatment system further includes a valve in fluid communication with the membrane element and the permeate flush line, and at least one of the pump and the valve provides a high-velocity water stream to the membrane element during the membrane flush. In other such instances, the water treatment system further includes a valve in fluid communication with the membrane element and the permeate flush line, and at least one of the pump and the valve provides a pulsed water stream to the membrane element during the membrane flush.

In another aspect, a water treatment system is provided in the form of a source of untreated water, a pump, a membrane element, a first sensor, a second sensor, and a controller. The source of untreated water is in fluid communication with an inlet line of the water treatment system, and the pump is in fluid communication with the source of untreated water. The membrane element is in fluid communication with the pump via a membrane feed line, and the membrane element is configured to produce a permeate stream and a retentate stream. The permeate stream is provided to a permeate line and the retentate stream is provided to a retentate line. In addition, an outlet line is in fluid communication with the permeate line. The first sensor is in fluid communication with the membrane element and is configured to sense a first parameter corresponding to a health of the membrane element. The controller is in electrical communication with the first sensor and is configured to initiate a cleaning of the membrane element.

In some instances, the controller is configured to initiate the cleaning of the membrane element when the first parameter crosses a threshold value, and the threshold value is indicative of membrane fouling.

In certain instances, the cleaning of the membrane element comprises a membrane flush provided as a high-velocity water stream to the membrane element through the membrane feed line.

In some instances, the cleaning of the membrane element comprises a soak of the membrane element, the soak includes providing an aqueous solution to the membrane element through the membrane feed line, and the aqueous solution comprises at least one of low TDS water, prefiltered water, untreated water, permeate water, and water dosed with a chemical additive.

In certain instances, the water treatment system also includes a retentate valve configured to control a flow of the retentate stream provided from the water treatment system, and the retentate valve is designed to selectively increase a flow rate of water through the membrane element.

In some instances, the controller is configured to initiate the cleaning of the membrane element when the first parameter crosses a threshold value. In some such instances, the first parameter is selected from the group consisting of a membrane element flux, a TDS output of the membrane element, a membrane rejection value, a membrane salt passage value, a pressure upstream of the membrane element, an RTD value, and combinations thereof.

In certain instances, the water treatment system also includes a prefiltration unit positioned downstream of the source of untreated water and upstream of the membrane element, and a tank downstream of the membrane element. The tank is configured to store prefiltered water from the prefiltration unit and the permeate stream from the membrane element. In some such instances, the water treatment system further includes a permeate flush line in fluid communication with the tank and the membrane element and a valve in fluid communication with the permeate flush line. In addition, the controller is configured to actuate the valve to provide permeate to the membrane element during the cleaning of the membrane element.

In some instances, the cleaning of the membrane element includes providing a chemical additive to the membrane element, and the chemical additive is selected from the group consisting of a polyphosphate compound, a chelating agent, an acidic compound, an antiscalant compound, a caustic compound, an oxidizing compound, a prebiotic, an enzymatic cleaner, and combinations thereof.

In a further aspect, a method of treating water includes providing a water treatment system including a membrane element, performing diagnostics at a first time period to determine a membrane element performance, thereby determining a first diagnostic result, performing diagnostics at a second time period to determine a membrane element performance, thereby determining a second diagnostic result, and choosing an action depending on at least one of the first diagnostic result and the second diagnostic result. The action comprises at least one of initiating a physical cleaning process, initiating a chemical cleaning process, maintaining normal function of the water treatment system, resuming normal function of the water treatment system, initiating the physical cleaning process at regular intervals, and initiating the chemical cleaning process at regular intervals. In some such instances, choosing an action includes selecting at least two of the aforementioned actions.

In some instances, performing diagnostics includes at least one of measuring flux across the membrane element, measuring TDS output of the membrane element, measuring characteristics of water provided to the membrane element, measuring membrane rejection, measuring pressure upstream of the membrane element, and determining an RTD value.

In certain instances, each of the physical cleaning process and the chemical cleaning process includes utilizing mechanical cleaning techniques, temperature-based cleaning techniques, and time-based cleaning techniques.

These and other aspects and advantages of the present disclosure will become apparent to those skilled in the art after considering the following detailed description in connection with the accompanying drawings.

### BRIEF DESCRIPTION OF DRAWINGS

FIG. 1 is a schematic diagram of an embodiment of a saltless water treatment system;

FIG. 2 is a schematic diagram of another embodiment of a saltless water treatment system;

FIG. 3A is a partial isometric view of a front, right side, and top view of a saltless water treatment system;

FIG. 3B is a front isometric view of the saltless water treatment system of FIG. 3A;

FIG. 3C is a back isometric view of the saltless water treatment system of FIG. 3A;

FIG. 4A is a schematic diagram of an embodiment of a saltless water treatment system;

FIG. 4B is a schematic diagram of another embodiment of the saltless water treatment system of FIG. 4A;

FIG. 4C is a schematic diagram of another embodiment of the saltless water treatment system of FIG. 4A;

FIG. 4D is a schematic diagram of another embodiment of the saltless water treatment system of FIG. 4A;

FIG. 4E is a schematic diagram of another embodiment of the saltless water treatment system of FIG. 4C;

FIG. 5 is a schematic block diagram of an embodiment of a control system for a saltless water treatment system;

FIG. 6 is another embodiment of the water treatment system of FIG. 3A;

FIG. 7 is a schematic diagram of an embodiment of an operational cycle of the saltless water treatment systems of FIGS. 2, 3A-3C, and 4A-4E;

FIG. 8 is a flowchart of an embodiment of a method of treating water using the saltless water treatment systems of FIGS. 1, 2, 3A-3C, and 4A-4E;

FIG. 9 is a is a flowchart of an embodiment of a method of treating water using the saltless water treatment systems of FIGS. 1, 2, 3A-3C, and 4A-4E;

FIG. 10 is a graph representing gallons of water processed by a membrane system versus permeate TDS values, the graph illustrating failure points of the membrane system when various polyphosphate compounds are used as antiscalants;

FIG. 11 is a graph representing performance of a membrane element and comparing the performance of the membrane element when treated with consistent permeate flushes versus the performance of the membrane element when treated with inconsistent permeate flushes; and

FIG. 12 is a graph representing performance of another membrane element and comparing the performance of the membrane element when treated with consistent permeate flushes versus when no membrane flushes were provided.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

At a high level, embodiments of the water treatment systems disclosed herein may include multiple system components that may be located at various locations or points within the water treatment systems. Although other fluids may be processed by the water treatment systems disclosed herein, for purposes of discussion and illustration, the present disclosure will refer to all possible fluids simply as water.

Some embodiments of the water treatment systems disclosed herein may include one or more pipes, conduits, tubing, or other feed or fluid transfer lines, which may connect system components and form a fluid circuit and/or fluid flow path, and allow water to flow from an inlet, through the water treatment system, to an outlet.

Some embodiments of the water treatment systems may include one or more valves to control and regulate water flow into, through, and out of the water treatment system. For example, in some embodiments, the valves may be provided in the form of a gate valve, check valve, or an actuated ball valve. Some embodiments of the water treatment systems may include one or more prefiltration units to remove sediment, certain chemicals, organics, and other undissolved impurities from inlet water. For example, in some embodiments, the prefiltration units may include a sediment filter or carbon filter. Some embodiments of the water treatment systems may include one or more sensors to measure, monitor, or sense variations in the water at different points in the system including dissolved sediment levels, water conductivity, water flow rates, water temperature, water pressure, water clarity, water volume, ion concentration, or water alkalinity. For example, in some embodiments, the sensors may be provided in the form of a total dissolved solids (TDS) sensor or probe, a flowmeter, a temperature sensor, a pressure sensor or transducer, an oxidation reduction potential (ORP) probe, a colorimeter sensor, an ion-selective electrode sensor, a volume-based batching sensor, and/or a pH sensor.

Some embodiments of the water treatment systems may include one or more membrane elements to remove hardness minerals, micropollutants, bacteria, viruses, and other contaminants from the water. In some embodiments, the membrane elements may be provided in the form of a RO membrane or a NF membrane. Some embodiments of the water treatment systems may include one or more feeders for introducing chemical cleaning agents or chemical additives to the water. Some embodiments of the water treatment systems may include one or more pumps to control or regulate water pressure in the system. Some embodiments of the water treatment systems may include one or more storage or retention tanks for holding or storing water that may have been filtered by a prefiltration unit or treated by a membrane element. Some embodiments of the water treatment systems may include one or more valves or capillary flow restrictors to regulate the flow of retentate exiting the system. Furthermore, some embodiments of the water treatment systems may include one or more control systems that may include a controller for monitoring, controlling, and communicating with one or more system components including, the valves, sensors, feeders, or pumps. The control system may also include one or more display panels or screens for providing information about the water treatment system to a user.

Embodiments of the water treatment systems disclosed herein may be self-mediating in that the flow of water through the water treatment systems may be controlled or regulated by the physical equilibrium of hydrodynamic forces such that actuated valves, pumps, or flow controllers may not be needed depending on flow conditions. More specifically, water pressure in the various lines of the water treatment system may be retained such that as water flows out of one area of the water treatment system, the pressure in such area may decrease. Water in other areas may then flow toward the area with lower pressure until an equilibrium of pressure within the system is reached. In some embodiments, a pressurized retention tank may be filled with water and the flow of water into and out of a retention tank may be automatic such that actuated valves or flow controllers may not be required or may be omitted for certain operations.

In some embodiments, the systems and methods described herein may be designed to extend water filtration membrane lifetime. For example, the whole home treatment system may comprise a water treatment system provided in the form of a tank and a water filtration membrane. The water filtration membrane may be provided as a permeable or semi-permeable reverse osmosis (RO) membrane. Untreated water may be pushed through a the RO membrane using pressure provided by a pump of the water treatment system. The RO membrane may be designed to remove minerals including calcium and magnesium ions and, optionally, other impurities from water provided to the tank (e.g., ions other than magnesium and calcium, TDS, unwanted particles, micropollutants, bacteria, virus particles, and other contaminants). The treated or mineral-depleted water produced by the RO membrane may then be provided to an outlet conduit and ultimately to an end user. The apparatus comprising an RO membrane may be configured to remove divalent and/or trivalent cations, such as calcium ions and magnesium ions, from hard water (e.g., water imparted with a hardness of at least about 7 grains per gallon or at least about 120 milligrams per liter) provided from various sources. In some instances, the water treatment system including the RO membrane may be configured to reduce scale-forming ions (e.g., calcium ions and magnesium ions) to levels at which scale formation is unlikely.

Ions in solution (e.g., ions in water streams within the RO membrane) may form precipitates on or within the RO membrane, including scale on the surface of the RO membrane. The scale formation occurs when the ions are concentrated at the RO membrane surface, forming a saturated solution or a supersaturated solution. If a concentrated solution (e.g., the retentate) is held stagnant against the RO membrane surface, the lifetime and performance of the RO membrane may be severely impacted.

The systems and methods disclosed herein may include processes for extending the lifetime of the membrane element. Such processes may include using a permeate flush and soak, and/or a forward membrane flush at a high flow rate, and the other membrane cleaning processes described herein. The process of ions forming scale on the membrane surface is not instantaneous. If the concentrated solution is rinsed off the membrane quickly, ions in the solution may not have time to precipitate and form scale. Various systems and methods are provided in which the membrane is flushed with water imparted with a low mineral concentration or water dosed with a chemical additive to help prevent scale formation. In addition, high velocity may be used to further encourage the displacement of unwanted foulants. In various instances, the chemical additive may comprise, consist essentially of, or consist of a polyphosphate compound, a chelating agent, an acidic compound, an antiscalant compound, a caustic compound, an oxidizing compound, a prebiotic, and/or an enzymatic cleaner. In other instances, the chemical additive may be selected from the group consisting of a polyphosphate compound, a chelating agent, an acidic compound, an antiscalant compound, a caustic compound, an oxidizing compound, a prebiotic, an enzymatic cleaner, and combinations thereof.

The systems and methods provided for extending water filtration membrane lifetime can include physical cleaning processes and/or chemical cleaning processes provided in the form of mechanical, and/or time-based cleaning techniques. For example, the physical cleaning processes may include a membrane flush process, a membrane rinse process, and/or a membrane soak process, said processes utilizing inlet water or permeate water. As an additional example, the chemical processes may include a membrane flush process, a membrane rinse process, a membrane soak process, and/or a membrane clean-in-place process, said processes utilizing the chemical additive.

The systems and methods provided for extending water filtration membrane lifetime can include physical cleaning processes and/or chemical cleaning processes such as mechanical, temperature, and/or time-based cleaning techniques. For example, the physical cleaning processes can include a membrane flush process, a membrane rinse process, and/or a membrane soak process, in which a membrane flush process, a membrane rinse process, and/or a membrane soak process utilizes inlet water or permeate water. The temperature-based cleaning techniques may utilize a temperature control device (e.g., an electrical heating element, a heat exchanger) designed to raise and/or lower the temperature of the streams provided to the RO membrane during cleaning, which in turn can improve the solubility of certain ions and precipitates. The chemical processes can include a membrane flush process, a membrane rinse process, a membrane soak process, and/or a membrane clean-in-place process, in which the aforementioned processes utilize the chemical additive.

The systems and methods provided for extending water filtration membrane lifetime can include adding the chemical additive (e.g., a chelation agent, a polyphosphate compound, an acidic compound, anti-scaling agents, and/or a prebiotic) to the water before the water is provided to the RO membrane.

The systems and methods provided for extending water filtration membrane lifetime can include adding a chemical additive (e.g., a chelation agent, a polyphosphate compound, and/or an acidic compound) before the water is provided to the membrane element as a rinse or soak.

The systems and methods provided for extending water filtration membrane lifetime can include using one or more clean-in-place processes. Generally, a clean-in-place process may include the automated or semi-automated circulation of cleaning solutions (e.g., chemical additives), through the internal surfaces of system components such as the water filtration membrane. In addition, the clean-in-place process may not require disassembly of the water filtration membrane or the other components cleaned using the clean-in-place process. The clean-in-place process may include pre-rinsing the water filtration membrane with water to remove loose contaminants, introducing and circulating one or more chemical additives to dissolve or dislodge fouling and biofilm, rinsing of the water filtration membrane to flush out residual chemicals and contaminants. In some cases, an additional rinse of the water filtration element may be provided to help ensure removal the chemical additive. The clean-in-place process may enable efficient and repeatable cleaning of the water filtration element, which may help reduce system downtime, maintain optimal performance of the water filtration element, and extend the operational life of the water filtration element.

Additionally, various diagnostics for determining membrane life, algorithms to coordinate the function of the pump with the various methods for cleaning and/or preserving the health of the RO membrane, and a display including a color indicator to indicate RO membrane function, health, and lifetime are provided.

Furthermore, the system may be provided with a controller that is designed to trigger, initiate, or start implementation of the various methods for cleaning and/or preserving the RO membrane. The controller can utilize a remote monitoring system, including an internet- or cellular-connected system to, by way of example, monitor system use, membrane function, and water conditions.

It is to be understood that the various physical cleaning processes and/or chemical cleaning processes described herein (such as mechanical, temperature, and/or time-based cleaning techniques) may be initiated separately, sequentially, at the same time, at predetermined times, once, more than once, and/or under other similar operating conditions. In addition, the various physical cleaning processes and/or chemical cleaning processes may be manually implemented or initiated by a controller.

Embodiments of a water treatment system disclosed herein provide several advantages over current water treatment systems. One advantage of the water treatment systems disclosed provide for a simplified saltless water treatment system. For example, the water treatment systems may operate with only a single pump and tank. Another advantage of the unique design of the water treatment systems disclosed is that the water treatment systems enable a continuous supply of water to a point of use in a residential or commercial property. For example, the tank may be in fluid communication with inlet water via a prefiltration unit such that prefiltered water may flow through the tank directly to an outlet, rather than having to first go through a membrane element. Providing the storage tank in parallel with the membrane element enables the water treatment system to always provide water to a point of use within a residential or commercial property even during high-demand periods. Further, the water treatment systems disclosed herein use physical equilibrium of hydrodynamic forces to help ensure that water may always be supplied to a point of use, even if there is a power outage, unless the water source is a well. Furthermore, the water treatment system utilizes a prefiltration unit such that the residential or commercial property may always have at least some level of filtered water flowing to a point of use, even if the inlet water is not provided to the membrane element before being provided to the point of use.

Another advantage of the embodiments of a water treatment system disclosed herein is that the unique design of the water treatment system enables the membrane element to operate at least about an 80% recovery rate, at least about an 85% recovery rate, or at least about a 90% recovery rate or greater, which minimizes the amount of wastewater produced. To enable such a high recovery rate, the water treatment systems disclosed may use, for example, a prefiltration unit to remove larger particulates (e.g., particulates with a diameter of greater than about 5 microns) from the inlet water to minimize the clogging of pores in the membrane element. In addition, in some embodiments of the water treatment system disclosed herein, a permeate flush, e.g., low TDS water, may be used to clean the membrane element. Low TDS water may be any water imparted with a TDS concentration lower than the TDS concentration of the inlet water provided to the system. Additionally, or alternatively, low TDS water may be water imparted with a TDS concentration of less than about 3.5 grains per gallon (60 milligrams per liter). Using a permeate flush to clean the membrane as part of the operational cycle of the water treatment system minimizes the build-up of scale on the membrane element because the surface of the membrane element may not be habitually exposed to water with a high TDS content. High TDS water may be water imparted with a TDS concentration that is about equal to or greater than the TDS concentration of the inlet water entering the system. Additionally, or alternatively, high TDS may be water imparted with a TDS concentration greater than about 3.5 grains per gallon (60 milligrams per liter). Furthermore, in some embodiments of the water treatment systems disclosed herein, a chemical additive released by a feeder may be used to maintain membrane element health.

A further advantage of the embodiments of a water treatment system disclosed herein is the use of one or more sensors that may be in communication with a control system that may be Internet of Things compatible. Thus, the water treatment system may allow for remote monitoring, control, and troubleshooting, and enable connection and communication with other user devices (e.g., a mobile phone). In some embodiments, the water treatment system may use one or more sensors to detect potential operational or component issues and self-diagnose. For example, the measurements provided by the one or more sensors may be used by the control system in combination with another sensor of the same type (e.g., one or more TDS sensors) or a sensor of a different type (e.g., a flowmeter in combination with a pressure sensor) to monitor the health of a membrane element, to trigger the pump on or off, and/or to detect a condition (e.g., an increase in the amount of high TDS water in the tank).

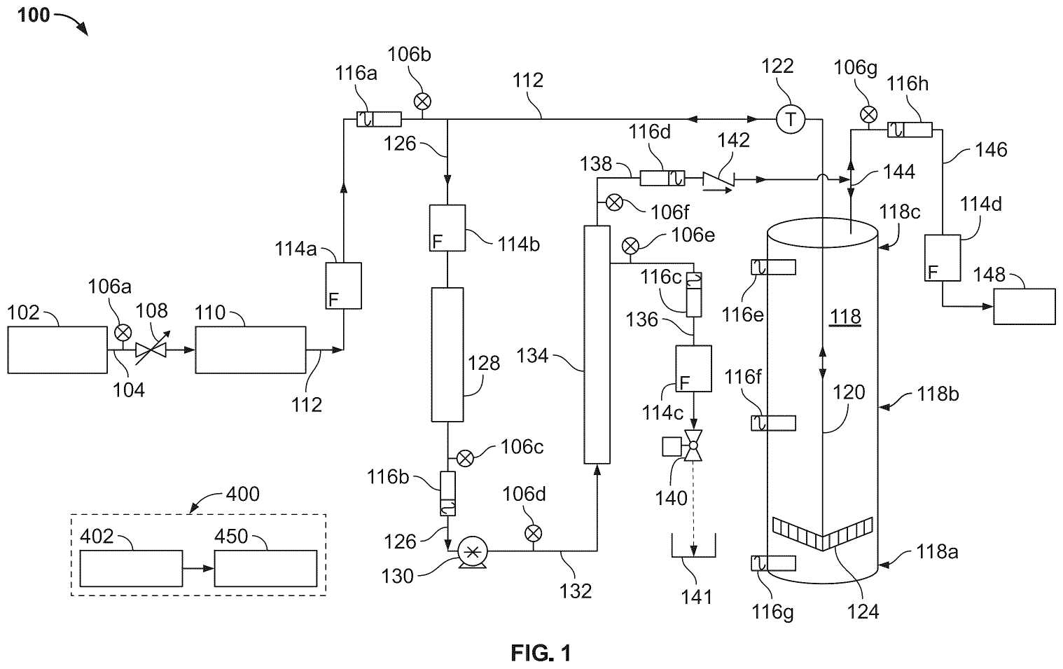

FIG. 1 illustrates an embodiment of a water treatment system 100. The water treatment system 100 may include an inlet 102 through which inlet water (e.g., hard water) enters the water treatment system 100. The inlet water may pass through a prefiltration unit 110, where the inlet water may be filtered, and sediment or other contaminants may be removed. The prefiltered water may flow into a tank 118 where the prefiltered water is stored for future processing by a membrane element 134 of the water treatment system 100. The prefiltered water may also flow into and through the tank 118 to an outlet 148 of the water treatment system 100 for immediate use. Alternatively, or additionally, the prefiltered water may flow toward the membrane element 134 after passing through the prefiltration unit 110. As the prefiltered water flows toward the membrane element 134, the prefiltered water may pass a feeder 128, which is designed to add a chemical additive to the prefiltered water. In some instances, the feeder 128 may be positioned elsewhere in the system 100 (e.g., downstream of the pump 130 or downstream of the membrane element 134). After passing the feeder 128, the prefiltered water may flow through the membrane element 134. A pump 130 located on a feed side of the membrane element 134 may be used to direct the prefiltered water toward the membrane element 134. The membrane element 134 may further filter the prefiltered water to remove hardness minerals and other impurities. The membrane filtered water may flow from the membrane element 134 to the tank 118 for storage or may flow directly out of the outlet 148 of the water treatment system 100 to a point of use.

Water with hardness minerals and other impurities that do not pass through the membrane element 334 may be discharged from the membrane element 134 via a retentate line 136

The water treatment system 100 may have one or more sensors (e.g., 106a-106g, 114a-114d, 116a-116h, 122) that may be disposed at various points in the water treatment system 100 to measure or monitor a characteristic of the water (e.g., pressure, flow rate, conductivity, total dissolved solids, etc.) and provide data to a controller 402. Furthermore, one or more valves (e.g., 108, 140, 142) may be included at various points of the water treatment system 100 to control the flow of water into, through, and out of the water treatment system 100.

Still referring to FIG. 1, the inlet 102 of the water treatment system 100 may be in fluid communication with an inlet line 104. The inlet water may be provided from an inlet water source (not shown). The inlet water source may be, for example, a municipal water source, a well, or other influent water source. The inlet water may be imparted with a hardness value of about 1 grain per gallon (17.1 milligrams per liter) to about or above 10 grains per gallon (over 180 milligrams per liter).

The water treatment system 100 may include one or more pressure sensors 106. In some embodiments, the one or more pressure sensors 106 may be defined by a gauge pressure transmitter, a differential pressure transmitter, an absolute pressure transmitter, a multivariate pressure transmitter, or a submersible pressure transmitter.

A first pressure sensor 106a may be in fluid communication with the inlet line 104. The first pressure sensor 106a may measure, monitor, or sense the pressure of the inlet water in the inlet line 104.

The water treatment system 100 may include a first valve 108. The first valve 108 may be in fluid communication with the inlet line 104. In some instances, the first valve 108 is positioned upstream of the pressure sensor 106a, although the first valve 108 may be positioned downstream of the pressure sensor 106a. In some embodiments, the first valve 108 may be a gate valve. In some embodiments, the first valve 108 may be a bypass valve, a solenoid valve, a butterfly valve, a ball valve, a globe valve, a pressure relief valve, or a check valve.

The first valve 108 may control or regulate the amount of inlet water entering the water treatment system 100. The first valve 108 may open, either partially or fully, to enable the flow or increase the amount of inlet water entering the water treatment system 100 through the inlet 102. The first valve 108 may close, either partially or fully, to stop or decrease the flow or amount of inlet water entering the water treatment system 100. In addition, in some embodiments, the water treatment system 100 may be provided with a manual bypass valve (not illustrated) that is configured to decrease, substantially stop, or completely stop the flow of inlet water into the water treatment system 100. The amount of inlet water entering the water treatment system 100 may increase or decrease the water pressure in the water treatment system 100.

The water treatment system 100 may include the prefiltration unit 110. The prefiltration unit 110 may be provided in the form of one or more prefilter elements having one or more filter media. The prefiltration unit 110 may be in fluid communication with the inlet line 104 and a prefiltered water line 112. Inlet water may enter the prefiltration unit 110 via the inlet line 104 and exit the prefiltration unit 110 via the prefiltered water line 112. When inlet water passes through the prefiltration unit 110, the prefiltration unit 110 may remove sediment, particulates, certain chemicals and other contaminants from the inlet water, producing a prefiltered water that may flow out of the prefiltration unit 110 via the prefiltered water line 112.

In some embodiments, the prefiltration unit 110 may include a sediment filter. The sediment filter may remove sediments, such as sand, silt, and dirt, and other particulates such as rust from the inlet water. In some embodiments, the sediment filter may include a filter media including pores with a pore size of no more than 5 microns, or no more than about 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In other embodiments, the sediment filter may include a depth media, woven fabric, or nonwoven fabric.

In some embodiments, the prefiltration unit 110 may include an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like. In some embodiments, a non-carbon-based media, such as clay or an ion exchange media, may be used in place of the activated carbon media.

By removing sediment, chlorine, chloramine, and other contaminants, the prefiltration unit 110 may provide prefiltered water that may have substantially no odor and have an improved taste compared to the inlet water. In addition, by removing sediment, chlorine, chloramine, and other contaminants the prefiltration unit 110 may protect the downstream membrane element 134 from sediment fouling or oxidation.

In some embodiments, the prefiltration unit 110 may be defined by a series of prefilter elements (e.g., two or more sediment filters) or may be comprised of a combination of prefilter elements (e.g., one or more sediment filters and one or more activated carbon filters). One of ordinary skill in the art would understand that the one or more prefilter elements that comprise the prefiltration unit 110 may be retained within a single prefiltration element or may be separate and distinct prefiltration elements that are in fluid communication with one another. In some embodiments, the prefiltration unit 110 may be a PENTAIR® EVERPURE® filter. In other embodiments, the prefiltration unit 110 may be a PENTAIR® PENTEK® BIG BLUE® filter.

The water treatment system 100 may include one or more flowmeters 114. In some embodiments, the one or more flowmeters 114 may be provided as a mechanical flowmeter or an ultrasonic flowmeter. In some embodiments, the one or more flowmeters may include a ⅜ inch (0.95 centimeter) F-nut inflow connector, a ⅜ inch (0.95 centimeter) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 114 may be a 0.26-16 GPM turbine flowmeter, a 0.26-7.9 GPM turbine flowmeter, or a 0.26-0.65 turbine flowmeter. One of ordinary skill in the art would understand that each of the one or more flowmeters 114a-114d may be the same type of flowmeter or may each be a different type of flowmeter.

A first flowmeter 114a may be positioned within or otherwise in fluid communication with the prefiltered water line 112. The first flowmeter 114a may measure, monitor, or sense the flow rate of the prefiltered water through the prefiltered water line 112.

The water treatment system 100 may include one or more TDS sensors 116. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about +10% Full Scale (25° C.). In some embodiments, the one or more TDS sensors 116 may be a TDS sensor having a TDS measurement range of at least about 0 to about 3000 ppm or greater than about 3000 ppm. In other embodiments, the TDS sensor may be a flexible TDS probe as described in U.S. patent application Ser. No. 17/657,916 owned by Pentair Residential Filtration, LLC and incorporated herein by reference. One of ordinary skill in the art would understand that each of the one or more TDS sensors 116a-116h may be the same type of TDS sensor or may each be a different type of TDS sensor.

A first TDS sensor 116a may be in fluid communication with the prefiltered water line 112. The first TDS sensor 116a may measure, monitor, or sense the conductivity of the prefiltered water to determine a concentration or an amount of dissolved solids in the prefiltered water (e.g., inlet water that has passed through the prefiltration unit 110).

The water treatment system 100 may include a second pressure sensor 106b that may be in fluid communication with the prefiltered water line 112. The second pressure sensor 106b may measure, monitor, or sense the pressure of the prefiltered water in the prefiltered water line 112.

The water treatment system 100 may include a temperature sensor 122 that may be in fluid communication with the prefiltered water line 112. The temperature sensor 122 is designed to measure, monitor, or sense the temperature of the prefiltered water. In some embodiments, the temperature sensor 122 may be a thermistor, a thermocouple, a semiconducting material, and any other mechanical or electronic sensor that may respond to a change in temperature. In some embodiments, additional temperature sensors may be included in the water treatment system 100. In some embodiments, an additional temperature sensor may be optionally placed on or within the inlet line 104.

The water treatment system 100 may include the tank 118, which may be used to store water. The tank 118 may be defined by a housing having a bottom portion 118a, a center portion 118b, and a top portion 118c. In some instances, each of the portions 118a, 118b, 118c may be separated by a physical barrier (e.g., if the tank 118 is provided as a bladder tank), although in preferred embodiments no physical barrier is positioned between the portions 118a, 118b, 118c. In some embodiments, the tank 118 may be a flow through tank, which may allow for the seamless delivery of water to a point of use (POU). In some embodiments, the tank 118 may be a pressurized tank. In some embodiments, the tank 118 may be a fiberglass reinforced plastic (FRP) tank. In some embodiments, the tank 118 may range in size from about 24 gallons (91 liters) to about 200 gallons (757 liters). In other embodiments, multiple tanks 118 of any size may be connected in series. In further embodiments, existing water vessels within the residential or commercial property (e.g., a water heater) may be used for additional storage capacity.

The tank 118 may include a riser tube 120 that extends upwardly vertically from the bottom portion 118a of the tank 118 to the top portion 118c of the tank 118, or vice versa. The riser tube 120 may be in fluid communication with the prefiltered water line 112. In some embodiments, the riser tube 120 may be provided as PVC tubing.

The tank 118 may further include a flow distributor 124, which may be attached or coupled to the riser tube 120. The flow distributor 124 may prevent or reduce the mixing of higher TDS water that may be stored in the bottom portion 118a of the tank 118 with lower TDS water that may be stored in the top portion 118c of the tank 118. In some embodiments, the flow distributor 124 may be a dome flow distributor. In some embodiments, multiple flow distributors 124 may be used.

Additionally, or alternatively, the tank 118 may include baffles and external plumbing (e.g., flow distributors) to reduce the mixing of higher TDS water that may be stored in the bottom portion 118a of the tank 118 with lower TDS water that may be stored in the top portion 118c of the tank 118.

In some embodiments, the high TDS water is added to the bottom portion 118a of the tank 118 and the low TDS water is added to the top portion 118c of the tank 118. Advantageously, adding the high TDS water and the low TDS water to the tank 118 in this manner helps maintain the separation between the high TDS water and the low TDS water in the tank 118, which in turn helps ensure that low TDS water is provided to a point of use during operation of the tank 118.

The water treatment system 100 may include an additive line 126. The additive line 126 may be physically connected to or otherwise in fluid communication with the prefiltered water line 112.

A second flowmeter 114b may be positioned within or otherwise in fluid communication with the additive line 126. The second flowmeter 114b may measure, monitor, or sense the flow rate of the prefiltered water through the additive line 126.

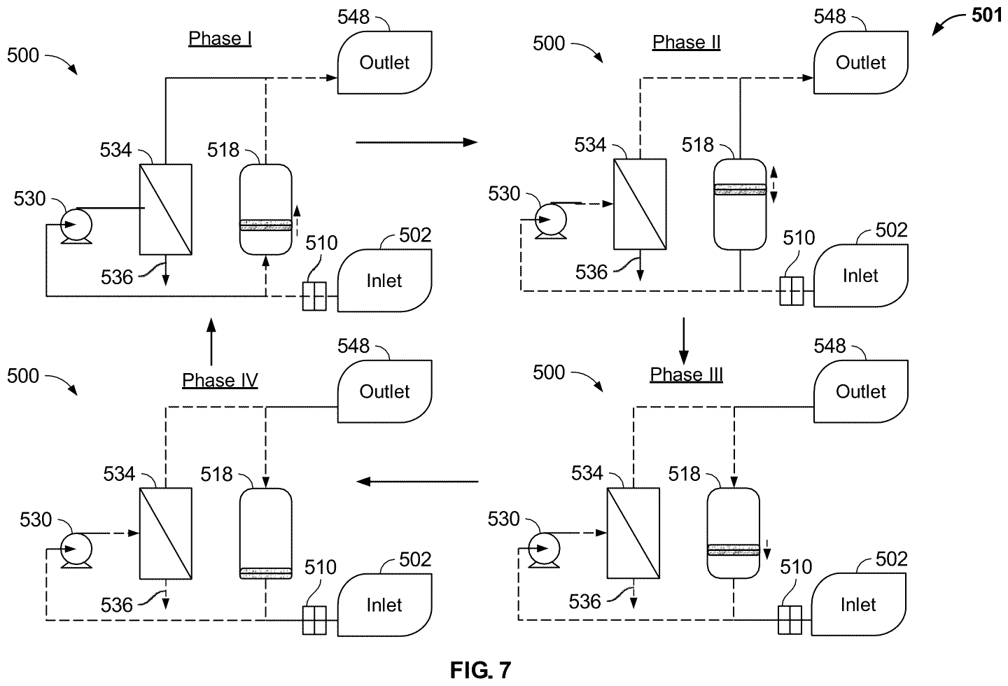

The prefiltered water may have a fluid flow path through the water treatment system 100. In some embodiments, depending on the flow conditions when the water treatment system 100 is in use, the prefiltered water may flow in different directions as described in more detail below (scc, e.g., FIG. 7). For example, during some flow conditions, the prefiltered water may flow directly from the prefiltration unit 110 through the prefiltered water line 112, down the riser tube 120, and into the bottom portion 118a of the tank 118. The prefiltered water may be stored in the tank 118. During other flow conditions, the prefiltered water may flow from the prefiltration unit 110 via the prefiltered water line 112 toward the membrane element 134 via the additive line 126 and a membrane feed line 132. During further flow conditions, the prefiltered water may flow from the bottom portion 118a of the tank 118, up the riser tube 120, through the prefiltered water line 112 toward the membrane element 134 via the additive line 126 and the membrane feed line 132.

The water treatment system 100 may include the feeder 128 that is in fluid communication with the additive line 126. The feeder 128 may introduce or add a chemical additive to the prefiltered water. In some embodiments, the chemical additive may be an anti-scaling agent to reduce corrosion or scale on a feed side of a membrane element. In some embodiments, the chemical additive may be a polyphosphate compound.

In some embodiments, when the prefiltered water flows through or passes by the feeder 128, the chemical additive may be added or introduced to the prefiltered water. The chemical additive may dissolve or otherwise degrade in the prefiltered water. In some embodiments, as further detailed herein, the feeder 128 may impart the water flowing through the feeder 128 with a chemical additive concentration of at least about 0.01 ppm to at least about 10 ppm, or at least 0.01 ppm to at least 10 ppm. In other embodiments, the feeder 128 may impart the water flowing through the feeder 128 with a chemical additive concentration of less than 0.01 ppm or greater than 10 ppm of the chemical additive.

The water treatment system 100 may include a third pressure sensor 106c that may be in fluid communication with the additive line 126. The third pressure sensor 106c may measure, monitor, or sense the pressure of the prefiltered water with additive in the additive line 126. Alternatively, if a chemical additive is not added by the feeder 128, the third pressure sensor 106c may measure, monitor, or sense the pressure of the prefiltered water in the additive line 126.

The water treatment system 100 may include a second TDS sensor 116b. The second TDS sensor 116b may be in fluid communication with the additive line 126. The second TDS sensor 116b may measure, monitor, or sense the conductivity of the prefiltered water to determine an amount or concentration of dissolved solids in the prefiltered water (with or without additive). The prefiltered water with additive may have a higher TDS than the prefiltered water without additive.

The water treatment system 100 may include the pump 130. An inlet side (not shown) of the pump 130 may be in fluid communication with the additive line 126, and an outlet side (not shown) of the pump 130 may be in fluid communication with the membrane feed line 132. In some embodiments, the pump 130 may be a single-phase booster pump. For example, the pump 130 may be a PENTAIR® STA-RITE™ single-phase 115 volt, ¾ horsepower pump. In some embodiments, the pump 130 may be a multi-phase booster pump. In some embodiments, the pump 130 may boost differential pressure in the membrane feed line 132 to 120-250 pounds per square inch (827-1725 kilopascals) at a flow rate of 1.0-7.0 gallons per minute (11-26 liters per minute) or at a preferable flow rate of 2.0-5.0 gallons per minute (7.5-19 liters per minute).

The membrane feed line 132 may be in fluid communication with a fourth pressure sensor 106d. The fourth pressure sensor 106d may measure, monitor, or sense the pressure of the prefiltered water (with or without additive) in the membrane feed line 132.

The water treatment system 100 may include the membrane element 134. In some embodiments, the membrane element 134 may be a reverse osmosis (RO) membrane. In some embodiments, the RO membrane may be spiral wound and may include feed spacers imparted with a certain thickness and/or structure. In some embodiments, the RO membrane may be a spiral wound RO membrane (e.g., a spiral wound 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membrane may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membrane may be a spiral wound RO membrane (e.g., a spiral wound 4040 RO membrane) with feed spacers imparted with a thickness of at least 8 mil to no more than 40 mil. For example, the feed spacers may be imparted with a thickness of no more than 8 mil, or no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In other embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membrane may be a spiral wound RO membrane (e.g., a spiral wound 4040 RO membrane) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membrane may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membrane may be a spiral wound RO membrane (e.g., a spiral wound 4040 RO membrane) with feed spacers imparted with a thickness of at least 0.2 millimeters to no more than 1.1 millimeters. For example, the RO membrane may have feed spacers imparted with a thickness of no more than 0.2 millimeters, or no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In other embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the membrane element 134 may be a nanofiltration (NF) membrane, an ultrafiltration (UF) membrane, a microfiltration (MF) membrane, or a particulate membrane. In some embodiments, the membrane element 134 may be a hollow fiber NF membrane. In other embodiments, the membrane element 134 may be an electrodialysis membrane system.

In some embodiments, the membrane element 134 may comprise a combination of one or more of a RO membrane, a NF membrane, a UF membrane, a MF membrane, a particulate membrane, and/or an electrodialysis membrane, which may be disposed in parallel or in series. For example, in some embodiments, the combination of membranes may include at least one RO membrane and at least one NF membrane. The at least one RO membrane may be disposed in parallel with the at least one NF membrane, or the RO membrane may be disposed before or after the at least one NF membrane in series. In other embodiments, the combination of membrane elements may include at least one UF membrane and at least one MF membrane. The at least one UF membrane may be disposed in parallel with the at least one MF membrane, or the at least one UF membrane may be disposed before or after the at least one MF membrane in series. The one or more membranes in the combination of membranes may be contained within a single housing, in separate housings, or a combination thereof.

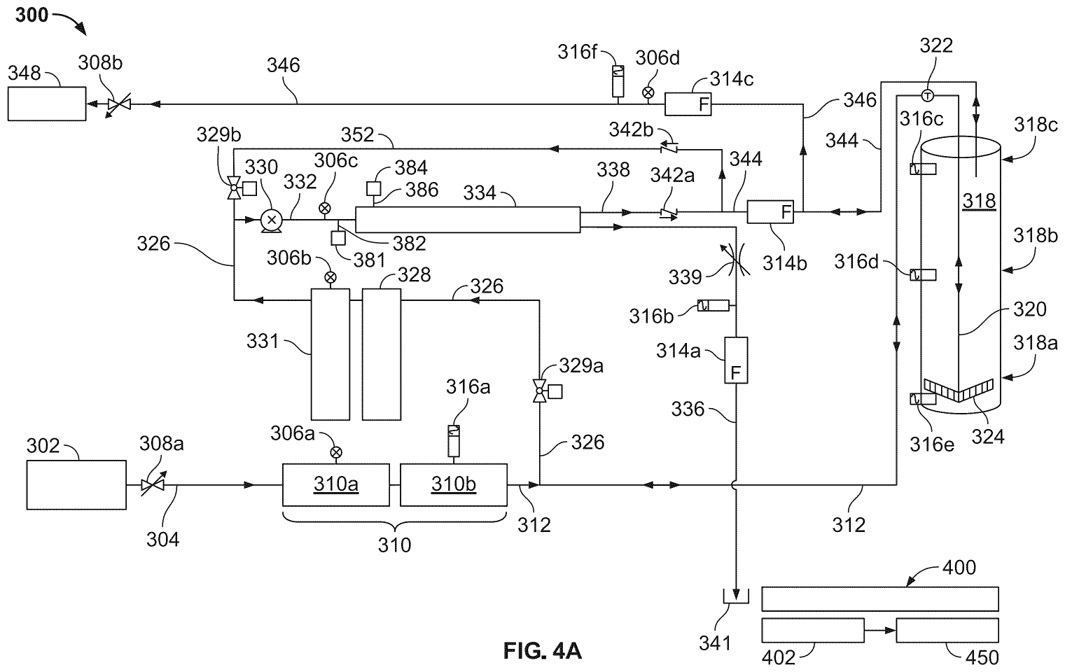

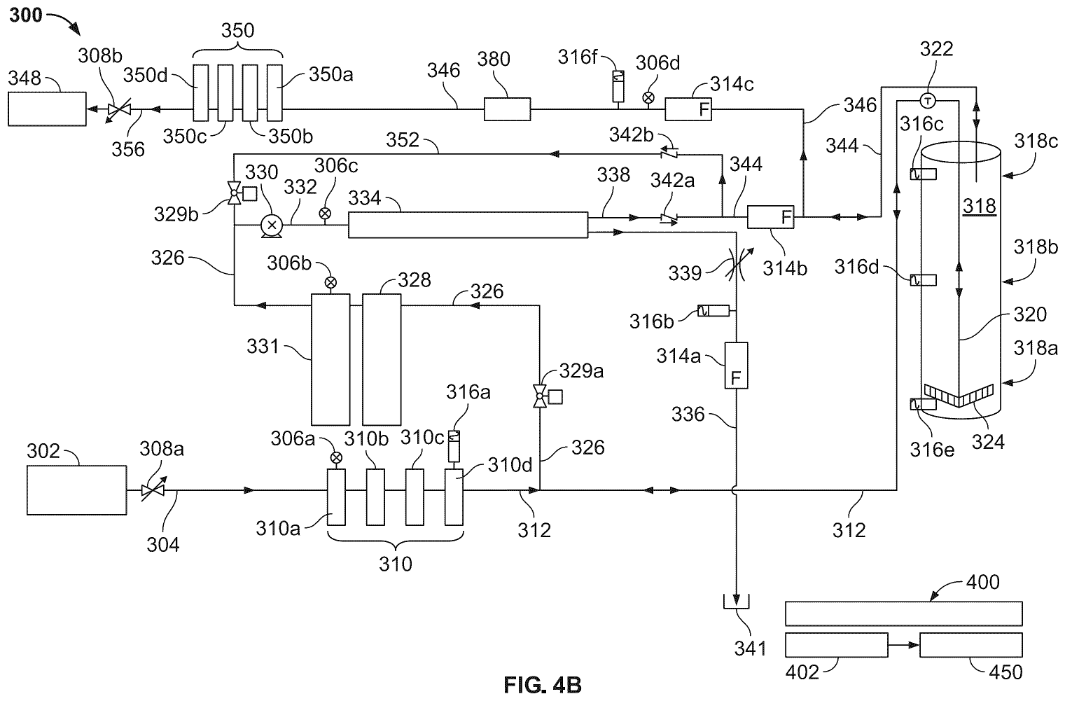

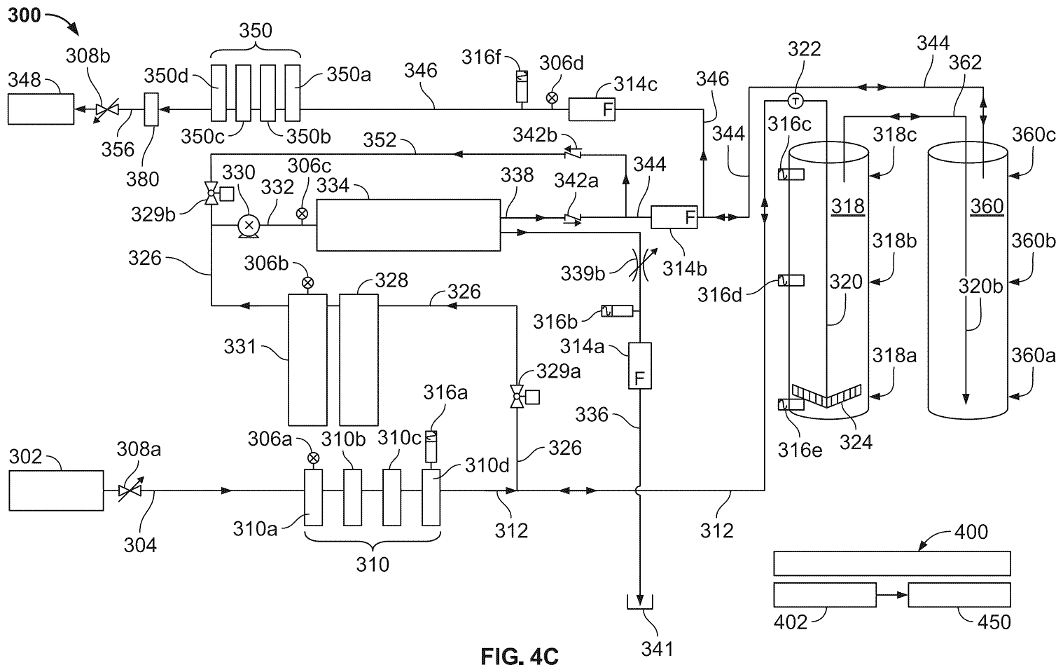

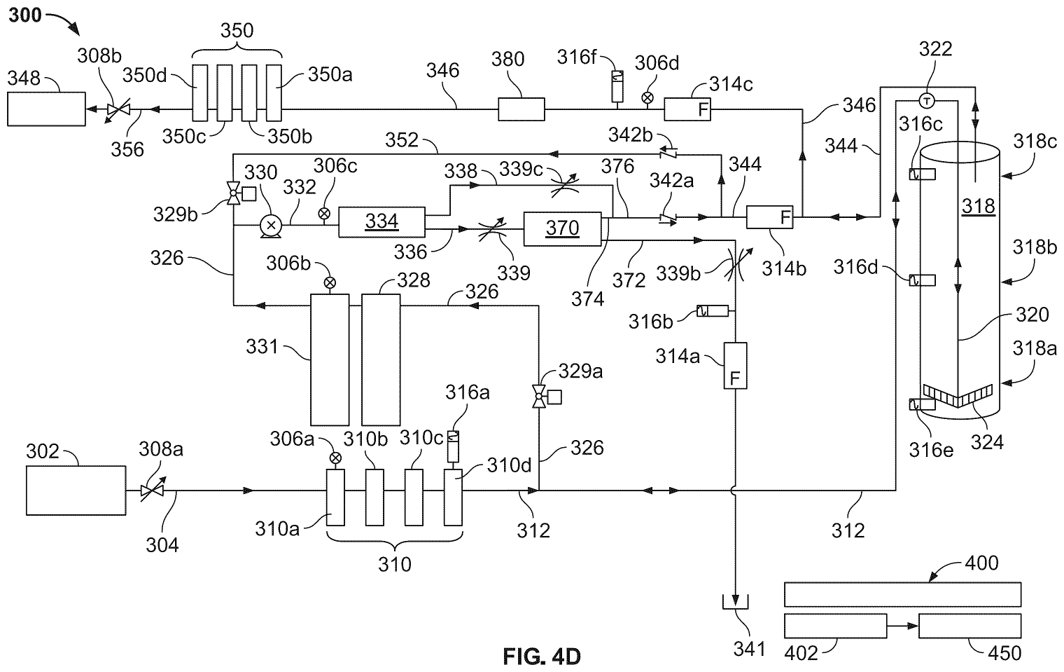

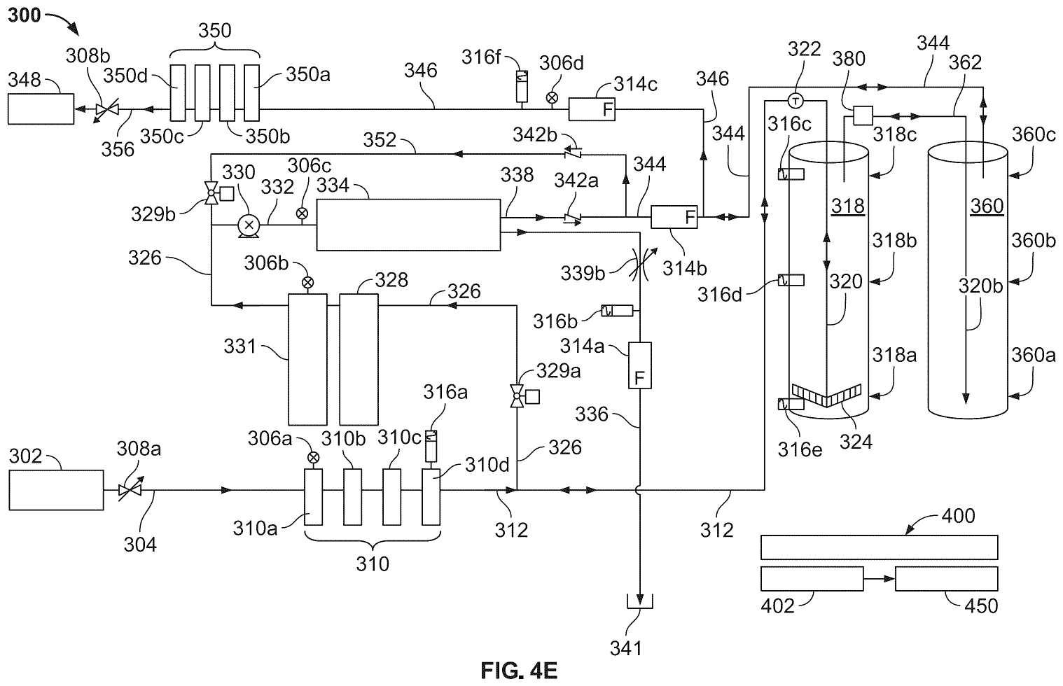

In further embodiments, the membrane element 134 may include two or more RO membranes, NF membranes, a UF membrane, a MF membrane, a particulate membrane, and/or electrodialysis membranes, which may be disposed in parallel or in series. In some embodiments, the membrane element 134 may be a series of membranes of the same type (e.g., two or more RO membranes) but of a different size. For example, the membrane element 134 may include a first membrane imparted with a first diameter and a second membrane imparted with a second diameter that is different than the first diameter (e.g., the second diameter may be less than the first diameter). In some embodiments, the first membrane may be a spiral wound 4040 RO membrane and the second membrane may be a spiral wound 2540 RO membrane. The two or more membranes may be contained within a single housing, in separate housings (e.g., as shown in FIG. 4D), or a combination thereof.

Varying the membrane type and/or size can be used to optimize the level of permeate production, allowing for enhanced water recovery, while at the same time balancing factors such as a particular permeate water chemistry and/or membrane health. For example, in some embodiments, including at least one NF membrane as a first or second membrane in a series may allow for higher total permeate output as compared to utilizing two RO membranes. In other embodiments, including two or more RO membranes in series, for example, may help maintain a higher velocity on the feed side of the individual membranes, which in turn may reduce ion concentration at the membrane surface of each membrane. In addition, including two or more RO membranes in series may enable the operation of the individual RO membranes at different membrane recoveries, which may help optimize permeate production as dissolved mineral content increases.

In further embodiments, using a smaller membrane as a second membrane in a series of membranes, where the first membrane is imparted with a diameter that is larger than the diameter of the second membrane, may allow the water entering the second membrane to have a higher velocity, which may boost overall water recovery. For instance, in some embodiments, if the water treatment system 100 is operating at an approximately 80% recovery, and a spiral wound 4040 RO membrane is used as the first membrane in a series of membranes and a spiral wound 2540 RO membrane is used as a second membrane in the series of membranes, the total water recovery of the water treatment system 100 may be increased to at least about a 94% recovery.

The membrane element 134 may be in fluid communication with the membrane feed line 132 on a feed side (not shown) of the membrane element 134. The membrane element 134 also may be in fluid communication with the retentate line 136 on the feed side of the membrane element 134. The membrane element 134 may be in fluid communication with a membrane permeate line 138 on a permeate side (not shown) of the membrane element 134.

In some embodiments, as the prefiltered water (with or without additive) enters the feed side of the membrane element 134, the membrane element 134 may allow a solvent (e.g., water) in the prefiltered water to pass through a surface of a membrane (not shown) retained within the membrane element 134. The solvent that passes through the surface of the membrane may exit from the permeate side of the membrane element 134 as membrane permeate via the membrane permeate line 138. Solutes (e.g., dissolved minerals and ions and various organic compounds) in the prefiltered water may not pass through the membrane and may be retained at the surface of the membrane. The solutes may be discharged from the feed side of the membrane element 134 as retentate via the retentate line 136.

In some embodiments, when the pump 130 is activated, the pump 130 may increase the rate at which water flows into the membrane feed line 132 toward the membrane element 134. Increasing the flow rate of water into the membrane feed line 132 may increase pressure in the membrane feed line 132. The increased pressure may in turn aid in pushing solvent in the membrane feed line 132 through the pores formed within the surface of the membrane retained within the membrane element 134.

The water treatment system 100 may include a fifth pressure sensor 106e that may be in fluid communication with the retentate line 136. The fifth pressure sensor 106e may measure, monitor, or sense the pressure of the retentate in the retentate line 136.

The water treatment system 100 may include a third TDS sensor 116c that may be in fluid communication with the retentate line 136. The third TDS sensor 116c may measure, monitor, or sense the conductivity of the retentate to determine an amount or concentration of dissolved solids in the retentate.

The water treatment system 100 may include a third flowmeter 114c. The third flowmeter 114c may be positioned within or otherwise in fluid communication with the retentate line 136. The third flowmeter may measure, monitor, or sense the flow rate of the retentate in the retentate line 136.

The water treatment system 100 may include a second valve 140. The second valve 140 may be in fluid communication with the retentate line 136. In some embodiments, the second valve 140 may be an actuated ball valve. In some embodiments, the second valve 140 may be a gate valve, a butterfly valve, a globe valve, a pressure relief valve, a check valve, a needle valve, a flow control valve, or a pressure regulator.

The second valve 140 may be used to control or regulate the amount of retentate leaving the water treatment system 100 via the retentate line 136 into a drain 141. The second valve 140 may open, either partially or fully, to enable the flow or increase the amount of retentate flowing through the retentate line 136 into the drain 141. The second valve 140 may close, either partially or fully, to stop or decrease the flow or amount of retentate flowing through the retentate line 136. In some embodiments, a flow restrictor tube may be used instead of or in combination with the second valve 140. The amount of retentate exiting the water treatment system 100 into the drain 141 may increase or decrease the water pressure in the water treatment system 100.

The water treatment system 100 may include a sixth pressure sensor 106f that may be in fluid communication with the membrane permeate line 138. The sixth pressure sensor 106f may measure, monitor, or sense the pressure of the membrane permeate in the membrane permeate line 138.

The water treatment system 100 may include a fourth TDS sensor 116d that may be in fluid communication with the membrane permeate line 138. The fourth TDS sensor 116d may measure, monitor, or sense the conductivity of the membrane permeate to determine an amount or concentration of dissolved solids in the membrane permeate.

The membrane permeate line 138 may be connected to or otherwise in fluid communication with a tank line 144. The tank line 144 may be in fluid communication with the top portion 118c of the tank 118. The tank line 144 also may be connected to or otherwise in fluid communication with an outlet feed line 146. The outlet feed line 146 may be in fluid communication with the outlet 148 of the water treatment system 100.

In some embodiments, depending on the flow conditions when the water treatment system 100 is in use, the membrane permeate may flow from the permeate side of the membrane element 134 through the membrane permeate line 138 and the tank line 144 into the top portion 118c of the tank 118. The membrane permeate may be stored in the tank 118. The membrane permeate may also flow from the membrane permeate line 138 to the tank line 144, into the outlet feed line 146 (thereby bypassing the tank 118), and out of the outlet 148. By enabling the flow of membrane permeate from the membrane element 134 directly to the outlet 148, membrane permeate may be provided to a point of use in real time.

Due to the amount of dissolved ions in high TDS water, high TDS water tends to have a higher density than low TDS water. By sending higher TDS water (e.g., the prefiltered water) to the bottom portion 118a of the tank 118 and lower TDS water (e.g., the membrane permeate) to the top portion 118c of the tank 118, the chances of water with different TDS amounts or concentrations mixing inside the tank 118 may be minimized. Thus, when membrane permeate is drawn from the top portion 118c of the tank 118, low TDS water may be provided to a point of use. Sending higher TDS water to the bottom of the tank 118 and lower TDS water to the top of the tank 118 may also create a sharp TDS profile along the vertical height of the tank 118, where the amount or concentration of TDS at the bottom portion 118a of the tank 118 is the highest (e.g., a TDS concentration of more than about 3.5 grains per gallon (60 milligrams per liter)), and the amount or concentration of TDS at the top portion 118c of the tank 118 is the lowest (e.g., a TDS concentration of less than about 3.5 grains per gallon (60 milligrams per liter)). Creating and maintaining this sharp TDS profile is aided by the density difference between the high TDS water and the low TDS water.

The water treatment system 100 may include a third valve 142 that may be in fluid communication with the membrane permeate line 138. In some embodiments, the third valve 142 may be a check valve. In some embodiments, the third valve may be a gate valve, a butterfly valve, a globe valve, a pressure relief valve, or a ball valve.

The third valve 142 may be used to control or regulate the amount of membrane permeate entering or flowing through the membrane permeate line 138 into the tank line 144 and into the top portion 118c of the tank 118 or out of the outlet 148 via the outlet feed line 146. The third valve 142 may open, either partially or fully, to enable or increase the flow or the amount of membrane permeate flowing through the membrane permeate line 138 to the tank line 144, and into the top portion 118c of the tank 118 or into the outlet feed line 146 and out of the outlet 148. The third valve 142 may close, either partially or fully, to stop or decrease the amount of membrane permeate flowing through the membrane permeate line 138 and the tank line 144, into the top portion 118c of the tank 118 or into the outlet feed line 146 and out of the outlet 148. The amount of membrane permeate entering or flowing through the membrane permeate line 138 and into the tank 118 or out of the outlet 148 may increase or decrease the water pressure in the water treatment system 100. In some instances, the third valve 142 may be a check valve that is used to prevent backflow through the tank line 144, which in turn helps protect the membrane element 134.

In some embodiments, the tank 118 may include a fifth TDS sensor 116e disposed in the top portion 118c, a sixth TDS sensor 116f disposed in the center portion 118b of the tank 118, and/or a seventh TDS sensor 116g disposed in the bottom portion 118a of the tank 118. The fifth TDS sensor 116e may measure, monitor, or sense the conductivity of the water in the top portion 118c of the tank 118 to determine an amount or concentration of dissolved solids in the water located in the top portion 118c of the tank 118. The sixth TDS sensor 116f may measure, monitor, or sense the conductivity of the water in center portion 118b of the tank 118 to determine an amount or concentration of dissolved solids in the water located in the center portion 118b of the tank 118. The seventh TDS sensor 116g may measure, monitor, or sense the conductivity of the water in the bottom portion 118a to determine an amount or concentration of dissolved solids in the water located in the bottom portion 118a of the tank 118. The fifth, sixth, and seventh TDS sensors (116c, 116f, and 116g, respectively) may create a profile of the TDS levels or concentrations of the water in the tank 118.

In some embodiments, the tank 118 may include zero, one, two, or more TDS sensors disposed in, or otherwise associated with, each of the top, center, or bottom portions of the tank 118. For example, in some embodiments, a TDS sensor may only be disposed in the center portion 118b of the tank, not the top portion 118c or the bottom portion 118a. In other embodiments, a TDS sensor may be disposed in each of the top portion 118c and the bottom portion 118a of the tank 118, but not the center portion 118b. In further embodiments, zero TDS sensors may be disposed in the tank 118.

The water (i.e., membrane permeate (lower TDS) or the prefiltered water (higher TDS)) that may be stored in the tank 118 may flow through the tank line 144 and the outlet feed line 146 out of the outlet 148. The outlet 148 may be in fluid communication with various appliances, fixtures, and plumbing of the residential or commercial property. In some embodiments, the outlet 148 may be in fluid communication with a water heater, faucets, fixtures, or toilets via one or more pipes or tubes.

The water treatment system 100 may include a seventh pressure sensor 106g in communication with the outlet feed line 146. The seventh pressure sensor 106g may measure, monitor, or sense the pressure of the water in the outlet feed line 146.

The water treatment system 100 may include an eighth TDS sensor 116h in communication with the outlet feed line 146. The eighth TDS sensor 116h may measure, monitor, or sense the conductivity of the water in the outlet feed line 146 to determine an amount or concentration of the dissolved solids in the water in the outlet feed line 146.

The water treatment system 100 may include a fourth flowmeter 114d that may be positioned within or otherwise in communication with the outlet feed line 146. The fourth flowmeter 114d may measure, monitor, or sense the flow rate of the water in the outlet feed line 146.

The water treatment system 100 may include an optional mineralization unit (not shown) containing a mineralization material. The mineralization material may be provided as a calcium-containing compound or a magnesium-containing compound, although other ionic compounds could also be used to increase the mineral or TDS concentration of the water provided by the system 100 to a point of use. The mineralization material may be, for example, a calcium carbonate compound (CaCO₃), a magnesium carbonate compound (MgCO₃), a magnesium oxide compound (MgO), a calcium oxide compound (CaO), a sodium bicarbonate compound (NaHCO₃), dolomite (CaMg(CO₃) 2), other substances with similar chemical and physical properties, and combinations thereof. In some instances, the mineralization compound may be selected from the group consisting of a calcium carbonate compound (CaCO₃), a magnesium carbonate compound

(MgCO₃), a magnesium oxide compound (MgO), a calcium oxide compound (CaO), a sodium bicarbonate (Na₂CO₃) compound, a sodium bicarbonate compound (NaHCO₃), a potassium carbonate (K₂CO₃) compound, a potassium bicarbonate (KHCO₃) compound, dolomite (CaMg(CO₃)₂), and combinations thereof. In instances where the mineralization material includes a calcium carbonate compound, the calcium carbonate may be provided in the form of calcite. In some instances, a magnesium oxysulfate compound may be used as the remineralization material.

In some embodiments, the mineralization unit may be a device containing a mineralization material that has an inlet and an outlet through which water passes. For example, the mineralization unit may be provided as a cartridge that may be replaced when the mineralization material is depleted. In some embodiments, the mineralization unit may include a bed or cartridge of mineralization material disposed on a line (e.g., outlet feed line 146) or other system component of the water treatment system 100, which water passes by but does not flow through. In other embodiments, the mineralization unit may be provided as a mineralization unit or include a cementitious material as described in U.S. patent application Ser. No. 17/061,830 owned by Pentair Residential Filtration, LLC and incorporated herein by reference.

The mineralization unit may generally be disposed on or coupled to various system components or lines of the system 100 that are positioned downstream of the membrane element 134. In some embodiments, the mineralization unit may be disposed on or coupled to the outlet feed line 146 upstream of the outlet 148 (see, e.g., mineralization unit 380 in FIG. 4A). The mineralization unit may introduce a mineralization material to the membrane permeate before the membrane permeate exits the water treatment system 100 via the outlet 148. In some embodiments, the mineralization unit may be disposed on the membrane permeate line 138 or the tank line 144. For example, the mineralization unit may be disposed on the membrane permeate line 138 or the tank line 144 proximate the tank 118 so that the membrane permeate is introduced to the mineralization material before the membrane permeate flows into the top portion 118c of the tank 118. In other embodiments, the mineralization unit may be disposed within a top portion 118c of the tank 118 so that the membrane permeate is introduced to the mineralization material as the membrane permeate flows into or out of the top portion 118c of the tank 118. In further embodiments, the mineralization unit may be disposed within a top portion 118c of the tank 118 so that the membrane permeate contacts the mineralization material in the mineralization unit while the membrane permeate is stored in the tank 118, including during periods when there is no flow of membrane permeate into or out of the tank 118. In other embodiments, the mineralization unit may be provided as a solid block of mineralization material (e.g., as a block of calcite) that is disposed within the tank 118 or within one of the lines or another system component of the water treatment system 100.

The mineralization material introduced or otherwise provided by the mineralization unit may change a quality or characteristic of the membrane permeate such as the pH level and/or the TDS level. The changing of a quality or characteristic of the membrane permeate may improve the aesthetics (e.g., taste) of the membrane permeate and/or reduce the possible corrosion of metal plumbing and appliances downstream from the water treatment system 100. One or more pH sensors may be disposed proximate to the mineralization unit to monitor the pH level of the membrane permeate before and/or after the membrane permeate passes by or through the mineralization unit. Additionally, or alternatively, one or more TDS sensors may be disposed proximate the mineralization unit to monitor the TDS level of the membrane permeate before and/or after the membrane permeate passes by or through the mineralization unit.

The re-mineralized membrane permeate that exits or results from passing by or through the mineralization unit may be imparted with a TDS concentration of at least about 20 ppm to at least about 1000 ppm, or at least about 50 ppm to at least about 500 ppm, or at least about 100 ppm to at least about 400 ppm. In some instances, the re-mineralized membrane permeate that exits or results from passing by or through the mineralization unit may be imparted with a TDS concentration less than about 20 ppm or greater than about 1000 ppm. In some instances, it is preferred to impart the re-mineralized water with a TDS concentration of at least about 50 ppm or at least 50 ppm.

In other embodiments, the re-mineralized membrane permeate that exits or results from passing by or through the mineralization unit may be imparted with a TDS concentration of at least 20 ppm to at least 1000 ppm, or at least 50 ppm to at least 500 ppm, or at least 100 ppm to at least 400 ppm. In some instances, the re-mineralized membrane permeate that exits or results from passing by or through the mineralization unit may be imparted with a TDS concentration less than 20 ppm or greater than 1000 ppm.

In some embodiments, the re-mineralized membrane permeate may be imparted with a TDS concentration of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more.

In other embodiments, the re-mineralized membrane permeate may be imparted with a TDS concentration of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In further embodiments, the re-mineralized membrane permeate that exits or results from passing by or through the mineralization unit may be imparted with a pH value within drinkable limits (e.g., between about 7 to about 10, or between 7 to 10). In some embodiments, the re-mineralized membrane permeate that exits or results from passing by or through the mineralization unit is imparted with a pH value of about 7, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In some embodiments, the re-mineralized membrane permeate that exits or results from passing by or through the mineralization unit is imparted with a pH value of 7, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

The water treatment system 100 may include and be in communication with a control system 400. The control system 400 may include the controller 402 and a display 450. As shown in FIG. 4, the controller 402 may be electronically connected to and may be in electronic communication with the display 450. The controller 402 also may be electronically connected to and may be in electronic communication with one or more of the water treatment system components including the one or more sensors (106a-106g, 114a-114d, 116a-116h, and 122), the first, second, or third valves (108, 140, and 142, respectively), the feeder 128, and/or the pump 130.

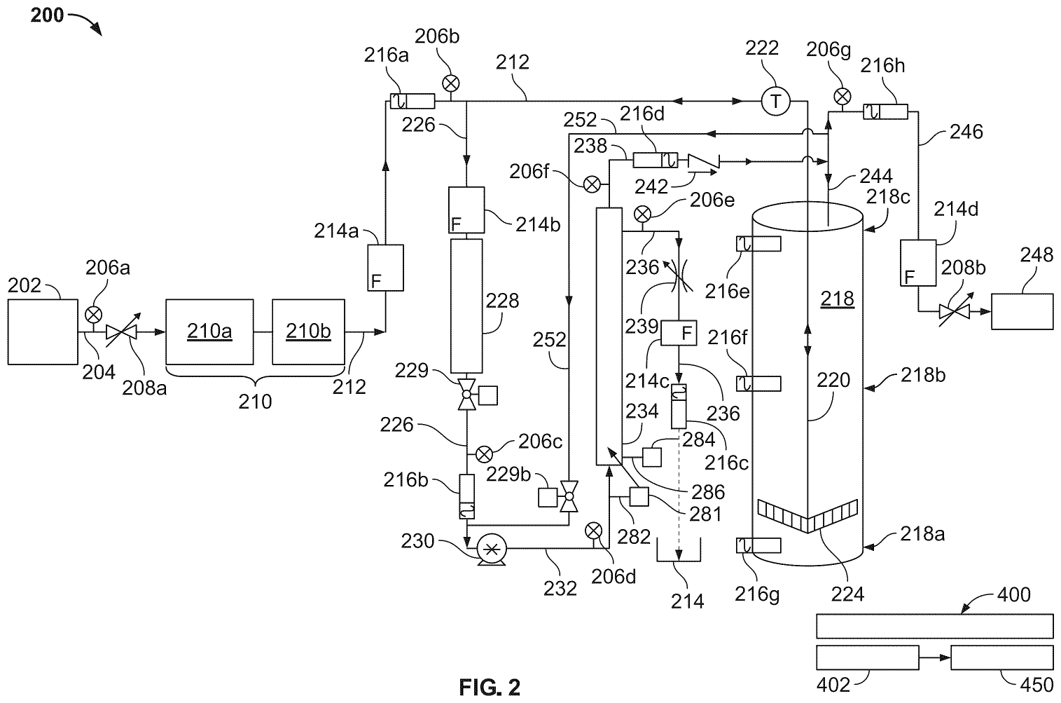

FIG. 2 illustrates another embodiment of a water treatment system 200. The water treatment system 200 may have the same types of system components as the water treatment system 100 of FIG. 1 (wherein similar components have like reference numbers) but may have fewer system components and/or system components in a different configuration than the water treatment system 100 of FIG. 1. In particular, the water treatment system 200 may further include a permeate flush line (i.e., a permeate flush line 252) designed to recirculate membrane permeate to clean one or more membrane elements.

The water treatment system 200 may include an inlet 202 through which inlet water (e.g., hard water) enters the water treatment system 200. The inlet water may pass through a prefiltration unit 210, where the inlet water may be filtered and sediment or other contaminants are removed. The prefiltered water may flow into a tank 218 where the prefiltered water is stored for future processing by a membrane element 234 of the water treatment system 200. The prefiltered water may also flow into and through the tank 218 to an outlet 248 of the water treatment system 200 for immediate use. Alternatively, or additionally, the prefiltered water may flow toward the membrane element 234 after passing through the prefiltration unit 210. As the prefiltered water flows toward the membrane element 234, the prefiltered water may pass a feeder 228, which is designed to add a chemical additive to the prefiltered water. In some instances, the feeder 228 may be positioned elsewhere in the system 200 (e.g., downstream of the pump 230 or any other suitable position). After passing the feeder 228, the prefiltered water may flow through the membrane element 234. A pump 230 located on a feed side of the membrane element 234 may be used to direct the prefiltered water toward the membrane element 234. The membrane element 234 may further filter the prefiltered water to remove hardness minerals and other impurities. The membrane filtered water may flow from the membrane element 234 to the tank 218 for storage or may flow directly out of the outlet 248 of the water treatment system 200 to a point of use. In addition, the water treatment system 200 may further include a permeate flush line (i.e., the permeate flush line 252) designed to recirculate membrane permeate to clean one or more membrane elements. Such recirculation of the permeate, alone or in conjunction with the other cleaning processes described herein, can help improve performance of the membrane element 234 and extend the lifetime of the membrane element 234.

Water with hardness minerals and other impurities that do not pass through the membrane element 234 may be discharged from the membrane element 234 via a retentate line 236.

The membrane filtered water stored in the tank 218 may also flow from the tank 218 toward an inlet side of the pump 230. The membrane filtered water may be directed toward the membrane element 234 via the pump 230 and may be used to clean the membrane element 234. Additionally, the water treatment system 200 may have one or more sensors (e.g., 206a-206g, 214a-214d, 216a-216h, 222) that may be disposed at various points in the water treatment system 200 to measure or monitor a characteristic of the water (e.g., pressure, flow rate, conductivity, total dissolved solids, etc.) and provide data to a controller 402. Furthermore, one or more valves or flow restrictor tubes (208a, 208b, 229a, 229b, 239, 242) may be included at various points of the water treatment system 200 to control the flow of water into, through and out of the water treatment system 200.

Still referring to FIG. 2, the inlet 202 of the water treatment system 200 may be in fluid communication with an inlet line 204. The inlet water may be from an inlet water source (not shown). The inlet water source may be provided from a municipal water source, a well, or other influent water source. The inlet water may be imparted with a hardness value of about 1 grain per gallon (17.1 milligrams per liter) to about or above 10 grains per gallon (over 180 milligrams per liter).

The water treatment system 200 may include one or more pressure sensors 206. In some embodiments, the one or more pressure sensors 206 may be defined by a gauge pressure transmitter, a differential pressure transmitter, an absolute pressure transmitter, a multivariate pressure transmitter, or a submersible pressure transmitter.

A first pressure sensor 206a may be in fluid communication with the inlet line 204. The first pressure sensor 206a may measure, monitor, or sense the pressure of the inlet water in the inlet line 204.

The water treatment system 200 may include a first valve 208a. The first valve 208a may be in fluid communication with the inlet line 204. In some instances, the first valve 208 is positioned upstream of the pressure sensor 206a, although the first valve 208 may be positioned downstream of the pressure sensor 206a. In some embodiments, the first valve 208a may be a gate valve. In some embodiments, the first valve 208a may be a bypass valve, a solenoid valve, a butterfly valve, a ball valve, a globe valve, a pressure relief valve, or a check valve.

The first valve 208a may control or regulate the amount of inlet water entering the water treatment system 200. The first valve 208a may open, either partially or fully, to enable the flow or increase the amount of inlet water entering the water treatment system 200 through the inlet 202. The first valve 208a may close, either partially or fully, to stop or decrease the flow or amount of inlet water entering the water treatment system 200. In addition, in some embodiments, the water treatment system 200 may be provided with a manual bypass valve (not illustrated) that is configured to decrease, substantially stop, or completely stop the flow of inlet water into the water treatment system 200. The amount of inlet water entering the water treatment system 200 may increase or decrease the water pressure in the water treatment system 200.

The water treatment system 200 may include the prefiltration unit 210. The prefiltration unit 210 may be provided in the form of one or more prefilter elements having one or more filter media. The prefiltration unit 210 may include a first prefilter element 210a and a second prefilter element 210b. The first prefilter element 210a may be in fluid communication with the inlet line 204 and the second prefilter element 210b. The second prefilter element 210b may be in fluid communication with the first prefilter element 210a and a prefiltered water line 212. Alternatively, the second prefilter element 210b may be in fluid communication with the inlet line 204 and the first prefilter element 210a, and the first prefilter element 210a may be in fluid communication with the second prefilter element 210b and the prefiltered water line 212.

Inlet water may enter the prefiltration unit 210 via the inlet line 204 and exit the prefiltration unit 210 via the prefiltered water line 212. When inlet water passes through the prefiltration unit 210, the prefiltration unit 210, via the first prefilter element 210a and the second prefilter element 210b, may remove sediment, particulates, certain chemicals and other contaminants from the inlet water, producing a prefiltered water that may flow out of the prefiltration unit 210 via the prefiltered water line 212.

In some embodiments, the first prefilter element 210a may be provided in the form of a sediment filter. The sediment filter may remove sediments, such as sand, silt, and dirt, and other particulates such as rust from the inlet water. In some embodiments, the sediment filter may include a filter media including pores with a pore size of no more than 5 microns, or no more than about 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some embodiments, the sediment filter may include a depth media, woven fabric, or nonwoven fabric.

In some embodiments, the second prefilter element 210b may be provided in the form of an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like. In some embodiments, a non-carbon-based media, such as clay or an ion exchange media, may be used in place of the activated carbon media.

By removing sediment, chlorine, chloramine, and other contaminants, the prefiltration unit 210 may provide prefiltered water that may have substantially no odor and have an improved taste compared to the inlet water. In addition, by removing sediment, chlorine, chloramine, and other contaminants the prefiltration unit 210 may protect the downstream membrane element 234 from sediment fouling or oxidation.

In some embodiments, the prefiltration unit 210 may be defined by a series of prefilter elements (e.g., two or more sediment filters) or may be comprised of a combination of prefilter elements (e.g., one or more sediment filters and one or more activated carbon filters). One ordinary skill in the art would understand that the one or more prefilter elements that comprise the prefiltration unit 210 may be retained within a single prefiltration element or may be separate and distinct prefilter elements (as shown in FIG. 2) that are in fluid communication with one another. In some embodiments, the prefiltration unit 210 may be a PENTAIR® EVERPURE® filter. In other embodiments, the prefiltration unit 210 may be a PENTAIR® PENTEK® BIG BLUE® filter.

The water treatment system 200 may include one or more flowmeters 214. In some embodiments, the one or more flowmeters 214 may be provided as a mechanical flowmeter or an ultrasonic flowmeter. In some embodiments, the one or more flowmeters may include a ⅜ inch (0.95 centimeters) F-nut inflow connector, a ⅜ inch (0.95 centimeters) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 214 may be a 0.26-16 GPM turbine flowmeter, a 0.26-7.9 GPM turbine flowmeter, or a 0.26-0.65 turbine flowmeter. One of ordinary skill in the art would understand that each of the one or more flowmeters 214a-214d may be the same type of flowmeter or may each be a different type of flowmeter.

A first flowmeter 214a may be positioned within or otherwise in fluid communication with the prefiltered water line 212. The first flowmeter 214a may measure, monitor, or sense the flow rate of the prefiltered water through the prefiltered water line 212.

The water treatment system 200 may include one or more TDS sensors 216. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about #10% Full Scale (25° C.). In some embodiments, the one or more TDS sensors 216 may be a TDS sensor having a TDS measurement range of at least about 0 to about 3000 ppm or greater than about 3000 ppm. One of ordinary skill in the art would understand that each of the one or more TDS sensors 216a-216h may be the same type of TDS sensor or may each be a different type of TDS sensor.

A first TDS sensor 216a may be in fluid communication with the prefiltered water line 212. The first TDS sensor 216a may measure, monitor, or sense the conductivity of the prefiltered water to determine the concentration or amount of dissolved solids in the prefiltered water.

The water treatment system 200 may include a second pressure sensor 206b that may be in fluid communication with the prefiltered water line 212. The second pressure sensor 206b may measure, monitor, or sense the pressure of the prefiltered water in the prefiltered water line 212.

The water treatment system 200 may include a temperature sensor 222 that may be in fluid communication with the prefiltered water line 212. The temperature sensor 222 is designed to measure, monitor, or sense the temperature of the prefiltered water. In some embodiments, the temperature sensor 222 may be thermistor, a thermocouple, a semiconducting material, and any other mechanical or electronic sensor that may respond to a change in temperature. In some embodiments, additional temperature sensors may be included in the water treatment system 200. In some embodiments, an additional temperature sensor may be optionally placed on or within the inlet line 204.

The water treatment system 200 may include the tank 218. The tank 218 may be used to store water. The tank 218 may be defined by a housing having a bottom portion 218a, a center portion 218b, and a top portion 218c. In some instances, each of the portions 218a, 218b, 218c may be separated by a physical barrier (e.g., if the tank 218 is provided as a bladder tank), although in preferred embodiments no physical barrier is positioned between the portions 218a, 218b, 218c. In some embodiments, the tank 218 may be a flow through tank, which may allow for the seamless delivery of water to a point of use (POU). In some embodiments, the tank 218 may be a pressurized tank. In some embodiments, the tank 218 may be a fiberglass reinforced plastic (FRP) tank. In some embodiments, the tank 218 may range in size from about 24 gallons (91 liters) to about 200 gallons (757 liters). In other embodiments, multiple tanks 218 of any size may be connected in series. In further embodiments, existing water vessels within the residential or commercial property (e.g., a water heater) may be used for additional storage capacity.

The tank 218 may include a riser tube 220 that extends upwardly vertically from the bottom portion 218a of the tank 218 to the top portion 218c of the tank 218, or vice versa. The riser tube 220 may be in fluid communication with the prefiltered water line 212. In some embodiments, the riser tube 220 may be provided as PVC tubing.

The tank 218 may further include a flow distributor 224, which may be attached or coupled to the riser tube 220. The flow distributor 224 may prevent or reduce the mixing of higher TDS water that may be stored in the bottom portion 218a of the tank 218 with lower TDS water that may be stored in the top portion 218c of the tank 218. In some embodiments, the flow distributor 224 may be a dome flow distributor. In some embodiments, multiple flow distributors 224 may be used.

Additionally, or alternatively, the tank 218 may include baffles and external plumbing (e.g., flow distributors) to reduce the mixing of higher TDS water that may be stored in the bottom portion 218a of the tank 218 with lower TDS water that may be stored in the top portion 218c of the tank 218.

In some embodiments, the high TDS water is added to the bottom portion 218a of the tank 218 and the low TDS water is added to the top portion 218c of the tank 218. Advantageously, adding the high TDS water and the low TDS water to the tank 218 in this manner helps maintain the separation between the high TDS water and the low TDS water in the tank 218, which in turn helps ensure that low TDS water is provided to a point of use during operation of the tank 218.

The water treatment system 200 may include an additive line 226. The additive line 226 may be physically connected to or otherwise in fluid communication with the prefiltered water line 212.

A second flowmeter 214b may be positioned within or otherwise in fluid communication with the additive line 226. The second flowmeter 214b may measure, monitor, or sense the flow rate of the prefiltered water through the additive line 226.

The prefiltered water may have a fluid flow path through the water treatment system 200. In some embodiments, depending on the flow conditions when the water treatment system 200 is in use, the prefiltered water may flow in different directions as described in more detail below (see, e.g., FIG. 7). For example, during some flow conditions, the prefiltered water may flow directly from the prefiltration unit 210 through the prefiltered water line 212, down the riser tube 220, and into the bottom portion 218a of the tank 218. The prefiltered water may be stored in the tank 218. During other flow conditions, the prefiltered water may also flow from the prefiltration unit 210 via the prefiltered water line 212 toward the membrane element 234 via the additive line 226. During further flow conditions, the prefiltered water may flow from the bottom portion 218a of the tank 218, up the riser tube 220, through the prefiltered water line 212 toward the membrane element 134 via the additive line 226.

The water treatment system 200 may include the feeder 228 that is in fluid communication with the additive line 226. The feeder 228 may introduce or add a chemical additive to the prefiltered water. In some embodiments, the chemical additive may be an anti-scaling agent to reduce corrosion or scale on a feed side of a membrane element. In some embodiments, the chemical additive may be a polyphosphate compound.

In some embodiments, when the prefiltered water flows through or passes the feeder 228, the chemical additive may be added or introduced to the prefiltered water. The chemical additive may dissolve or otherwise degrade in the prefiltered water. In some embodiments, as further detailed herein, the feeder 228 may impart the water flowing through the feeder 228 with a chemical additive concentration of at least about 0.01 ppm to at least about 10 ppm or 0.01 ppm to 10 ppm. In other embodiments, the feeder 228 may impart the water flowing through the feeder 228 with chemical additive concentration of somewhat less than 0.01 ppm or greater than 10 ppm of the chemical additive.

The water treatment system 200 may include a second valve 229a. The second valve 229a may be in fluid communication with the additive line 226. In some embodiments, the second valve 229a may be an actuated ball valve. In some embodiments, the second valve 229a may be a gate valve, a butterfly valve, a globe valve, a pressure relief valve, or a check valve. In some embodiments, the second valve 229a may be positioned upstream of the feeder 228 or downstream of the pump 230.

The second valve 229a may be used to control or regulate the amount of prefiltered water (with or without additive) flowing through the additive line 226. The second valve 229a may open, either partially or fully, to enable the flow or increase the amount of prefiltered water (with or without additive) flowing through the additive line 226 toward the pump 230. The second valve 229a may close, either partially or fully, to stop or decrease the flow or amount of prefiltered water (with or without additive) flowing through the additive line 226 toward the pump 230.

The water treatment system 200 may include a third pressure sensor 206c that may be in fluid communication with the additive line 226. The third pressure sensor 206c may measure, monitor, or sense the pressure of the prefiltered water with additive in the additive line 226. Alternatively, if a chemical additive is not added by the feeder 228, the third pressure sensor 206c may measure, monitor, or sense the pressure of the prefiltered water in the additive line 226.

The water treatment system 200 may include a second TDS sensor 216b. The second TDS sensor 216b may be in fluid communication with the additive line 226. The second TDS sensor 216b may measure, monitor, or sense the conductivity of the prefiltered water (with or without additive) to determine an amount or concentration of dissolved solids in the prefiltered water (with or without additive). The prefiltered water with additive may have a higher TDS than the prefiltered water without additive.

The water treatment system 200 may include the pump 230. An inlet side (not shown) of the pump 230 may be in fluid communication with the additive line 226, and an outlet side (not shown) of the pump 230 may be in fluid communication with a membrane feed line 232. In some embodiments, the pump 230 may be a single-phase booster pump. For example, the pump 230 may be a PENTAIR® STA-RITE™ single phase 115 volt, ¾ horsepower pump. In some embodiments, the pump 230 may be a multi-phase booster pump. In some embodiments, the pump 230 may boost differential pressure in the membrane feed line 232 to 120-250 pounds per square inch (827-1725 kilopascals) at a flow rate of 1.0-7.0 gallons per minute (3.5-26 liters per minute) or at a preferable flow rate of 2.0-5.0 gallons per minute (7.5-19 liters per minute).

The membrane feed line 232 may be in fluid communication with a fourth pressure sensor 206d. The fourth pressure sensor 206d may measure, monitor, or sense the pressure of the prefiltered water (with or without additive) in the membrane feed line 232.

The water treatment system 200 may include the membrane element 234. In some embodiments, the membrane element 234 may be a reverse osmosis (RO) membrane. In some embodiments, the RO membrane may be spiral wound and may include feed spacers imparted with a certain thickness and/or structure. In some embodiments, the RO membrane may be a spiral would RO membrane (e.g., a spiral would 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membrane may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membrane may be a spiral wound RO membrane (e.g., a spiral wound 4040 RO membrane) with feed spacers imparted with a thickness of at least 8 mil to no more than 40 mil. For example, the feed spacers may be imparted with a thickness of no more than 8 mil, or no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membrane may be a spiral wound RO membrane (e.g., a spiral wound 4040 RO membrane) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membrane may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membrane may be a spiral wound RO membrane (e.g., a spiral wound 4040 RO membrane) with feed spacers imparted with a thickness of at least 0.2 millimeters to no more than 1.1 millimeters. For example, the RO membrane may have feed spacers imparted with a thickness of no more than 0.2 millimeters, or no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the membrane element 234 may be a nanofiltration (NF) membrane, an ultrafiltration (UF) membrane, a microfiltration (MF) membrane, or a particulate membrane. In some embodiments, the membrane element 234 may be a hollow fiber NF membrane. In other embodiments, the membrane element 234 may be an electrodialysis membrane system.

In some embodiments, the membrane element 234 may comprise a combination of one or more of a RO membrane, a NF membrane, a UF membrane, a MF membrane, a particulate membrane, and/or an electrodialysis membrane, which may be disposed in parallel or in series. For example, in some embodiments, the combination of membranes may include at least one RO membrane and at least one NF membrane. The at least one RO membrane may be disposed in parallel with the at least one NF membrane, or the RO membrane may be disposed before or after the at least one NF membrane in series. In other embodiments, the combination of membrane elements may include at least one UF membrane and at least one MF membrane. The at least one UF membrane may be disposed in parallel with the at least one MF membrane, or the at least one UF membrane may be disposed before or after the at least one MF membrane in series. The one or more membranes in the combination of membranes may be contained within a single housing, in separate housings, or a combination thereof.

In further embodiments, the membrane element 234 may include two or more RO membranes, NF membranes, a UF membrane, a MF membrane, a particulate membrane, and/or electrodialysis membranes, which may be disposed in parallel or in series. In some embodiments, the membrane element 234 may be a series of membranes of the same type (e.g., two or more RO membranes) but of a different size. For example, the membrane element 234 may include a first membrane imparted with a first diameter and a second membrane imparted with a second diameter that is different than the first diameter (e.g., the second diameter may be less than the first diameter). In some embodiments, the first membrane may be a spiral wound 4040 RO membrane and the second membrane may be a spiral wound 2540 RO membrane. The two or more membranes may be contained within a single housing, in separate housings (e.g., as shown in FIG. 4D), or a combination thereof.

Varying the membrane type and/or size can be used to optimize the level of permeate production, allowing for enhanced water recovery, while at the same time balancing factors such as a particular permeate water chemistry and membrane health. For example, in some embodiments, including at least one NF membrane as a first or second membrane in a series may allow for higher total permeate output as compared to utilizing two RO membranes. In other embodiments, including two or more RO membranes in series, for example, may help maintain a higher velocity on the feed side of the individual membranes, which in turn may reduce ion concentration at the membrane surface of each membrane. In addition, including two or more RO membranes in series may enable the operation of the individual RO membranes at different membrane recoveries, which may help optimize permeate production as dissolved mineral content increases.

In further embodiments, using a smaller membrane as a second membrane in a series of membranes, where the first membrane has a larger diameter than the diameter of the second membrane, may allow the water entering the second membrane to have a higher velocity, which may boost overall water recovery. For instance, in some embodiments, if the water treatment system 200 is operating at an approximately 80% recovery, and a spiral wound 4040 RO membrane is used as the first membrane in a series of membranes and a spiral wound 2540 RO membrane is used as a second membrane in the series of membranes, the total water recovery of the water treatment system 200 may be increased to at least about a 94% recovery.

The membrane element 234 may be in fluid communication with the membrane feed line 232 on a feed side (not shown) of the membrane element 234. The membrane element 234 also may be in fluid communication with the retentate line 236 on the feed side of the membrane element 234. The membrane element 234 may be in fluid communication with a membrane permeate line 238 on a permeate side (not shown) of the membrane element 234.

In some embodiments, as the prefiltered water (with or without additive) enters the feed side of the membrane element 234, the membrane element 234 may allow a solvent (e.g., water) in the prefiltered water to pass through a surface of a membrane (not shown) retained within the membrane element 234. The solvent that passes through the surface of the membrane may exit from the permeate side of the membrane element 234 as membrane permeate via the membrane permeate line 238. Solutes (e.g., dissolved minerals and ions and various organic compounds) in the prefiltered water may not pass through the membrane and may be retained at the surface of the membrane. The solutes may be discharged from the feed side of the membrane element 234 as retentate via the retentate line 236.

In some embodiments, when the pump 230 is activated, the pump 230 may increase the rate at which water flows into the membrane feed line 232 toward the membrane element 234. Increasing the flow rate of water into the membrane feed line 232 may increase pressure in the membrane feed line 232. The increased pressure in turn may aid in pushing solvent in the membrane feed line 232 through the pores formed within the surface of the membrane retained within the membrane element 234.

The water treatment system 200 may include a fifth pressure sensor 206e that may be in fluid communication with the retentate line 236. The fifth pressure sensor 206e may measure, monitor, or sense the pressure of the retentate in the retentate line 236.

The water treatment system 200 may include a flow restrictor tube 239 that may be in fluid communication with the retentate line 236. The flow restrictor tube 239 may be used to control or regulate the amount of retentate leaving the water treatment system 200 via the retentate line 236 into a drain 241. In some embodiments, the flow restrictor tube 239 may be a capillary tube imparted with an inner diameter of at least about 1/16 inches (at least about 1.6 mm) to no more than about ⅛ inches (no more than about 3.2 mm). In some embodiments, the flow restrictor tube 239 may be imparted with a length of at least about 1 inch (at least about 2.5 centimeters) to at least about 4 feet (at least about 122 cm). For example, the flow restrictor tube 239 may be imparted with a length of no less than 1 foot (30.5 centimeters) and no more than 3 feet (91.4 centimeters). In some embodiments, the flow restrictor tube 239 may be provided in the form of material that has a low energy surface to prevent the formation of scale on the surface of the flow restrictor tube 239, given that retentate may be beyond the saturation limit of the water. For example, the flow restrictor tube 239 may be made from polyethylene tubing. In further embodiments, a valve may be used instead of or in combination with the flow restrictor tube 239. The amount of retentate exiting the water treatment system 200 into the drain 241 may increase or decrease the water pressure in the water treatment system 200.

The water treatment system 200 may include a third flowmeter 214c. The third flowmeter 214c may be positioned within or otherwise in fluid communication with the retentate line 236. The third flowmeter may measure, monitor, or sense the flow rate of the retentate in the retentate line 236.

The water treatment system 200 may include a third TDS sensor 216c that may be in fluid communication with the retentate line 236 and the drain 241. The third TDS sensor 216c may measure, monitor, or sense the conductivity of the retentate to determine an amount or concentration of dissolved solids in the retentate.

The water treatment system 200 may include a sixth pressure sensor 206f that may be in fluid communication with the membrane permeate line 238. The sixth pressure sensor 206f may measure, monitor, or sense the pressure of the membrane permeate in the membrane permeate line 238.

The water treatment system 200 may include a fourth TDS sensor 216d that may be in fluid communication with the membrane permeate line 238. The fourth TDS sensor 216d may measure, monitor, or sense the conductivity of the membrane permeate to determine an amount or concentration of dissolved solids in the membrane permeate.

The membrane permeate line 238 may be connected to or otherwise in fluid communication with a tank line 244. The tank line 244 may be in fluid communication with the top portion 218c of the tank 218. The tank line 244 also may be connected to or otherwise in fluid communication with an outlet feed line 246. The outlet feed line 246 may be in fluid communication with the outlet 248 of the water treatment system 200.

In some embodiments, depending on the flow conditions when the water treatment system 200 is in use, the membrane permeate may flow from the permeate side of the membrane element 234 through the membrane permeate line 238 and the tank line 244 into the top portion 218c of the tank 218. The membrane permeate may be stored in the tank 218. The membrane permeate may also flow from the permeate side of the membrane element 234 through the membrane permeate line 238 to the tank line 244, into the outlet feed line 246 (thereby bypassing the tank 218), and out of the outlet 248. By enabling the flow of membrane permeate from the membrane element 234 directly to the outlet 248, membrane permeate may be provided to a point of use in real time.

Due to the amount of dissolved ions in high TDS water, high TDS water tends to have a higher density than low TDS water. By sending higher TDS water (e.g., the prefiltered water) to the bottom portion 218a of the tank 218 and lower TDS water (e.g., the membrane permeate) to the top portion 218c of the tank 218, the chances of water with different TDS amounts or concentrations mixing inside the tank 218 may be minimized. Thus, when water is later drawn from the top portion 218c of the tank 218, low TDS water may be provided to the point of use. Sending higher TDS water to the bottom of the tank 218 and lower TDS water to the top of the tank 218 may also create a sharp TDS profile along the vertical height of the tank 218, where the amount or concentration of TDS at the bottom portion 218a of the tank 218 is the highest (e.g., a TDS concentration of more than or about 3.5 grains per gallon (60 milligrams per liter)), and the amount or concentration of TDS at the top portion 218c of the tank 218 is the lowest (e.g., a TDS concentration of less than or about 3.5 grains per gallon (60 milligrams per liter)). Creating and maintaining this sharp TDS profile is aided by the density difference between the high TDS water and the low TDS water.

The water treatment system 200 may include a third valve 242 that may be in fluid communication with the membrane permeate line 238. In some embodiments, the third valve 242 may be a check valve. In some embodiments, the third valve may be a butterfly valve, a ball valve, a globe valve, a pressure relief valve, or a gate valve.

The third valve 242 may be used to control or regulate the amount of membrane permeate entering or flowing through the membrane permeate line 238 into the tank line 244 and into the top portion 218c of the tank 218 or out of the outlet 248 via the outlet feed line 246. The third valve 242 may open, either partially or fully, to enable or increase the flow or the amount of membrane permeate flowing through the membrane permeate line 238 to the tank line 244, and into the top portion 218c of the tank 218 or into the outlet feed line 246 and out of the outlet 248. The third valve 242 may close, either partially or fully, to stop or decrease the amount of membrane permeate flowing through the membrane permeate line 238 and the tank line 244, into the top portion 218c of the tank 218 or into the outlet feed line 246 and out of the outlet 248. The amount of membrane permeate entering or flowing through the membrane permeate line 238 and into the tank 218 or out of the outlet 248 may increase or decrease the water pressure in the water treatment system 200. In some instances, the third valve 242 may be a check valve that is used to prevent backflow through the tank line 244, which in turn helps protect the membrane element 234.

In some embodiments, the tank 218 may include a fifth TDS sensor 216e disposed in the top portion 218c, a sixth TDS sensor 216f disposed in the center portion 218b of the tank 218, and/or a seventh TDS sensor 216g disposed in the bottom portion 218a of the tank 218. The fifth TDS sensor 216e may measure, monitor, or sense the conductivity of the water in the top portion 218c of the tank 218 to determine an amount or concentration of dissolved solids in the water located in the top portion 218c of the tank 218. The sixth TDS sensor 216f may measure, monitor, or sense the conductivity of the water in the center portion 218b of the tank 218 to determine an amount or concentration of dissolved solids in the water located in the center portion 218b of the tank 218. The seventh TDS sensor 216g may measure, monitor, or sense the conductivity of the water in the bottom portion 218a of the tank 218 to determine an amount or concentration of dissolved solids in the water located in the bottom portion 218a of the tank 218. The fifth, sixth, and seventh TDS sensors (216e, 216f, and 216g, respectively) may create a profile of the TDS levels or concentrations of the water in the tank 218.

In some embodiments, the tank 218 may include zero, one, two, or more TDS sensors disposed in each of the top, center, or bottom portions of the tank 218. For example, in some embodiments, a TDS sensor may only be disposed in the center portion 218b of the tank, not the top portion 218c or the bottom portion 218a. In other embodiments, a TDS sensor may be disposed in each of the top portion 218c and the bottom portion 218a of the tank 218, but not the center portion 218b. In further embodiments, zero TDS sensors may be disposed in the tank 218.

The water (i.e., membrane permeate (lower TDS water) or the prefiltered water (higher TDS water)) that may be stored in the tank 218 may flow through the tank line 244 and the outlet feed line 246 out of the outlet 248. The outlet 248 may be in fluid communication with various appliances, fixtures, and plumbing of the residential or commercial property. In some embodiments, the outlet 248 may be in fluid communication with a water heater, faucets, fixtures, or toilets via one or more pipes or tubes.

The water treatment system 200 may include a seventh pressure sensor 206g in communication with the outlet feed line 246. The seventh pressure sensor 206g may measure, monitor, or sense the pressure of the water in the outlet feed line 246.

The water treatment system 200 may include an eighth TDS sensor 216h in communication with the outlet feed line 246. The eighth TDS sensor 216h may measure, monitor, or sense the conductivity of the water in the outlet feed line 246 to determine an amount or concentration of the dissolved solids in the water in the outlet feed line 246.

The water treatment system 200 may include a fourth flowmeter 214d may be positioned within or otherwise in communication with the outlet feed line 246. The fourth flowmeter 214d may measure, monitor, or sense the flow rate of the water in the outlet feed line 246.

The water treatment system 200 may include a fourth valve 208b that may be in fluid communication with the outlet feed line 246. In some embodiments, the fourth valve 208b may be a gate valve. In some embodiments, the fourth valve 208b may be a bypass valve, a solenoid valve, a butterfly valve, a ball valve, a globe valve, a pressure relief valve, or a check valve.

The fourth valve 208b may be used to control or regulate the amount of water (e.g., membrane permeate or prefiltered water) flowing from the tank 218, through the tank line 244, into the outlet feed line 246, and out of the outlet 248 or from the membrane element 234, through the tank line 244, into the outlet feed line 246, and out of the outlet 248. The fourth valve 208b may open, either partially or fully, to enable or increase the flow or the amount of water from the tank 218 or the membrane element 234, through the tank line 244, into the outlet feed line 246, and out of the outlet 248. The fourth valve 208b may close, either partially or fully, to stop or decrease the amount of water flowing from the tank 218 or the membrane element 234, through the tank line 244, into the outlet feed line 246 and out of the outlet 248. The amount of water flowing through the outlet feed line 246 and out of the outlet 248 may increase or decrease the water pressure in the water treatment system 200.

Preferably, the first valve 208a and the fourth valve 208b are provided as on/off valves that can substantially or completely stop the flow of water through the system 200. In such embodiments, the first valve 208a and the fourth valve 208b may be provided as ball valves, solenoid valves, or other similarly functioning valves.

The water treatment system 200 may include the permeate flush line 252. The permeate flush line 252 may be physically connected to or otherwise in fluid communication with the tank line 244 and the additive line 226. In some embodiments, the permeate flush line 252 may be physically connected to or otherwise in fluid communication with the tank line 244 and the pump 230. In some embodiments, the permeate flush line 252 can be connected or coupled to any conduit of the water treatment system 200 that is downstream of the second valve 229a (e.g., the membrane feed line 232).

The water treatment system 200 may include a fifth valve 229b that may be in fluid communication with the permeate flush line 252. In some embodiments, the fifth valve 229b may be an actuated ball valve. In some embodiments, the fifth valve 229b may be a gate valve, a butterfly valve, a globe valve, a pressure relief valve, or a check valve.

The fifth valve 229b may be used to control or regulate the amount of membrane permeate entering or flowing through the permeate flush line 252 from the tank line 244 and into the membrane feed line 232 and, eventually, to the retentate line 236 via the membrane element 234. The fifth valve 229b may open, either partially or fully, to enable or increase the flow or the amount of membrane permeate flowing from the top portion 218c of the tank 218, into the tank line 244, through the permeate flush line 252, and into the membrane feed line 232 and the retentate line 236 via the membrane element 234. The fifth valve 229b may close, either partially or fully, to stop or decrease the amount of membrane permeate flowing from the top portion 218c of the tank 218, into the tank line 244, through the permeate flush line 252, and into the membrane feed line 232 and the retentate line 236 via the membrane element 234. The amount of membrane permeate entering or flowing through the permeate flush line 252 to the membrane feed line 232 and the retentate line 236 via the membrane element 234 may increase or decrease the water pressure in the water treatment system 200.

In some embodiments, depending on flow conditions, when the water treatment system 200 is in use, membrane permeate from the top portion 218c of the tank 218 may flow through the tank line 244 and the permeate flush line 252 into the membrane feed line 232 toward the membrane element 234. The membrane permeate may be recirculated through the membrane feed line 232 and into the feed side of the membrane element 234. The recirculation of the membrane permeate through the membrane feed line 232 may be aided by the pump 230 when activated or may be caused by pressure within the water treatment system 200 when the pump 230 is turned off. The membrane permeate may be used to clean the membrane element 234 by flushing solutes (e.g., ions) from the surface of the membrane element 234. The membrane permeate used to clean or flush the surface of the membrane element 234 may then be discharged through the retentate line 236.

In some embodiments, the second valve 229a may be closed and the fifth valve 229b may be opened. In this instance, the pump 230 may be activated such that membrane permeate from the membrane element 234 may flow directly from the membrane element 234 to the permeate flush line 252, through the membrane feed line 232 and into the membrane element 234 to clean or flush the surface of the membrane element 234.

The water treatment system 200 may include an optional mineralization unit (not shown). The mineralization material may be provided as a calcium-containing compound or a magnesium-containing compound, although other ionic compounds could also be used to increase the mineral or TDS concentration of the water provided by the system 200 to a point of use. The mineralization material may be, for example, a calcium carbonate compound (CaCO₃), a magnesium carbonate compound (MgCO₃), a magnesium oxide compound (MgO), a calcium oxide compound (CaO), a sodium bicarbonate compound (NaHCO₃), dolomite (CaMg(CO₃)₂), other substances with similar chemical and physical properties, and combinations thereof. In some instances, the mineralization compound may be selected from the group consisting of a calcium carbonate compound (CaCO₃), a magnesium carbonate compound (MgCO₃), a magnesium oxide compound (MgO), a calcium oxide compound (CaO), a sodium bicarbonate (Na₂CO₃) compound, a sodium bicarbonate compound (NaHCO₃), a potassium carbonate (K₂CO₃) compound, a potassium bicarbonate (KHCO₃) compound, dolomite (CaMg(CO₃)₂), and combinations thereof. In instances where the mineralization material includes a calcium carbonate compound, the calcium carbonate may be provided in the form of calcite. In some instances, a magnesium oxysulfate compound may be used as the mineralization material.

In some embodiments, the mineralization unit may be a device containing a mineralization material that has an inlet and an outlet through which water passes. For example, the mineralization unit may be provided as a cartridge that may be replaced when the mineralization material is depleted. In some embodiments, the mineralization unit may include a bed or cartridge of mineralization material disposed on a line (e.g., outlet feed line 246) or other system component of the water treatment system 200, which water passes by but does not flow through.

The mineralization unit may generally be disposed on or coupled to various system components or lines of the system 200 that are positioned downstream of the membrane element 234. In some embodiments, the mineralization unit may be disposed on or coupled to the outlet feed line 246 upstream of the outlet 248 (see, e.g., mineralization unit 380 in FIG. 4A). The mineralization unit may introduce a mineralization material to the membrane permeate before the membrane permeate exits the water treatment system 200 via the outlet 248. In some embodiments, the mineralization unit may be disposed on the membrane permeate line 238 or the tank line 244. For example, the mineralization unit may be disposed on the membrane permeate line 238 or the tank line 244 proximate the tank 218 so that the membrane permeate is introduced to the mineralization material before the membrane permeate flows into the top portion 218c of the tank 218. In other embodiments, the mineralization unit may be disposed within a top portion 218c of the tank 218 so that the membrane permeate is introduced to the mineralization material as the membrane permeate flows into or out of the top portion 218c of the tank 218. In further embodiments, the mineralization unit may be disposed within a top portion 218c of the tank 218 so that the membrane permeate contacts the mineralization material in the mineralization unit while the membrane permeate is stored in the tank 218, including during periods when there is no flow of membrane permeate into or out of the tank 218. In other embodiments, the mineralization unit may be provided as a solid block of mineralization material (e.g., as a block of calcite) that is disposed within the tank 218 or within one of the lines or another system component of the water treatment system 200.

The mineralization material introduced or otherwise provided by the mineralization unit may change a quality or characteristic of the membrane permeate such as the pH level and/or the TDS level. The changing of a quality or characteristic of the membrane permeate may improve the aesthetics (e.g., taste) of the membrane permeate and/or reduce the possible corrosion of metal plumbing and appliances downstream from the water treatment system 200. One or more pH sensors may be disposed proximate to the mineralization unit to monitor the pH level of the membrane permeate before and/or after the membrane permeate passes by or through the mineralization unit. Additionally, or alternatively, one or more TDS sensors may be disposed proximate the mineralization unit to monitor the TDS level of the membrane permeate before and/or after the membrane permeate passes by or through the mineralization unit.

The re-mineralized membrane permeate that exits or results from passing by or through the mineralization unit may be imparted with a TDS concentration of at least about 20 ppm to at least about 1000 ppm, or at least about 50 ppm to at least about 500 ppm, or at least about 100 ppm to at least about 400 ppm. In some instances, the re-mineralized membrane permeate that exits or results from passing by or through the mineralization unit may be imparted with a TDS concentration less than about 20 ppm or greater than about 1000 ppm. In some instances, it is preferred to impart the re-mineralized water with a TDS concentration of at least about 50 ppm or at least 50 ppm.

In other embodiments, the re-mineralized membrane permeate that exits or results from passing by or through the mineralization unit may be imparted with a TDS concentration of at least 20 ppm to at least 1000 ppm, or at least 50 ppm to at least 500 ppm, or at least 100 ppm to at least 400 ppm. In some instances, the re-mineralized membrane permeate that exits or results from passing by or through the mineralization unit may be imparted with a TDS concentration less than 20 ppm or greater than 1000 ppm.

In some embodiments, the re-mineralized membrane permeate may be imparted with a TDS concentration of at about least 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more.

In other embodiments, the re-mineralized membrane permeate may be imparted with a TDS concentration of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In further embodiments, the re-mineralized membrane permeate that exits or results from passing by or through the mineralization unit may be imparted with a pH value within drinkable limits (e.g., between about 7 to about 10, or between 7 to 10). In some embodiments, the re-mineralized membrane permeate that exits or results from passing by or through the mineralization unit is imparted with a pH value of about 7, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In some embodiments, the re-mineralized membrane permeate that exits or results from passing by or through the mineralization unit is imparted with a pH value of 7, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

Referring again to FIG. 2, in some instances, a temperature control element 281 is placed in fluid communication with the membrane feed line 232 by one or more pipes 282. For the sake of clarity, only a single pipe 282 is illustrated in FIG. 2, although additional pipes 282 may be used to carry water to and from the temperature control element 281. In other instances, the temperature control element 281 may be directly coupled to or provided in the flow path of the membrane feed line 232 (e.g., the temperature control element 281 may be provided in-line with the membrane feed line 232 and the one or more pipes 282 may be omitted). The temperature control element 281 may be designed to increase and/or decrease the temperature of a water stream of a solution. In instances in which the temperature control element 281 is provided, some, substantially all, or all of the water flowing through the membrane feed line 232 may be provided to the temperature control element 281 before being provided to the membrane element 234. The temperature control element 281 may be utilized to increase or decrease the temperature of a solution (e.g., a water stream, the prefiltered water, a prefiltered water dosed with a chemical cleaning agent or a chemical additive, permeate water dosed with a chemical additive, etc.) entering the membrane feed line 232, which in turn may increase or decrease the temperature of the solution within the membrane element 234 and/or the temperature of the membrane element 234 itself. In some instances, the temperature control element 281 may be directly coupled to the membrane element 234 or provided within the membrane element 234 such that the temperature control element 281 may increase or decrease the temperature of the solution within the membrane element 234 and/or the temperature of the membrane element 234 itself.

In some instances, the water stream provided to the temperature control element 281 may be imparted with a first temperature. When the temperature control element 281 is activated, the stream exiting the temperature control element 281 may be imparted with a second temperature or a third temperature. In some cases, the second temperature is about equal to or greater than the first temperature and the third temperature is about equal to or less than the first temperature.

In some instances, the second temperature may be imparted with a value of about 15° C. to about 95° C., although the second temperature may be somewhat less than or somewhat greater than these values. For example, the second temperature may be imparted with a value of at least about 15° C., or at least about 20° C., or at least about 25° C., or at least about 30° C., or at least about 35° C., or at least about 40° C., or at least about 45° C., or at least about 50° C., or at least about 55° C., or at least about 60° C., or at least about 65° C., or at least about 70° C., or at least about 75° C., or at least about 80° C., or at least about 85° C., or at least about 90° C., or at least about 95° C. In other instances, the second temperature may be imparted with a value of 15° C. to 95° C., although the second temperature may be somewhat less than or somewhat greater than these values. For example, the second temperature may be imparted with a value of at least 15° C., or at least 20° C., or at least 25° C., or at least 30° C., or at least 35° C., or at least 40° C., or at least 45° C., or at least 50° C., or at least 55° C., or at least 60° C., or at least 65° C., or at least 70° C., or at least 75° C., or at least 80° C., or at least 85° C., or at least 90° C., or at least 95° C.

In some instances, the third temperature may be imparted with a value of about 0° C. to about 20° C., although the third temperature may be somewhat less than or somewhat greater than these values. For example, the third temperature may be imparted with a value of no more than about 20° C., or no more than about 15° C., or no more than about 10° C., or no more than about 5° C., or no more than about 0° C. In other instances, the third temperature may be imparted with a value of 0° C. to 20° C., although the third temperature may be somewhat less than or somewhat greater than these values. For example, the third temperature may be imparted with a value of no more than 20° C., or no more than 15° C., or no more than 10° C., or no more than 5° C., or no more than 0° C.

In some instances, the chemical additive used in the membrane flush or other cleaning processes may be introduced directly to the membrane element 234. Alternatively, or the chemical additive may be introduced to a water stream upstream of the membrane element 234 (e.g., the chemical additive may be provided to the water stream flowing through the membrane feed line 232). In some instances, the chemical additive may be provided from a dosing mechanism 284 to the membrane element 234 or water stream via a dosing conduit 286 that is coupled to the membrane element or the water stream. Alternatively, the dosing mechanism 284 may be provided in-line within the water treatment system 200 (e.g., in-line with the membrane feed line 232) and the dosing conduit 286 may be omitted. In cases in which the dosing conduit 286 is directly coupled to the membrane element 234, the dosing conduit may couple to a port of the membrane element 234 that is in fluid communication with the interior of the membrane element 234.

In various instances, the dosing mechanism 284 may be designed to meter, dose, or otherwise provide an amount of the chemical additive to a water stream or directly to the membrane element 234. For example, in some instances, the dosing mechanism 284 may be provided in the form of a flow control valve, a blend valve, a fixed orifice, a venturi meter, a metering pump, a piston valve, and/or a micro-doser.

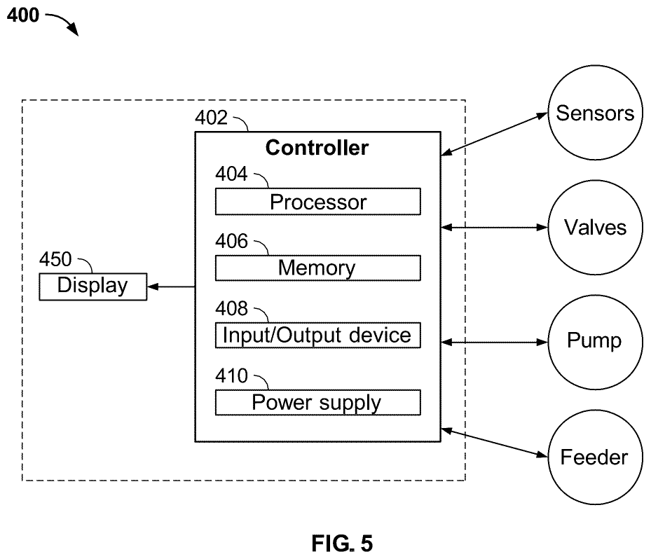

The water treatment system 200 may include and be in communication with a control system 400. The control system 400 may include the controller 402 and a display 450. As shown in FIG. 5, the controller 402 may be electronically connected to and may be in electronic communication with the display 450. The controller 402 also may be electronically connected to and may be in electronic communication with one or more of the water treatment system components including the one or more sensors (206a-206g, 214a-214d, 216a-216h, and 222), the first, second, third, fourth, or fifth valves (208a, 229a, 242, 208b, and 229b, respectively), the feeder 228, and/or the pump 230.

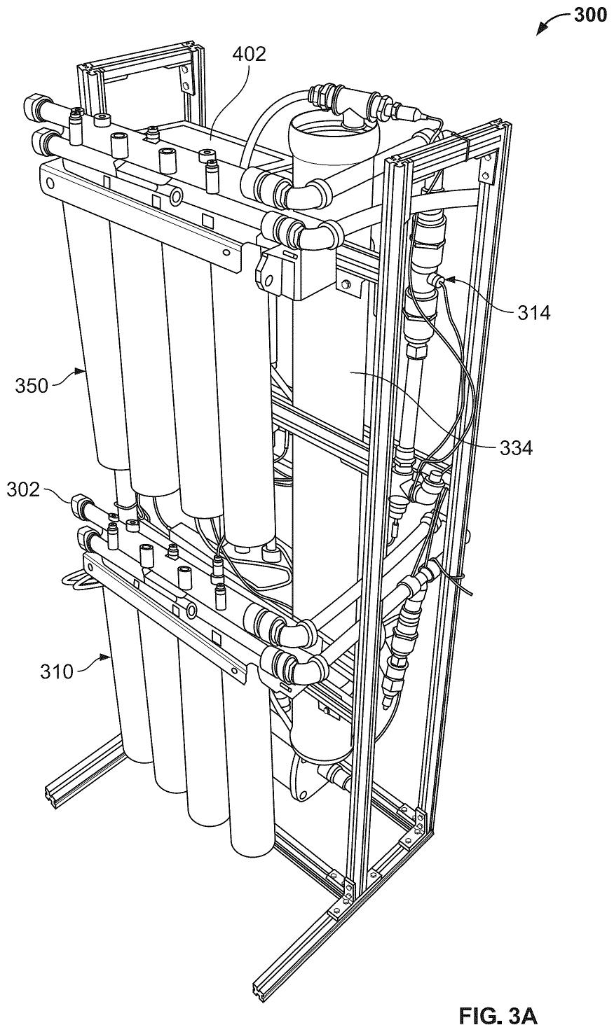

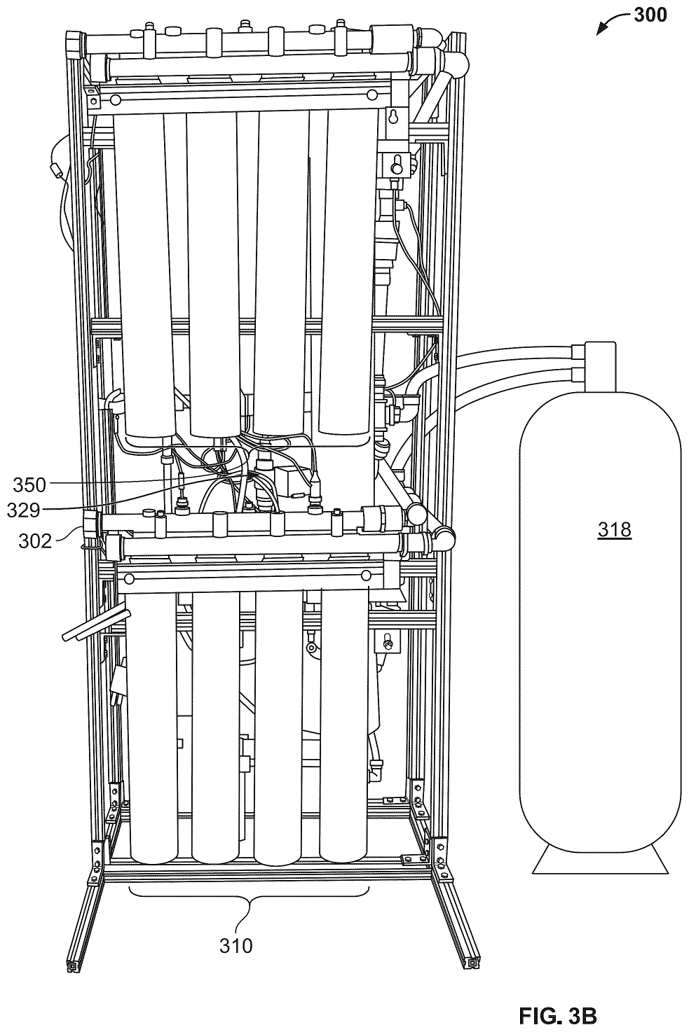

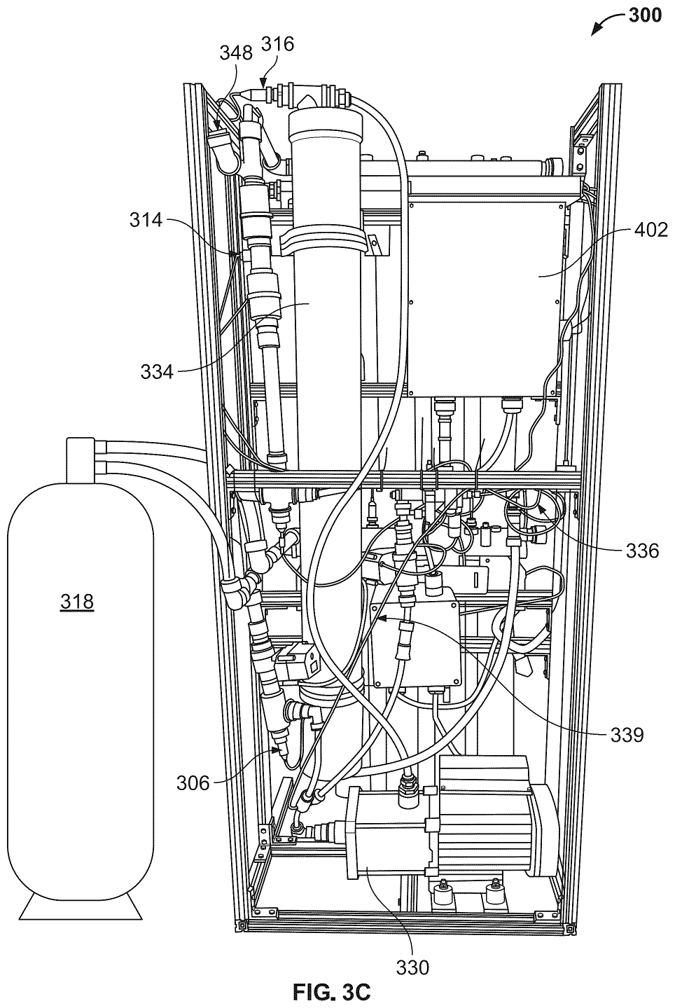

FIGS. 3A, 3B, and 3C illustrate an embodiment of a water treatment system 300. The water treatment system 300 may have the same types of system components as the water treatment system 100 of FIG. 1 and the water treatment system 200 of FIG. 2 (wherein similar components have like reference numbers), but the water treatment system 300 may have fewer system components and/or system components in a different configuration than the water treatment system 100 of FIG. 1 and the water treatment system 200 of FIG. 2. Similar to the water treatment system 200 of FIG. 2, water treatment system 300 may include a permeate flush line. The water treatment system 300 may also include various configurations of prefiltration and post-filtration systems as described in more detail herein below.

The water treatment system 300 may include an inlet 302 through which inlet water (e.g., hard water) enters the water treatment system 300. The inlet water may pass through a prefiltration unit 310, where the inlet water may be filtered and sediment or other contaminants removed. The prefiltered water may flow into a tank 318 where the prefiltered water is stored for future processing by a membrane element 334 of the water treatment system 300. The prefiltered water may also flow into and through the tank 318 to an outlet 348 (see FIG. 3C) of the water treatment system 300 for immediate use. Alternatively, or additionally, the prefiltered water may flow toward the membrane element 334. Optionally, as the prefiltered water flows toward the membrane element 334 the prefiltered water may pass a feeder 328. If provided, in some instances, the feeder 328 may be positioned elsewhere in the system 300 (e.g., downstream of the pump 330 or downstream of the membrane element 334). The feeder 328 may add a chemical additive to the prefiltered water. A pump 330 located on a feed side of the membrane element 334 may be activated to direct the prefiltered water toward the membrane element 334. The membrane element 334 may further filter the prefiltered water to remove hardness minerals and other impurities.

Water with hardness minerals and other impurities that do not pass through the membrane element 334 may be discharged from the membrane element 334 via a retentate line 336 (see FIG. 3C).

The membrane filtered water may flow from the membrane element 334 to the tank 318 for storage or may flow toward the outlet 348 of the water treatment system 300 to a point of use. Before the membrane filtered water flows out of the outlet 348, the membrane filtered water may pass through a post-filtration unit 350, where the membrane filtered water is further purified before exiting the water treatment system 300 via the outlet 348. The membrane filtered water may be stored in the tank 318. The membrane filtered water may also flow from the tank 318 toward an inlet side of the pump 330. The membrane filtered water may then be directed toward the membrane element 334 via the pump 330 and may be used to clean the membrane element 334.

The water treatment system 300 may have one or more sensors (e.g., 306a-306d, 314a-314c, 316a-316f, 322) that may be disposed at various points in the water treatment system 300 to measure or monitor a characteristic of the water (e.g., pressure, flow rate, conductivity, total dissolved solids, etc.) and provide data to a controller 402. Furthermore, one or more valves or flow restrictor tubes (e.g., 308a, 308b, 329a, 329b, 339, 342a, 342b) may be included at various points of the water treatment system 300 to control the flow of water into, through and out of the water treatment system 300.

Now turning to FIG. 4A, the inlet 302 of the water treatment system 300 may be in fluid communication with an inlet line 304. The inlet water may be from an inlet water source (not shown). The inlet water source may be, for example, a municipal water source, a well, or other influent water source. The inlet water may be imparted with a hardness value of about 1 grain per gallon (17.1 milligrams per liter) to about or above 10 grains per gallon (over 180 milligrams per liter).

The water treatment system 300 may include a first valve 308a. The first valve 308a may be in fluid communication with the inlet line 304. In some embodiments, the first valve 308a may be a gate valve. In some embodiments, the first valve 308a may be a bypass valve, a solenoid valve, a butterfly valve, a ball valve, a globe valve, a pressure relief valve, or a check valve.

The first valve 308a may control or regulate the amount of inlet water entering the water treatment system 300. The first valve 308a may open, either partially or fully, to enable the flow or increase the amount of inlet water entering the water treatment system 300 through the inlet 302. The first valve 308a may close, either partially or fully, to stop or decrease the flow or amount of inlet water entering the water treatment system 300. In addition, in some embodiments, the water treatment system 300 may be provided with a manual bypass valve (not illustrated) that is configured to decrease, substantially stop, or completely stop the flow of inlet water into the water treatment system 300. The amount of inlet water entering the water treatment system 300 may increase or decrease the water pressure in the water treatment system 300.

The water treatment system 300 may include the prefiltration unit 310. The prefiltration unit 310 may be provided in the form of one or more prefilter elements having one or more filter media. The prefiltration unit 310 may include a first prefilter element 310a and a second prefilter element 310b. The first prefilter element 310a may be in fluid communication with the inlet line 304 and the second prefilter element 310b. The second prefilter element 310b may be in fluid communication with the first prefilter element 310a and a prefiltered water line 312. Alternatively, the second prefilter element 310b may be in fluid communication with the inlet line 304 and the first prefilter element 310a, and the first prefilter element 310a may be in fluid communication with the second prefilter element 310b and the prefiltered water line 312.

Inlet water may enter the prefiltration unit 310 via the inlet line 304 and exit the prefiltration unit 310 via the prefiltered water line 312. When inlet water passes through the prefiltration unit 310, the prefiltration unit 310, via the first prefilter element 310a and the second prefilter element 310b, may remove sediment, particulates, certain chemicals and other contaminants from the inlet water, producing a prefiltered water that may flow out of the prefiltration unit 310 via the prefiltered water line 312.

In some embodiments, the first prefilter element 310a may include a sediment filter. The sediment filter may remove sediments, such as sand, silt, and dirt, and other particulates such as rust from the inlet water. In some embodiments, the sediment filter may include a filter media including pores with a pore size of no more than 5 microns, or no more than about 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some embodiments, the sediment filter may include a depth media, woven fabric, or nonwoven fabric.

In some embodiments, the second prefilter element 310b may include an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like. In some embodiments, a non-carbon-based media, such as clay or an ion exchange media, may be used in place of the activated carbon media.

By removing sediment, chlorine, chloramine, and other contaminants, the prefiltration unit 310 may provide prefiltered water that may have substantially no odor and have an improved taste compared to the inlet water. In addition, by removing sediment, chlorine, chloramine, and other contaminants the prefiltration unit 310 may protect the downstream membrane element 334 from sediment fouling or oxidation.

In some embodiments, the prefiltration unit 310 may be defined by a series of prefilter elements (e.g., two or more sediment filters) or may be comprised of a combination of prefilter elements (e.g., one or more sediment filters and one or more activated carbon filters). One ordinary skill in the art would understand that the one or more prefilter elements that comprise the prefiltration unit 310 may be retained within a single prefiltration element or may be separate and distinct prefilter elements (as shown in FIGS. 3A, 3B, and 4A) that are in fluid communication with one another. In some embodiments, the prefiltration unit 310 may be a PENTAIR® EVERPURE® filter. In other embodiments, the prefiltration unit 310 may be a PENTAIR® PENTEK® BIG BLUE® filter.

The water treatment system 300 may include one or more pressure sensors 306. In some embodiments, the one or more pressure sensors 306 may be defined by a gauge pressure transmitter, a differential pressure transmitter, an absolute pressure transmitter, a multivariate pressure transmitter, or a submersible pressure transmitter.

Preferably, a first pressure sensor 306a may be in fluid communication with the inlet line 304. The first pressure sensor 306a may measure, monitor, or sense the pressure of the inlet water in the inlet line 304. Alternatively, the first pressure sensor 306a may be in fluid communication with inlet water within the first prefilter element 310a. The first pressure sensor 306a may measure, monitor, or sense the pressure of the inlet water within the first prefilter element 310a. In some embodiments, the first pressure sensor 306a may be coupled to the prefiltration unit 310. In some embodiments, the first pressure sensor 306a may be coupled to the first prefilter element 310a (as shown in FIG. 4A) or the second prefilter element 310b.

The water treatment system 300 may include one or more TDS sensors 316. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about +10% Full Scale (25° C.). In some embodiments, the one or more TDS sensors 316 may be a TDS sensor having a TDS measurement range of at least about 0 to about 3000 ppm or greater than about 3000 ppm. One of ordinary skill in the art would understand that each of the one or more TDS sensors 316 may be the same type of TDS sensor or may each be a different type of TDS sensor.

A first TDS sensor 316a may be in fluid communication with the prefiltered water line 312. The first TDS sensor 316a may measure, monitor, or sense the conductivity of the prefiltered water to determine the concentration or amount of dissolved solids in the prefiltered water. Alternatively, the first TDS sensor 316a may be in fluid communication with water within the second prefilter element 310b. Preferably, the first TDS sensor may be coupled to the inlet line 304. The first TDS sensor may measure, monitor, or sense the conductivity of the inlet water or the water within the second prefilter element 310b to determine the concentration or amount of dissolved solids in the inlet water or the water within the second prefilter element 310b. In some embodiments, the first TDS sensor 316a may be coupled to the prefiltration unit 310. In some embodiments, the first TDS sensor 316a may be coupled to the second prefilter element 310b (as shown in FIG. 4A) or the first prefilter element 310a.

The water treatment system 300 may include a temperature sensor 322 that may be in fluid communication with the prefiltered water line 312. The temperature sensor 322 is designed to measure, monitor, or sense the temperature of the prefiltered water. In some embodiments, the temperature sensor 322 may be thermistor, a thermocouple, a semiconducting material, and any other mechanical or electronic sensor that may respond to a change in temperature. In some embodiments, additional temperature sensors may be included in the water treatment system 300. In some embodiments, an additional temperature sensor may be optionally placed on or within the inlet line 304.

The water treatment system 300 may include the tank 318, which may be used to store water. The tank 318 may be defined by a housing having a bottom portion 318a, a center portion 318b, and a top portion 318c. In some instances, each of the portions 318a, 318b, 318c may be separated by a physical barrier (e.g., if the tank 318 is provided as a bladder tank), although in preferred embodiments no physical barrier is positioned between the portions 318a, 318b, 318c. In some embodiments, the tank 318 may be a flow through tank, which may allow for the seamless delivery of water to a point of use (POU). In some embodiments, the tank 318 may be a pressurized tank. In some embodiments, the tank 318 may be a fiberglass reinforced plastic (FRP) tank. In some embodiments, the tank 318 may range in size from about 24 gallons (91 liters) to about 200 gallons (757 liters). In some embodiments, multiple tanks 318 of any size may be connected in series. In further embodiments, existing water vessels within the residential or commercial property (e.g., a water heater) may be used for additional storage capacity.

The tank 318 may include a riser tube 320 that extends upwardly vertically from the bottom portion 318a of the tank 318 to the top portion 318c of the tank 318, or vice versa. The riser tube 320 may be in fluid communication with the prefiltered water line 312. In some embodiments, the riser tube 320 may be provided as PVC tubing.

The tank 318 may further include a flow distributor 324, which may be attached or coupled to the riser tube 320. The flow distributor 324 may prevent or reduce the mixing of higher TDS water that may be stored in the bottom portion 318a of the tank 318 with lower TDS water that may be stored in the top portion 318c of the tank 318. In some embodiments, the flow distributor 324 may be a dome flow distributor. In some embodiments, multiple flow distributors 324 may be used.

Additionally, or alternatively, the tank 318 may include baffles and external plumbing (e.g., flow distributors) to reduce the mixing of higher TDS water that may be stored in the bottom portion 318a of the tank 318 with lower TDS water that may be stored in the top portion 318c of the tank 318.

In some embodiments, the high TDS water is added to the bottom portion 318a of the tank 318 and the low TDS water is added to the top portion 318c of the tank 318. Advantageously, adding the high TDS water and the low TDS water to the tank 318 in this manner helps maintain the separation between the high TDS water and the low TDS water in the tank 318, which in turn helps ensure that low TDS water is provided to a point of use during operation of the tank 318.

The water treatment system 300 may include an additive line 326. The additive line 326 may be physically connected to or otherwise in fluid communication with the prefiltered water line 312.

The water treatment system 300 may include a second valve 329a. The second valve 329a may be in fluid communication with the additive line 326. In some embodiments, the second valve 329a may be an actuated ball valve. In some embodiments, the second valve 329a may be a gate valve, a butterfly valve, a globe valve, a pressure relief valve, or a check valve.

The second valve 329a may be used to control or regulate the amount of prefiltered water flowing through the additive line 326. The second valve 329a may open, either partially or fully, to enable the flow or increase the amount of prefiltered water flowing through the additive line 326 toward the pump 330. The second valve 329a may close, either partially or fully, to stop or decrease the flow or amount of prefiltered water (with or without additive) flowing through the additive line 326 toward the pump 330.

Referring again to FIG. 4A, in some instances, a temperature control element 381 may be coupled via one or more pipes 382 to the membrane feed line 332, although the temperature control element 381 may also be provided in-line with the membrane feed line 332 or directly coupled to or provided with the membrane element 334. The temperature control element 381 may be designed to increase or decrease the temperature of a solution (e.g., the prefiltered water, the permeate water, a prefiltered water dosed with a chemical cleaning agent, a permeate water dosed with a chemical cleaning agent, etc.) entering the membrane feed line 332. In some instances, the temperature control element 381 may increase or decrease a temperature of the interior of the membrane element 334.

In various cases, the temperature control element 381 may be provided in the form of an electric heater, a heat exchanger, or any other similar apparatus designed to increase the temperature of a water stream. In various instances, the temperature control element 381 may be provided in the form of an electric chiller, a heat exchanger, or any other similar apparatus designed to decrease the temperature of a water stream. It is to be understood that the temperature control element 381 may be provided in any of the water treatment systems described herein.

Additionally, a cleaning agent or chemical additive may be introduced directly to the membrane element 334 during a cleaning process (e.g., during a membrane flush process). For example, the chemical additive may be directed from a dosing mechanism 384 through a dosing conduit 386 such that the chemical additive may be provided to the membrane element 334. As shown in FIG. 4A, the dosing mechanism 384 and the dosing conduit 386 may be directly coupled to the membrane element 334, although the dosing mechanism 384 and the dosing conduit 386 may be coupled to other components of the water treatment system 300 (e.g., the membrane feed line 332). In cases in which the dosing conduit 386 is directly coupled to the membrane element 334, the dosing conduit 386 may couple to a port of the membrane element 334 that is in fluid communication with the interior of the membrane element 334.

In some cases, the dosing mechanism 384 may include a reservoir designed to retain a predetermined amount of the chemical additive. In some instances, the dosing mechanism 384 may be in fluid communication with a source of the chemical additive. It is to be understood that the dosing mechanism 384 may be provided in any of the water treatment systems described herein.

The prefiltered water may have a fluid flow path through the water treatment system 300. In some embodiments, depending on the flow conditions when the water treatment system 300 is in use, the prefiltered water may flow in different directions as described in more detail below (scc, e.g., FIG. 7). For example, during some flow conditions, the prefiltered water may flow from the prefiltration unit 310 through the prefiltered water line 312, down the riser tube 320, and into the bottom portion 318a of the tank 318. The prefiltered water may be stored in the tank 318. During other flow conditions, the prefiltered water may also flow from the prefiltration unit 310 via the prefiltered water line 312 toward the membrane element 334 via the additive line 326. During further flow conditions, the prefiltered water may flow from the bottom portion 318a of the tank 318, up the riser tube 320, through the prefiltered water line 312 toward the membrane element 334 via the additive line 326.

The water treatment system 300 may include the feeder 328 that is in fluid communication with the additive line 326. The feeder 328 may introduce or add a chemical additive to the prefiltered water. In some embodiments, the chemical additive may be an anti-scaling agent to reduce corrosion or scale on a feed side of a membrane element. In some embodiments, the chemical additive may be a polyphosphate compound.

When the prefiltered water flows through or passes the feeder 328, the chemical additive may be added or introduced to the prefiltered water. The chemical additive may dissolve or otherwise degrade in the prefiltered water. In some embodiments, as further detailed herein, the feeder 328 may impart the water flowing through the feeder 328 with a chemical additive concentration of at least about 0.01 ppm to at least about 10 ppm or 0.01 ppm to 10 ppm. In other embodiments, the feeder 328 may impart the water flowing through the feeder 328 with a chemical additive concentration of less than 0.01 ppm or greater than 10 ppm of the chemical additive.

In some embodiments, the water treatment system 300 may include an optional second prefiltration unit 331 (as shown in FIG. 4A). The second prefiltration unit 331 may be in fluid communication with the additive line 326.

The second prefiltration unit 331 may be provided in the form of one or more prefilter elements having one or more filter media. Inlet water may enter the prefiltration unit 310 via the inlet line 304 and exit the prefiltration unit 310 via the prefiltered water line 312. When inlet water passes through the prefiltration unit 310, via the first prefilter element 310a and the second prefilter element 310b, may remove sediment, particulates, certain chemicals and other contaminants from the inlet water, producing a prefiltered water that may flow out of the prefiltration unit 310 via the prefiltered water line 312.

In some embodiments, the one or more prefilter elements of the second prefiltration unit 331 may include a sediment filter. The sediment filter may remove remaining sediment, such as sand, silt, and dirt, and other particulates from the prefiltered water (with or without additive) that were not removed by the prefiltration unit 310. In some embodiments, the sediment filter may include a filter media including pores with a pore size of no more than 1 micron or no more than about 1 micron. For example, the sediment filter may include a filter media including pores with a pore size of no more than 1 micron, no more than 0.5 microns, or no more than 0.1 microns. As an additional example, the sediment filter may include a filter media including pores with a pore size of no more than about 1 micron, no more than about 0.5 microns, or no more than about 0.1 microns. In some embodiments, the sediment filter may include a depth media, woven fabric, or nonwoven fabric.

The water treatment system 300 may include a second pressure sensor 306b that may be in fluid communication with the additive line 326. The second pressure sensor 306b may measure, monitor, or sense the pressure of the prefiltered water with additive in the additive line 326. Specifically, if the feeder 328 is provided, the second pressure sensor 306b may determine the pressure after the chemical additive is provided and the water has passed through an optional sediment filter. Alternatively, if a chemical additive is not added by the feeder 328, the second pressure sensor 306b may measure, monitor, or sense the pressure of the prefiltered water in the additive line 326. In some embodiments, the second pressure sensor 306b may be coupled to the second prefiltration unit 331 (as shown in FIG. 4A). In some embodiments, the measurement from the second pressure sensor 306b may be used as an input by the control system 400 in determining whether the pump 330 should be activated or whether the there is sufficient pressure within the water treatment system 300 such that the water treatment system 300 can operate without the pump 330 being activated.

The water treatment system 300 may include the pump 330. The inlet side (not shown) of the pump 330 may be in fluid communication with the additive line 326, and an outlet side (not shown) of the pump 330 may be in fluid communication with a membrane feed line 332. In some embodiments, the pump 330 may be a single-phase booster pump. For example, the pump 330 may be a PENTAIR® STA-RITE™ single phase 115 volt, ¾ horsepower pump. In some embodiments, the pump 330 may be a multi-phase booster pump. In some embodiments, the pump 330 may boost differential pressure in the membrane feed line 332 to 120-250 pounds per square inch (827-1725 kilopascals) at a flow rate of 1.0-7.0 gallons per minute (11-26 liters per minute) or at a preferable flow rate of 2.0-5.0 gallons per minute (7.5-19 liters per minute).

The membrane feed line 332 may be in fluid communication with a third pressure sensor 306c. The third pressure sensor 306c may measure, monitor, or sense the pressure of the prefiltered water (with or without additive) in the membrane feed line 332.

The water treatment system 300 may include the membrane element 334. In some embodiments, the membrane element 334 may be a reverse osmosis (RO) membrane. In some embodiments, the RO membrane may be spiral wound and may include feed spacers imparted with a certain thickness and/or structure. In some embodiments, the RO membrane may be a spiral would RO membrane (e.g., a spiral would 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membrane may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membrane may be a spiral wound RO membrane (e.g., a spiral wound 4040 RO membrane) with feed spacers imparted with a thickness of at least 8 mil to no more than 40 mil. For example, the feed spacers may be imparted with a thickness of no more than 8 mil, or no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membrane may be a spiral wound RO membrane (e.g., a spiral wound 4040 RO membrane) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membrane may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membrane may be a spiral wound RO membrane (e.g., a spiral wound 4040 RO membrane) with feed spacers imparted with a thickness of at least 0.2 millimeters to no more than 1.1 millimeters. For example, the RO membrane may have feed spacers imparted with a thickness of no more than 0.2 millimeters, or no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the membrane element 334 may be a nanofiltration (NF) membrane, an ultrafiltration (UF) membrane, a microfiltration (MF) membrane, or a particulate membrane. In some embodiments, the membrane element 334 may be a hollow fiber NF membrane. In other embodiments, the membrane element 334 may be an electrodialysis membrane system.

In some embodiments, the membrane element 334 may comprise a combination of one or more of a RO membrane, a NF membrane, a UF membrane, a MF membrane, a particulate membrane, and/or an electrodialysis membrane, which may be disposed in parallel or in series. For example, in some embodiments, the combination of membranes may include at least one RO membrane and at least one NF membrane. The at least one RO membrane may be disposed in parallel with the at least one NF membrane, or the RO membrane may be disposed before or after the at least one NF membrane in series. In other embodiments, the combination of membrane elements may include at least one UF membrane and at least one MF membrane. The at least one UF membrane may be disposed in parallel with the at least one MF membrane, or the at least one UF membrane may be disposed before or after the at least one MF membrane in series. The one or more membranes in the combination of membranes may be contained within a single housing, in separate housings, or a combination thereof.

In further embodiments, the membrane element 334 may include two or more RO membranes, NF membranes, a UF membrane, a MF membrane, a particulate membrane, and/or electrodialysis membranes, which may be disposed in parallel or in series. In some embodiments, the membrane element 334 may be a series of membranes of the same type (e.g., two or more RO membranes) but of a different size. For example, the membrane element 334 may include a first membrane imparted with a first diameter and a second membrane imparted with a second diameter that is different than the first diameter (e.g., the second diameter may be less than the first diameter). In some embodiments, the first membrane may be a spiral wound 4040 RO membrane and the second membrane may be a spiral wound 2540 RO membrane. The two or more membranes may be contained within a single housing, in separate housings (e.g., as shown in FIG. 4D), or a combination thereof.

Varying the membrane type and/or size can be used to optimize the level of permeate production, allowing for enhanced water recovery, while at the same time balancing factors such as a particular permeate water chemistry and membrane health. For example, in some embodiments, including at least one NF membrane as a first or second membrane in a series may allow for higher total permeate output as compared to utilizing two RO membranes. In other embodiments, including two or more RO membranes in series, for example, may help maintain a higher velocity on the feed side of the individual membranes, which in turn may reduce ion concentration at the membrane surface of each membrane. In addition, including two or more RO membranes in series may enable the operation of the individual RO membranes at different membrane recoveries, which may help optimize permeate production as dissolved mineral content increases.

In further embodiments, using a smaller membrane as a second membrane in a series of membranes, where the first membrane has a larger diameter than the diameter of the second membrane, may allow the water entering the second membrane to have a higher velocity, which may boost overall water recovery. For instance, in some embodiments, if the water treatment system 300 is operating at an approximately 80% recovery, and a spiral wound 4040 RO membrane is used as the first membrane in a series of membranes and a spiral wound 2540 RO membrane is used as a second membrane in the series of membranes, the total water recovery of the water treatment system 300 may be increased to at least about a 94% recovery.

The membrane element 334 may be in fluid communication with the membrane feed line 332 on a feed side (not shown) of the membrane element 334. The membrane element 334 also may be in fluid communication with the retentate line 336 on the feed side of the membrane element 334. The membrane element 334 may be in fluid communication with a membrane permeate line 338 on a permeate side (not shown) of the membrane element 334.

In some embodiments, as the prefiltered water (with or without additive) enters the feed side of the membrane element 334, the membrane element 334 may allow a solvent (e.g., water) in the prefiltered water to pass through a surface of a membrane (not shown) retained within the membrane element 334. The solvent that passes through the surface of the membrane may exit from the permeate side of the membrane element 334 as membrane permeate via the membrane permeate line 338. Solutes (e.g., dissolved minerals and ions and various organic compounds) in the prefiltered water may not pass through the membrane and may be retained at the surface of the membrane. The solutes may be discharged from the feed side of the membrane element 334 as retentate via the retentate line 336.

In some embodiments, when the pump 330 is activated, the pump 330 may increase the rate at which water flows into the membrane feed line 332 toward the membrane element 334. Increasing the flow rate of water into the membrane feed line 332 may increase pressure in the membrane feed line 332. The increased pressure may in turn aid in pushing solvent in the membrane feed line 332 through the pores formed within the surface of the membrane retained within the membrane element 334.

The water treatment system 300 may include a flow restrictor tube 339 that may be in fluid communication with the retentate line 336. The flow restrictor tube 339 may be used to control or regulate the amount of retentate leaving the water treatment system 300 via the retentate line 336 into a drain 341. In some embodiments, the flow restrictor tube 339 may be a capillary tube imparted with an inner diameter of at least about 1/16 inches (at least about 1.6 mm) to no more than about ⅛ inches (no more than about 3.2 mm). In some embodiments, the flow restrictor tube 339 may be imparted with a length of at least about 1 inch (at least about 2.5 centimeters) to at least about 4 feet (at least about 122 cm). For example, the flow restrictor tube 339 may be imparted with a length of no less than 1 foot (30.5 centimeters) and no more than 3 feet (91.4 centimeters). In some embodiments, the flow restrictor tube 339 may be provided in the form of material that has a low energy surface to prevent the formation of scale on the surface of the flow restrictor tube 339, given that retentate may be beyond the saturation limit of the water. For example, the flow restrictor tube 339 may be made from polyethylene tubing. In further embodiments, a valve may be used instead of or in combination with the flow restrictor tube 339. The amount of retentate exiting the water treatment system 300 into the drain 341 may increase or decrease the water pressure in the water treatment system 300.

The water treatment system 300 may include a second TDS sensor 316b that may be in fluid communication with the retentate line 336. The second TDS sensor 316b may measure, monitor, or sense the conductivity of the retentate to determine an amount or concentration of dissolved solids in the retentate.

The water treatment system 300 may include one or more flowmeters 314. In some embodiments, the one or more flowmeters 314 may be provided as a mechanical flowmeter or an ultrasonic flowmeter. In some embodiments, the one or more flowmeters may include a ⅜ inch (0.95 centimeters) F-nut inflow connector, a ⅜ inch (0.95 centimeters) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 314 may be a 0.26-16 GPM turbine flowmeter, a 0.26-7.9 GPM turbine flowmeter, or a 0.26-0.65 turbine flowmeter. One of ordinary skill in the art would understand that each of the one or more flowmeters 314a-314c may be the same type of flowmeter or may each be a different type of flowmeter.

The water treatment system 300 may include a first flowmeter 314a. The first flowmeter 314a may be positioned within or otherwise in fluid communication with the retentate line 336 and the drain 341. The third flowmeter may measure, monitor, or sense the flow rate of the retentate in the retentate line 336.

The membrane permeate line 338 may be connected to or otherwise in fluid communication with a tank line 344. The tank line 344 may be in fluid communication with the top portion 318c of the tank 318. The tank line 344 also may be connected to or otherwise in fluid communication with an outlet feed line 346. The outlet feed line 346 may be in fluid communication with the outlet 348 of the water treatment system 300.

In some embodiments, depending on flow conditions when the water treatment system 300 is in use, the membrane permeate may flow directly from the permeate side of the membrane element 334 through the membrane permeate line 338 and the tank line 344 into the top portion 318c of the tank 318. The membrane permeate may be stored in the tank 318. The membrane permeate may also flow from the permeate side of the membrane element 334 through the membrane permeate line 338 to the tank line 344, into the outlet feed line 346 (thereby bypassing the tank 318), and out of the outlet 348. By enabling the flow of membrane permeate from the membrane element 334 directly to the outlet 348, membrane permeate may be provided to a point of use in real time.

Due to the amount of dissolved ions in high TDS water, high TDS water tends to have a higher density than low TDS water. Thus, by sending higher TDS water (e.g., the prefiltered water) to the bottom portion 318a of the tank 318 and lower TDS water (e.g., the membrane permeate) to the top portion 318c of the tank 318, the chances of water with different TDS amounts or concentrations mixing inside the tank 318 may be minimized. Thus, when water is later drawn from the top portion 318c of the tank 318, low TDS water may be provided to a point of use. Sending higher TDS water to the bottom of the tank 318 and lower TDS water to the top of the tank 318 may also create a sharp TDS profile along the vertical height of the tank 318, where the amount or concentration of TDS at the bottom portion 318a of the tank 318 is the highest (e.g., a TDS concentration of more than or about 3.5 grains per gallon (60 milligrams per liter)), and the amount or concentration of TDS at the top portion 318c of the tank 318 is the lowest (e.g., a TDS concentration of less than or about 3.5 grains per gallon (60 milligrams per liter)). Creating and maintaining this sharp TDS profile is aided by the density difference between the high TDS water and the low TDS water.

The water treatment system 300 may include a third valve 342a that may be in fluid communication with the membrane permeate line 338. In some embodiments, the third valve 342a may be a check valve. In some embodiments, the third valve may be a butterfly valve, a ball valve, a globe valve, a pressure relief valve, or a gate valve.

The third valve 342a may be used to control or regulate the amount of membrane permeate entering or flowing through the membrane permeate line 338 into the tank line 344 and into the top portion 318c of the tank 318 or out of the outlet 348 via the outlet feed line 346. The third valve 342a may open, either partially or fully, to enable or increase the flow or the amount of membrane permeate flowing through the membrane permeate line 338 to the tank line 344, and into the top portion 318c of the tank 318 or into the outlet feed line 346 and out of the outlet 348. The third valve 342a may close, either partially or fully, to stop or decrease the amount of membrane permeate flowing through the membrane permeate line 338 and the tank line 344, into the top portion 318c of the tank 318 or into the outlet feed line 346 and out of the outlet 348. The amount of membrane permeate entering or flowing through the membrane permeate line 338 and into the tank 318 or out of the outlet 348 may increase or decrease the water pressure in the water treatment system 300. In some instances, the third valve 342a may be a check valve that is used to prevent backflow through the tank line 344, which in turn helps protect the membrane element 334.

A second flowmeter 314b may be positioned within or otherwise in fluid communication with the tank line 344. The second flowmeter 314b may measure, monitor, or sense the flow rate of the prefiltered water through the tank line 344.

In some embodiments, the tank 318 may include a third TDS sensor 316c disposed in the top portion 318c, a fourth TDS sensor 316d disposed in the center portion 318b of the tank 318, and/or a fifth TDS sensor 316e disposed in the bottom portion 318a of the tank 318. The third TDS sensor 316c may measure, monitor, or sense the conductivity of the water in the top portion 318c of the tank 318 to determine an amount or concentration of dissolved solids in the water located in the top portion 318c of the tank 318. The fourth TDS sensor 316d may measure, monitor, or sense the conductivity of the water in the center portion 318b in the tank 318 to determine an amount or concentration of dissolved solids in the water located in the center portion 318b of the tank 318. The fifth TDS sensor 316e may measure, monitor, or sense the conductivity of the water in the bottom portion 318a of the tank 318 to determine an amount or concentration of dissolved solids in the water located in the bottom portion 318a of the tank 318. The third, fourth, and fifth TDS sensors (316c, 316d, and 316e, respectively) may create a profile of the TDS levels or concentrations of the water in the tank 318.

In some embodiments, the tank 318 may include zero, one, two, or more TDS sensors disposed in each of the top, center, or bottom portions of the tank 318. For example, in some embodiments, a TDS sensor may only be disposed in the center portion 318b of the tank, not the top portion 318c or the bottom portion 318a. In other embodiments, a TDS sensor may be disposed in each of the top portion 318c and the bottom portion 318a of the tank 318, but not the center portion 318b. In further embodiments, zero TDS sensors may be disposed in the tank 318.

The water (i.e., membrane permeate (lower TDS) or the prefiltered water (higher TDS)) that may be stored in the tank 318 may flow through the tank line 344 and the outlet feed line 346 out of the outlet 348. The outlet 348 may be in fluid communication with various appliances, fixtures, and plumbing of the residential or commercial property. In some embodiments, the outlet 348 may be in fluid communication with a water heater, faucets, fixtures, or toilets via one or more pipes or tubes.

The water treatment system 300 may include a third flowmeter 314c may be positioned within or otherwise in communication with the outlet feed line 346. The third flowmeter 314c may measure, monitor, or sense the flow rate of the water in the outlet feed line 346.

The water treatment system 300 may include a fourth pressure sensor 306d in communication with the outlet feed line 346. The fourth pressure sensor 306d may measure, monitor, or sense the pressure of the water in the outlet feed line 346.

The water treatment system 300 may include a sixth TDS sensor 316f in communication with the outlet feed line 346. The sixth TDS sensor 316f may measure, monitor, or sense the conductivity of the water in the outlet feed line 346 to determine an amount or concentration of the dissolved solids in the water in the outlet feed line 346.

The water treatment system 300 may include a fourth valve 308b that may be in fluid communication with the outlet feed line 346. In some embodiments, the fourth valve 308b may be a gate valve. In some embodiments, the fourth valve 308b may be a bypass valve, a solenoid valve, a butterfly valve, a ball valve, a globe valve, a pressure relief valve, or a check valve.

The fourth valve 308b may be used to control or regulate the amount of water (e.g., membrane permeate or prefiltered water) flowing from the tank 318, through the tank line 344, into the outlet feed line 346, and out of the outlet 348 or from the membrane element 334, through the tank line 344, into the outlet feed line 346, and out of the outlet 348. The fourth valve 308b may open, either partially or fully, to enable or increase the flow or the amount of water from the tank 318 or the membrane element 334, through the tank line 344, into the outlet feed line 346, and out of the outlet 348. The fourth valve 308b may close, either partially or fully, to stop or decrease the amount of water flowing from the tank 318 or the membrane element 334, through the tank line 344, into the outlet feed line 346 and out of the outlet 348. The amount of water flowing through the outlet feed line 346 and out of the outlet 348 may increase or decrease the water pressure in the water treatment system 300.

Preferably, the first valve 308a and the fourth valve 308b are provided as on/off valves that can substantially or completely stop the flow of water through the system 300. In such embodiments, the first valve 308a and the fourth valve 308b may be provided as ball valves, solenoid valves, or other similarly functioning valves.

The water treatment system 300 may include a permeate flush line 352. The permeate flush line 352 may be physically connected to or otherwise in fluid communication with the tank line 344 and the additive line 326. In some embodiments, the permeate flush line 352 may be physically connected to or otherwise in fluid communication with the tank line 344 and the pump 330. In some embodiments, the permeate flush line 352 may be in fluid communication with the membrane permeate line 338. In some embodiments, the permeate flush line 352 can be connected or coupled to any conduit of the water treatment system 300 that is downstream of the second valve 329a (e.g., the membrane feed line 332).

The water treatment system 300 may include an optional fifth valve 342b that may be in fluid communication with the permeate flush line 352. In some embodiments, the fifth valve 342b may be a check valve. In some embodiments, the fifth valve 342b may be a butterfly valve, a ball valve, a globe valve, a pressure relief valve, or a gate valve. In certain embodiments, the fifth valve 342b may be designed to control, regulate, or adjust the amount of permeate provided to the membrane element 334 during the permeate flush process. In certain embodiments, the fifth valve 342b may be designed to control, regulate, or adjust the amount of permeate provided to the membrane element 334 during any of the physical cleaning processes and chemical cleaning processes described herein. In further such embodiments, the fifth valve 342b may operate in conjunction with one or more other valves and/or the pump 330 to provide permeate to the membrane element 334 during the permeate flush process.

The optional fifth valve 342b may be used to control, regulate, or adjust the amount of membrane permeate entering or flowing into and through the permeate flush line 352 from the tank line 344. The fifth valve 342b may open, either partially or fully, to enable or increase the flow or the amount of membrane permeate flowing from the top portion 318c of the tank 318, into the tank line 344, and through the permeate flush line 352. The fifth valve 342b may close, either partially or fully, to stop or decrease the amount of membrane permeate flowing from the top portion 318c of the tank 318, into the tank line 344, and through the permeate flush line 352. The amount of membrane permeate entering or flowing through the permeate flush line 352 may increase or decrease the water pressure in the water treatment system 300.

The water treatment system 300 may include a sixth valve 329b that may be in fluid communication with the permeate flush line 352. In some embodiments, the sixth valve 329b may be an actuated ball valve. In some embodiments, the sixth valve 329b may be a gate valve, a butterfly valve, a globe valve, a pressure relief valve, or a check valve.

The sixth valve 329b may be used to control or regulate the amount of membrane permeate flowing through the permeate flush line 352 and into the membrane feed line 332 and, eventually, to the retentate line 336 via the membrane element 334. The sixth valve 329b may open, either partially or fully, to enable or increase the flow or the amount of membrane permeate flowing from the permeate flush line 352 into the membrane feed line 332 and the retentate line 336 via the membrane element 334. The sixth valve 329b may close, either partially or fully, to stop or decrease the amount of membrane permeate flowing from the permeate flush line 352 into the membrane feed line 332 and the retentate line 336 via the membrane element 334. The amount of membrane permeate flowing through the permeate flush line 352 to the membrane feed line 332 and the retentate line 336 via the membrane element 334 may increase or decrease the water pressure in the water treatment system 300.

In some embodiments, depending on flow conditions, when the water treatment system 300 is in use, membrane permeate from the top portion 318c of the tank 318 may flow through the tank line 344 and the permeate flush line 352 into the membrane feed line 332 toward the membrane element 334. The membrane permeate may be recirculated through the membrane feed line 332 and into the feed side of the membrane element 334. The recirculation of the membrane permeate through the membrane feed line 332 may be aided by the pump 330 when activated or may be caused by pressure within the water treatment system 300 when the pump 330 is turned off. The membrane permeate may be used to clean the membrane element 334 by flushing solutes (e.g., ions) from the surface of the membrane element 334. The membrane permeate used to clean or flush the surface of the membrane element 334 may then be discharged through the retentate line 336.

In some embodiments, the second valve 329a may be closed and the optional fifth valve 342b and the sixth valve 329b may be opened. In this instance, the pump 330 could be activated such that membrane permeate from the membrane element 334 may flow directly from the membrane element 334 to the permeate flush line 352, through the membrane feed line 332 and into the membrane element 334 to clean or flush the surface of the membrane element 334.

The water treatment system 300 may include an optional mineralization unit 380 containing a mineralization material. The mineralization material may be provided as a calcium-containing compound or a magnesium-containing compound, although other ionic compounds could also be used to increase the mineral or TDS concentration of the water provided by the system 300 to a point of use. The mineralization material may be, for example, a calcium carbonate compound (CaCO₃), a magnesium carbonate compound (MgCO₃), a magnesium oxide compound (MgO), a calcium oxide compound (CaO), a sodium bicarbonate compound (NaHCO₃), dolomite (CaMg(CO₃)₂), other substances with similar chemical and physical properties, and combinations thereof. In some instances, the mineralization compound may be selected from the group consisting of a calcium carbonate compound (CaCO₃), a magnesium carbonate compound (MgCO₃), a magnesium oxide compound (MgO), a calcium oxide compound (CaO), a sodium bicarbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), and combinations thereof. In instances where the mineralization material includes a calcium carbonate compound, the calcium carbonate may be provided in the form of calcite. In some instances, a magnesium oxysulfate compound may be used as the mineralization material.

In some embodiments, the mineralization unit 380 may be a device containing a mineralization material that has an inlet and an outlet through which water passes. For example, the mineralization unit 380 may be provided as a cartridge that may be replaced when the mineralization material is depleted. In some embodiments, the mineralization unit 380 may include a bed or cartridge of mineralization material disposed on a line (e.g., outlet feed line 346) or other system component of the water treatment system 300, which water passes by but does not flow through.

The mineralization unit 380 may generally be disposed on or coupled to various system components or lines of the system 300 that are positioned downstream of the membrane element 334. In some embodiments, the mineralization unit may be disposed on or coupled to the outlet feed line 346 upstream of the outlet 348. The mineralization unit 380 may introduce a mineralization material to the membrane permeate before the membrane permeate exits the water treatment system 300 via the outlet 348. In some embodiments, the mineralization unit 380 may be disposed on the membrane permeate line 338 or the tank line 344. For example, the mineralization unit 380 may be disposed on the membrane permeate line 338 or the tank line 344 proximate the tank 318 so that the membrane permeate is introduced to the mineralization material before the membrane permeate flows into the top portion 318c of the tank 318. In other embodiments, the mineralization unit 380 may be disposed within a top portion 318c of the tank 318 so that the membrane permeate is introduced to the mineralization material as the membrane permeate flows into or out of the top portion 318c of the tank 318. In further embodiments, the mineralization unit 380 may be disposed within a top portion 318c of the tank 318 so that the membrane permeate contacts the mineralization material in the mineralization unit 380 while the membrane permeate is stored in the tank 318, including during periods when there is no flow of membrane permeate into or out of the tank 318. In other embodiments, the mineralization unit 380 may be provided as a solid block of mineralization material (e.g., as a block of calcite) that is disposed within the tank 318 or within one of the lines or another system component of the water treatment system 300.

The mineralization material introduced or otherwise provided by the mineralization unit 380 may change a quality or characteristic of the membrane permeate such as the pH level and/or the TDS level. The changing of a quality or characteristic of the membrane permeate may improve the aesthetics (e.g., taste) of the membrane permeate and/or reduce the possible corrosion of metal plumbing and appliances downstream from the water treatment system 300. One or more pH sensors may be disposed proximate to the mineralization unit to monitor the pH level of the membrane permeate before and/or after the membrane permeate passes by or through the mineralization unit 380. Additionally, or alternatively, one or more TDS sensors may be disposed proximate the mineralization unit 380 to monitor the TDS level of the membrane permeate before and/or after the membrane permeate passes by or through the mineralization unit 380.

The re-mineralized membrane permeate that exits or results from passing by or through the mineralization unit 380 may be imparted with a TDS concentration of at least about 20 ppm to at least about 1000 ppm, or at least about 50 ppm to at least about 500 ppm, or at least about 100 ppm to at least about 400 ppm. In some instances, the re-mineralized membrane permeate that exits or results from passing by or through the mineralization unit may be imparted with a TDS concentration less than about 20 ppm or greater than about 1000 ppm. In some instances, it is preferred to impart the re-mineralized water with a TDS concentration of at least about 50 ppm or at least 50 ppm.

In other embodiments, the re-mineralized membrane permeate that exits or results from passing by or through the mineralization unit 380 may be imparted with a TDS concentration of at least 20 ppm to at least 1000 ppm, or at least 50 ppm to at least 500 ppm, or at least 100 ppm to at least 400 ppm. In some instances, the re-mineralized membrane permeate that exits or results from passing by or through the mineralization unit 380 may be imparted with a TDS concentration less than 20 ppm or greater than 1000 ppm.

In some embodiments, the re-mineralized membrane permeate may be imparted with a TDS concentration of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more.

In other embodiments, the re-mineralized membrane permeate may be imparted with a TDS concentration of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In further embodiments, the re-mineralized membrane permeate that exits or results from passing by or through the mineralization unit 380 may be imparted with a pH value within drinkable limits (e.g., between about 7 to about 10, or between 7 to 10). In some embodiments, the re-mineralized membrane permeate that exits or results from passing by or through the mineralization unit 380 is imparted with a pH value of about 7, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In some embodiments, the re-mineralized membrane permeate that exits or results from passing by or through the mineralization unit 380 is imparted with a pH value of 7, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

The water treatment system 300 may include and be in communication with a control system 400. The control system 400 may include the controller 402 and a display 450. As shown in FIG. 5, the controller 402 may be electronically connected to and may be in electronic communication with the display 450. The controller 402 also may be electronically connected to and may be in electronic communication with one or more of the water treatment system components including the one or more sensors (306a-306d, 314a-314c, 316a-316f, and 322), the first, second, third, fourth, fifth, or sixth valves (308a, 329a, 342a, 308b, 342b, and 329b, respectively), the feeder 328, and/or the pump 330.

In some embodiments of the water treatment system 300, the prefiltration unit 310 of the water treatment system 300 may be provided in the form of a first prefilter element 310a, a second prefilter element 310b, a third prefilter element 310c, and a fourth prefilter element 310d (see, e.g., FIGS. 3A-3C, 4B, 4C, and 4D). The first prefilter element 310a may be in fluid communication with the inlet line 304 and the second prefilter element 310b. The second prefilter element 310b may be in fluid communication with the first prefilter element 310a and the third prefilter element 310c. The third prefilter element 310c may be in fluid communication with the second prefilter element 310b and the fourth prefilter element 310d. The fourth prefilter element 310d may be in fluid communication with the third prefilter element 310c and the prefiltered water line 312.

Inlet water may enter the prefiltration unit 310 via the inlet line 304 and exit the prefiltration unit 310 via the prefiltered water line 312. When inlet water passes through the prefiltration unit 310, the prefiltration unit 310, via the first prefilter element 310a, the second prefilter element 310b, the third prefilter element 310c, and the fourth prefilter element 310d, may remove sediment, particulates, certain chemicals and other contaminants from the inlet water, producing a prefiltered water that may flow out of the prefiltration unit 310 via the prefiltered water line 312.

In some embodiments, one or more of the first prefilter element 310a, the second prefilter element 310b, the third prefilter element 310c, and/or the fourth prefilter element 310d may be defined by a sediment filter. The sediment filter may remove sediments, such as sand, silt, and dirt, and other particulates such as rust from the inlet water. In some embodiments, the sediment filter may include a filter media including pores with a pore size of no more than 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some embodiments, the sediment filter may include a depth media, woven fabric, or nonwoven fabric.

In some embodiments, one or more of the first prefilter element 310a, the second prefilter element 310b, the third prefilter element 310c, and/or fourth prefilter element 310d may comprise an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like. In some embodiments, a non-carbon-based media, such as clay or an ion exchange media, may be used in place of the activated carbon media.

By removing sediment, chlorine, chloramine, and other contaminants, the prefiltration unit 310 may provide prefiltered water that may have substantially no odor and have an improved taste compared to the inlet water. In addition, by removing sediment, chlorine, chloramine, and other contaminants the prefiltration unit 310 may protect a membrane element from sediment fouling or oxidation.

In some embodiments, the prefiltration unit 310 may be comprised of a series of prefilter elements (e.g., two or more sediment filters) or may be comprised of a combination of prefilter elements (e.g., one or more sediment filters and one or more activated carbon filters). One ordinary skill in the art would understand that the one or more prefilter elements that comprise the prefiltration unit 310 may be retained within a single prefiltration element or may be separate and distinct prefilter elements (see, e.g., FIG. 4B) that are in fluid communication with one another. In some embodiments, the prefiltration unit 310 may be a PENTAIR® EVERPURE® filter. In other embodiments, the prefiltration unit 310 may be a PENTAIR® PENTEK® BIG BLUE® filter.

In some embodiments of the water treatment system 300, the first pressure sensor 306a may be in fluid communication with the inlet line 304. Alternatively, the first pressure sensor 306a may be in fluid communication with inlet water within the first prefilter element 310a. The first pressure sensor 306a may measure, monitor, or sense the pressure of the inlet water in the inlet water or within the first prefilter element 310a. In some embodiments, the first pressure sensor 306a may be coupled to the prefiltration unit 310. In some embodiments, the first pressure sensor 306a may be coupled to the first prefilter element 310a (see, e.g., FIG. 4B), the second prefilter element 310b, the third prefilter element 310c, or the fourth prefilter element 310d.

In some embodiments of the water treatment system 300, the first TDS sensor 316a may be in fluid communication with the prefiltered water line 312. The first TDS sensor 316a may measure, monitor, or sense the conductivity of the prefiltered water to determine the concentration or amount of dissolved solids in the prefiltered water. Alternatively, the first TDS sensor 316a may be in fluid communication with water within the fourth prefilter element 310d. The first TDS sensor may measure, monitor, or sense the conductivity of the water within the fourth prefilter element 310d to determine the concentration or amount of dissolved solids in the water within the fourth prefilter element 310d. In some embodiments, the first TDS sensor 316a may be coupled to the prefiltration unit 310. In some embodiments, the first TDS sensor 316a may be coupled to the fourth prefilter element 310d (see, e.g., FIG. 4B), the first prefilter element 310a, the second prefilter element 310b, or the third prefilter element 310c.

In some embodiments, the water treatment system 300 may also include a post-filtration unit 350 as shown in FIGS. 3A-3C, 4B, 4C, and 4D. The post-filtration unit 350 may be in fluid communication with the outlet feed line 346 and a post-filtration line 356. The post-filtration unit 350 may be provided in the form of one or more of a first postfilter element 350a, a second postfilter element 350b, a third postfilter element 350c, and a fourth postfilter element 350d (scc, e.g., FIG. 4B). In some embodiments, the post-filtration unit 350 may be in the form of one or more ultraviolet (UV) lights or ozone. In further embodiments, the post-filtration unit 350 may be in the form of one or more remineralization cartridges.

The first postfilter element 350a may be in fluid communication with the outlet feed line 346 and the second postfilter element 350b. The second postfilter element 350b may be in fluid communication with the first postfilter element 350a and the third postfilter element 350c. The third postfilter element 350c may be in fluid communication with the second postfilter element 350b and the fourth postfilter element 350d. The fourth postfilter element 350d may be in fluid communication with the third postfilter element 350c and the fourth valve 308b.

In some embodiments, membrane permeate may enter the post-filtration unit 350 via the outlet feed line 346 and exit the post-filtration unit 350 via the post-filtration line 356. When membrane permeate passes through the post-filtration unit 350, the post-filtration unit 350, via the first postfilter element 350a, the second postfilter element 350b, the third postfilter element 350c, and the fourth postfilter element 350d, may remove sediment, particulates, certain chemicals and other contaminants from the inlet water, producing a postfiltered permeate that may flow out of the post-filtration unit 350 via the post-filtration line 356.

In some embodiments, the first postfilter element 350a, the second postfilter element 350b, the third postfilter element 350c, and/or the fourth postfilter element 350d may be an activated carbon filter. In other embodiments, the first postfilter element 350a, the second postfilter element 350b, the third postfilter element 350c, and/or the fourth postfilter element 350d may include filter media specifically designed to remove bacteria, nitrates, perfluoroalkyl and polyfluoroalkyl (PFAS) compounds, heavy metals such as arsenic, lead, iron, cadmium, and the like, and/or volatile organic compounds. In some embodiments, the post-filtration unit 350 may be in the form of one or more ultraviolet (UV) lights.

The fourth valve 308b and the outlet 348 may be in fluid communication with the post-filtration line 356. The fourth valve 308b may be used to control or regulate the amount of water (e.g., membrane permeate) flowing from the second tank 360, through the tank line 344, into the outlet feed line 346, through the post-filtration unit 350 and post-filtration line 356, and out of the outlet 348. The fourth valve 308b may open, either partially or fully, to enable or increase the flow or the amount of water from the second tank 360, through the tank line 344, into the outlet feed line 346, through the post-filtration unit 350 and post-filtration line 356, and out of the outlet 348. The fourth valve 308b may close, either partially or fully, to stop or decrease the amount of water flowing from the second tank 360, through the tank line 344, into the outlet feed line 346, through the post-filtration unit 350 and post-filtration line 356, and out of the outlet 348. The amount of water flowing through the outlet feed line 346 through the post-filtration unit 350 and post-filtration line 356, and out of the outlet 348 may increase or decrease the water pressure in the water treatment system 300.

As illustrated in FIG. 4C, in some embodiments, the water treatment system 300 may include a second tank 360, which is in fluid communication with the tank 318 via a tank connector line 362. The second tank 360 may be used to store water. The second tank 360 may be defined by a housing having a bottom portion 360a, a center portion 360b, and a top portion 360c. In some instances, each of the portions 360a, 360b, 360c may be separated by a physical barrier (e.g., if the second tank 360 is provided as a bladder tank), although in preferred embodiments no physical barrier is positioned between the portions 360a, 360b, 360c. In some embodiments, the second tank 360 may be a pressurized tank. In some embodiments, the second tank 360 may be a fiberglass reinforced plastic (FRP) tank. In some embodiments, the second tank 360 may range in size from about 24 gallons (91 liters) to about 200 gallons (757 liters).

The second tank 360 may include a second riser tube 320b that extends vertically from the bottom portion 360a of the second tank 360 to the top portion 360c of the second tank 360, or vice versa. The second riser tube 320b may be in fluid communication with the tank 318 via the tank connector line 362. In some embodiments, the second riser tube 320b may be PVC tubing.

The second tank 360 may include a second flow distributor (not shown), which may be attached or coupled to the second riser tube 320b. The second flow distributor may prevent or reduce the mixing of higher TDS water that may be stored in the bottom portion 360a of the second tank 360 with lower TDS water that may be stored in the top portion 360c of the second tank 360. In some embodiments, the second flow distributor may be a dome flow distributor. In some embodiments, multiple second flow distributors may be used.

In some embodiments, depending on the flow conditions when the water treatment system 300 is in use, the prefiltered water may flow from the prefiltration unit 310 through the prefiltered water line 312, down the riser tube 320 of the tank 318, and into the bottom portion 318a of the tank 318. The prefiltered water may be stored in the tank 318. The prefiltered water may also flow from the prefiltration unit 310 via the prefiltered water line 312 toward the pump 330 via the additive line 326. The prefiltered water may then flow from the pump 330 to the membrane element 334 via the membrane feed line 332 for processing by the membrane element 334. The prefiltered water may further flow from the bottom portion 318a of the tank 318, where the prefiltered water may be stored, up the riser tube 320 of the tank 318, through the prefiltered water line 312 toward the pump 330 via the additive line 326 to the membrane element 334 via the membrane feed line 332 for processing by the membrane element 334. The prefiltered water may pass through the membrane element 334, resulting in retentate exiting the membrane element 334 via the retentate line 336 and/or membrane permeate exiting the membrane element 334 via the membrane permeate line 338.

The membrane permeate line 338 may be connected to or otherwise in fluid communication with the tank line 344. The tank line 344 may be in fluid communication with the top portion 360c of the second tank 360. The tank line 344 also may be connected to or otherwise in fluid communication with an outlet feed line 346.

In some embodiments, depending on flow conditions when the water treatment system 300 is in use, the membrane permeate may flow from the permeate side of the membrane element 334 through the membrane permeate line 338 and the tank line 344 into the top portion 360c of the second tank 360. The membrane permeate may be stored in the second tank 360. The membrane permeate may also flow from the permeate side of the membrane element 334 through the membrane permeate line 338 and the tank line 344, into the outlet feed line 346 (thereby bypassing the second tank 360) through the post-filtration unit 350 and the post-filtration line 356, and out of the outlet 348. By enabling the flow of membrane permeate from the membrane element 334 directly to the outlet 348, membrane permeate may be provided to a point of use in real time.

The third valve 342 may be used to control or regulate the amount of membrane permeate entering or flowing through the membrane permeate line 338 into the tank line 344 and into the top portion 360c of the second tank 360 or toward the outlet 348 via the outlet feed line 346 and post-filtration line 356. The third valve 342 may open, either partially or fully, to enable or increase the flow or the amount of membrane permeate flowing through the membrane permeate line 338 to the tank line 344, and into the top portion 360c of the second tank 360 or into the outlet feed line 346 and toward the outlet 348. The third valve 342 may close, either partially or fully, to stop or decrease the amount of membrane permeate flowing through the membrane permeate line 338 and the tank line 344, into the top portion 360c of the second tank 360 or into the outlet feed line 346 and toward the outlet 348. The amount of membrane permeate entering or flowing through the membrane permeate line 338 and into the second tank 360 or toward the outlet 348 may increase or decrease the water pressure in the water treatment system 300.

A second flowmeter 314b may be positioned within or otherwise in fluid communication with the tank line 344. The second flowmeter 314b may measure, monitor, or sense the flow rate of the prefiltered water through the tank line 344.

In some embodiments, the second tank 360 may include zero, one, two, three, or more TDS sensors (not shown) disposed in each of the top, center, or bottom portions of the second tank 360. For example, in some embodiments, a TDS sensor may only be disposed in the center portion 360b of the second tank 360, not the top portion 360c or the bottom portion 360a. In other embodiments, a TDS sensor may be disposed in each of the top portion 360c and the bottom portion 360a of the second tank 360, but not the center portion 360b. In some embodiments, zero TDS sensors may be disposed in the second tank 360.

Depending on flow conditions, in some embodiments, the membrane permeate (i.e., the lower TDS water) that may be stored in the second tank 360 may flow from the second tank 360 through the tank line 344, the outlet feed line 346, the post-filtration unit 350, and the post-filtration line 356 and out of the outlet 348. The outlet 348 may be in fluid communication with various appliances, fixtures, and plumbing of the residential or commercial 3property. In some embodiments, the outlet 348 may be in fluid communication with a water heater, faucets, fixtures, or toilets via one or more pipes or tubes.

In some embodiments, higher TDS water may be stored in tank 318 (e.g., prefiltered water from the prefiltration unit 310) and lower TDS water (e.g., membrane permeate from the membrane element 334) may be stored in second tank 360. Depending on flow conditions when the water treatment system 300 is in use, the lower TDS water (e.g., membrane permeate) stored in the second tank 360 may flow from the bottom portion 360a of the second tank 360 through the second riser tube 320b and tank connector line 362 and into the tank 318 as the high TDS water (e.g., prefiltered water) in tank 318 flows out of the tank 318 via the riser tube 320, through the prefiltered water line 312, the additive line 326, and the membrane feed line 332 toward the membrane element 334 for processing by the membrane element 334. Once processed, the resulting membrane permeate may flow toward and into the second tank 360 via the membrane permeate line 338 and the tank line 344 or toward and out of the outlet 348 via the outlet feed line 346 and the post-filtration line 356.

In some embodiments of the water treatment system 300, the optional mineralization unit 380 may be disposed on the post-filtration line 356 as shown in FIG. C, rather than the membrane permeate line 338, the tank line 344, or the outlet feed line 346 as shown in FIGS. 4A, 4B, and 4D. In some embodiments, the mineralization unit 380 may be disposed on the post-filtration line 356 before the fourth valve 308b.

Turning to FIG. 4D, in some embodiments, the water treatment system 300 may further include a second membrane element 370, which may be a reverse osmosis (RO) membrane. In some embodiments, the RO membrane may be spiral wound and may include feed spacers imparted with a certain thickness and/or structure as discussed in more detail above with respect to the membrane element 334.

In some embodiments, the second membrane element 370 may be a nanofiltration (NF) membrane, an ultrafiltration (UF) membrane, a microfiltration (MF) membrane, or a particulate membrane. In some embodiments, the second membrane element 370 may be a hollow fiber NF membrane. In other embodiments, the second membrane element 370 may be an electrodialysis membrane system.

In other embodiments, the second membrane element 370 may comprise a combination of one or more of a RO membrane, a NF membrane, a UF membrane, a MF membrane, a particulate membrane, and/or an electrodialysis membrane, which may be disposed in parallel or in series as discussed in further detail above with respect to membrane element 334. The one or more membranes in the combination of membranes may be contained within a single housing, in separate housings, or a combination thereof.

In further embodiments, the second membrane element 370 may include two or more RO membranes, NF membranes, UF membranes, MF membranes, particulate membranes, and/or electrodialysis membranes, which may be disposed in parallel or in series. In some embodiments, the second membrane element 370 may be a series of membranes of the same type (e.g., two or more RO membranes) but of a different size (e.g., each membrane is imparted with a different diameter) as discussed in more detail above with respect to membrane element 334. The two or more membranes may be contained within a single housing, in separate housings (e.g., as shown in FIG. 4D), or a combination thereof.

The second membrane element 370 may be in fluid communication with the retentate line 336 of the membrane element 334 on a feed side (not shown) of the second membrane element 370. The second membrane element 370 also may be in fluid communication with a second retentate line 372 on the feed side of the second membrane element 370. The second membrane element 370 may be in fluid communication with a second membrane permeate line 374 on a permeate side (not shown) of the second membrane element 370.

In some embodiments, the retentate of the membrane element 334 may be processed by the second membrane element 370 producing a second membrane permeate that may exit the second membrane element 370 via the second membrane permeate line 374. The second membrane element 370 may produce a second membrane retentate that may exit the second membrane element 370 via the second retentate line 372.

In some embodiments, as the retentate from the membrane element 334 enters the feed side of the second membrane element 370 via the retentate line 336, the second membrane element 370 may allow a solvent (e.g., water) in the retentate to pass through a surface of a membrane (not shown) retained within the second membrane element 370. The solvent that passes through the surface of the membrane within the second membrane element 370 may exit from the permeate side of the second membrane element 370 as the second membrane permeate via the second membrane permeate line 374. Solutes (e.g., dissolved minerals and ions and various organic compounds) in the retentate from the membrane element 334 may not pass through the membrane of the second membrane element 370 and may be retained at the surface of the membrane. The solutes may be discharged from the feed side of the second membrane element 370 as the second membrane retentate via the second retentate line 372.

In some embodiments, when the pump 330 is activated, the pump 330 may increase the rate at which water flows into the membrane feed line 332 toward the membrane element 334 and the second membrane element 370. Increasing the flow rate of water into the membrane feed line 332 may increase pressure in the membrane feed line 332. The increased pressure may in turn aid in pushing solvent through the pores formed within the surface of the membrane retained within the membrane element 334 and through the pores formed within the surface of the membrane retained within the second membrane element 370.

In the embodiment of the water treatment system 300 illustrated in FIG. 4D, the flow restrictor tube 339, which may be in communication with the retentate line 336, may be used to control or regulate the amount of the retentate leaving the membrane element 334 and/or entering the second membrane element 370. In some embodiments, the flow restrictor tube 339 may be a capillary tube imparted with an inner diameter of at least about 1/16 inches (at least about 1.6 mm) to no more than about ⅛ inches (no more than about 3.2 mm). In some embodiments, the flow restrictor tube 339 may be imparted with a length of at least about 1 inch (at least about 2.5 centimeters) to at least about 4 feet (at least about 122 cm). For example, the flow restrictor tube 339 may be imparted with a length of no less than 1 foot (30.5 centimeters) and no more than 3 feet (91.4 centimeters). In some embodiments, the flow restrictor tube 339 may be provided in the form of material that has a low energy surface to prevent the formation of scale on the surface of the flow restrictor tube 339, given that retentate may be beyond the saturation limit of the water. For example, the flow restrictor tube 339 may be made from polyethylene tubing. In other embodiments, a valve (e.g., a ball valve, needle valve, or globe valve) may be used instead of or in combination with the flow restrictor tube 339. In some embodiments, no flow restrictor tube 339 or valve is provided on the retentate line 336.

In the embodiment of the water treatment system 300 illustrated in FIG. 4D, a second flow restrictor tube 339b may be in fluid communication with the second retentate line 372. The second flow restrictor tube 339b may be used to control or regulate the amount of the second membrane retentate leaving the water treatment system 300 via the second retentate line 372 into the drain 341. In some embodiments, the second flow restrictor tube 339b may be a capillary tube imparted with an inner diameter of at least about 1/16 inches (at least about 1.6 mm) to no more than about ⅛ inches (no more than about 3.2 mm). In some embodiments, the second flow restrictor tube 339b may be imparted with a length of at least about 1 inch (at least about 2.5 centimeters) to at least about 4 feet (at least about 122 cm). For example, the second flow restrictor tube 339b may be imparted with a length of no less than 1 foot (30.5 centimeters) and no more than 3 feet (91.4 centimeters). In some embodiments, the second flow restrictor tube 339b may be provided in the form of material that has a low energy surface to prevent the formation of scale on the surface of the second flow restrictor tube 339b, given that the second membrane retentate may be beyond the saturation limit of the water. For example, the second flow restrictor tube 339b may be made from polyethylene tubing. In further embodiments, a valve may be used instead of or in combination with the second flow restrictor tube 339b. The amount of the second membrane retentate exiting the water treatment system 300 into the drain 341 may increase or decrease the water pressure in the water treatment system 300.

In some embodiments (see FIG. 4D), the second TDS sensor 316b and the first flowmeter 314a may each be in communication with the second retentate line 372 instead of the retentate line 336. The second TDS sensor 316b may measure, monitor, or sense the conductivity of the second membrane retentate to determine an amount or concentration of dissolved solids in the second membrane retentate. The first flowmeter 314a may measure, monitor, or sense the flow rate of the second membrane retentate in the second retentate line 372.

In some embodiments, the membrane permeate line 338, which may be in fluid communication with the membrane element 334, may include a third flow restrictor tube 339c. The third flow restrictor tube 339c may be used to control or regulate the amount of membrane permeate flowing from the membrane element 334 through the membrane permeate line 338. In some embodiments, the third flow restrictor tube 339c may be a capillary tube imparted with an inner diameter of at least about 1/16 inches (at least about 1.6 mm) to no more than about ⅛ inches (no more than about 3.2 mm). In some embodiments, the third flow restrictor tube 339c may be imparted with a length of at least about 1 inch (at least about 2.5 centimeters) to at least about 4 feet (at least about 122 cm). For example, the third flow restrictor tube 339c may be imparted with a length of no less than 1 foot (30.5 centimeters) and no more than 3 feet (91.4 centimeters). In some embodiments, the third flow restrictor tube 339c may be provided in the form of material that has a low energy surface to prevent the formation of scale on the surface of the third flow restrictor tube 339c. In further embodiments, a valve may be used instead of or in combination with the third flow restrictor tube 339c.

In some embodiments (see FIG. 4D), the water treatment system 300 may have a combined membrane permeate line 376. The combined membrane permeate line 376 may be in fluid communication with the membrane permeate line 338. The membrane permeate line 338 may bypass the second membrane element 370 providing a fluid flow of membrane permeate from the membrane element 334 to the combined membrane permeate line 376. The combined membrane permeate line 376 may also be in fluid communication with the second membrane permeate line 374.

I In some embodiments (see FIG. 4D), the combined membrane permeate line 376 may be in fluid communication with the third valve 342a. Depending on flow conditions, in some embodiments of the water treatment system 300, membrane permeate from the membrane element 334 may flow from the membrane element 334 through the membrane permeate line 338 and third flow restrictor tube 339c, into the combined membrane permeate line 376 and toward the third valve 342a. In addition, the second membrane permeate from the second membrane element 370 may flow from the second membrane element 370 element through the second membrane permeate line 374, into the combined membrane permeate line 376 toward the third valve 342a.

In some embodiments (see FIG. 4D), the third valve 342a may be in fluid communication with the tank line 344. Depending on flow conditions, in some embodiments of the water treatment system 300, the membrane permeate and/or the second membrane permeate in the combined membrane permeate line 376 may flow through the third valve 342a and the tank line 344, into the top portion 318c of the tank 318. The membrane permeate and/or the second membrane permeate in the combined membrane permeate line 376 also flow through the third valve 342a and the tank line 344 into the outlet feed line 346 toward the outlet 348.

In some embodiments, the third valve 342a may be used to control or regulate the amount of membrane permeate and/or second membrane permeate entering or flowing through the combined membrane permeate line 376 into the tank line 344 and into the top portion 318c of the tank 318 or toward the outlet 348 via the outlet feed line 346. The third valve 342a may open, either partially or fully, to enable or increase the flow or the amount of membrane permeate and/or second membrane permeate flowing through the combined membrane permeate line 376 to the tank line 344, and into the top portion 318c of the tank 318 or into the outlet feed line 346 and toward the outlet 348. The third valve 342a may close, either partially or fully, to stop or decrease the amount of membrane permeate and/or second membrane permeate flowing through the combined membrane permeate line 376 and the tank line 344, into the top portion 318c of the tank 318 or into the outlet feed line 346 and toward the outlet 348. The amount of membrane permeate and/or second membrane permeate entering or flowing through the combined membrane permeate line 376 and into the tank 318 or toward the outlet 348 may increase or decrease the water pressure in the water treatment system 300.

In some embodiments of the water treatment system 300, the optional mineralization unit 380 may be disposed on the combined membrane permeate line 376, rather than the membrane permeate line 338, the tank line 344, the outlet feed line 346 as shown in FIGS. 4A, B, and 4D, or the post-filtration line 356 as shown in FIG. 4C.

In some cases, the one or more TDS sensors 316 may be provided in the form of ion-selective electrodes. The ion-selective electrodes may be designed to detect one or more ions in a water stream that may impact a measured TDS or alkalinity value. For example, the one or more TDS sensors may be provided in the form of an ion-selective electrode designed to detect calcium ions, an ion-selective electrode designed to detect magnesium ions, an ion-selective electrode designed to detect alkalinity values, and the like. It is to be appreciated that the ion-selective electrodes may also be provided as the one or more TDS sensors 116, 216 in the water treatment systems 100, 200.

In various instances of the water treatment system 300, the TDS content of water may be determined indirectly by measuring the conductivity of a water stream. Generally, a conductivity value provides a proxy for TDS content in a water stream, as the presence of ions affects an ability of a water stream to conduct electricity. Accordingly, in some instances, conductivity measurements may be carried out in place of, or in conjunction with, measurements of TDS values. In such instances, one or more conductivity threshold values may be used in addition to or in place of the TDS threshold values when determining actions taken by the water treatment system 300. For example, the control system 400 may use the conductivity threshold values instead of the TDS threshold values for determining an action. In addition, the control system 400 may convert the measured conductivity values to TDS values. The conversion may partially depend on the solution used to calibrate the conductivity sensor (e.g., a sodium chloride solution, a potassium chloride solution, a mixed-ion solution such as a “442” solution).

To measure the conductivity values of the water streams in the water treatment system 300, one or more conductivity sensors may be provided in the water treatment system 300. The conductivity sensors may be placed in fluid communication with any of the conduits provided in the water treatment system 300. In addition, the conductivity sensors may be positioned in the same locations, or substantially the same locations, as the one or more TDS sensors 316.

It is to be understood that the above-described conductivity sensors may also be implemented in the water treatment systems 100, 200.

One skilled in the art would appreciate that less or more of each of the water treatment system components, e.g., inlets, outlets, filters, feeders, valves, pumps, tanks, lines, membranes, sensors, and/or control systems may be used in any of the embodiments disclosed herein without departing from the scope of the present disclosure. In addition, other sensors, e.g., ORP probes, colorimeter sensors, ion-selective electrode sensors, volume-based batching sensors, or pH sensors, may be used in any of the embodiments disclosed herein. Further, the specific location of each of the water treatment system components may vary from the locations disclosed in the embodiments described herein without departing from the scope of the present disclosure.

FIG. 5 is a schematic illustration of the control system 400 used with the water treatment systems of FIGS. 1, 2, 3A-3C, and 4A-4E according to some embodiments. The controller 402 may be electronically connected to the display 450 and the water treatment system components including the various sensors, valves, feeder, and pump via one or more wires or may be electronically connected via a communications network. The communications network may be a wireless network such as a personal area network (PAN) or local area network (LAN), a cellular network, or the Internet. In some embodiments, the display 450 may be an LED, LCD, or OLED display.

The controller 402 may be Bluetooth enabled and have Internet of Things (IoT) connectivity. The water treatment system components (e.g., the sensors, valves, feeder, and/or pump) may be IoT-enabled and/or communicatively connected smart components.

In some instances, the system can use an internet or cell-connected system to monitor the system use, membrane productivity, filter element pressure drops, pressure drop changes, and water conditions. In various instances, the system can monitor the system remotely and trigger cleaning in which specified cleaning chemicals and a cleaning regimen are chosen and initiated.

In some cases, the data collection and analysis regarding the type of cleaning and how frequently the cleaning is conducted can be done in a central location, using most up-to-date water data and analysis programs. Data collection and analysis can also be done while monitoring the resulting membrane flux, to record efficacy. In some instances, remote decision-making can be coordinated with a service visit, if necessary. The service can include replacement of the membrane element, replacement of some or all of the filter elements, replacement of any treatment chemicals, or a manual cleaning process.

The controller 402 may send or receive electronic signals from one or more of the sensors including the pressure sensors (e.g., 106a-160g, 206a-206g, 306a-306d), flowmeters (e.g., 114a-114d, 214a-214d, 314a-314c), TDS sensors (e.g., 116a-116h, 216a-216h, 316a-316f), the temperature sensors (e.g., 122, 222, 322), and/or any other sensors provided in the water treatment system (e.g., 100, 200, 300). The electronic signals received from one or more of the sensors may provide measurements and other data regarding pressure, flow rate, total dissolved solids, conductivity, pH level, or the temperature of the water at various locations in the water treatment system. The measurements and other data may be sent to the controller 402 by the one or more sensors continuously, frequently or periodically.

The control system 400 may use the measurements or other data received from one or more of the sensors to send electronic signals to the valves, feeders, or the pumps. In some embodiments, the controller 402 may send an electronic signal to a first valve (e.g., 108, 208a, 308a), a second valve (e.g., 140, 229a, 329a), a third valve (e.g., 142, 242, 342a), a fourth valve (e.g., 208b, 308b), a fifth valve (e.g., 229b, 342b), and/or a sixth valve (e.g., 329b) to open or close, partially or fully. The controller 402 may send an electronic signal to a feeder (e.g., 128, 228, 328) to start, stop, increase, or decrease the amount of chemical additive released by the feeder 128. The controller 402 may send an electronic signal to a pump (e.g., 130, 230, 330) to start, stop, increase, or decrease the speed of the pump. Adjusting one or more of the valves, the feeder, and/or the pump may change the flow rate of the water into, through or out of the system, the flow direction of the water within the system, and/or the pressure of the water in various lines of the water treatment system. The controller 402 may also receive electronic signals from the valves, feeders, and/or pumps.

It is to be understood that one or more of the values associated with the water treatment systems described herein (e.g., the systems of FIGS. 4A-4F), including a target threshold value, a target tank threshold value, an amount of chemical additive, a target TDS value, a membrane temperature, a water temperature, and the like, may be measured at different time intervals. In addition, the one or more values described with reference to the water treatment systems herein (e.g., the systems of FIGS. 4A-4F) may be measured on demand, manually implemented, or at predetermined time intervals (e.g., continuously, once a second, once a minute, once a day, once a week, once a month, etc.). Further, it is to be understood that the one or more of the values associated with the water treatment systems described herein (e.g., such as the systems described with reference to FIGS. 4A-4F) may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition. In each instance, such measurements may be carried out by one or more systems provided with the water treatment system and then received and stored by a controller (e.g., controller 402).

In addition, the predetermined values, thresholds, ranges, and other information described with reference to the water treatment systems of FIGS. 4A-4F (e.g., values, parameters, metrics, or characteristics associated with a membrane element flux, a membrane output, a membrane rejection value, a membrane salt passage value, an RTD value, other values indicative of membrane health, and combinations thereof) may be manually implemented or otherwise input into the system. For example, the predetermined values, target values, and predetermined ranges may be manually input into a user interface of a controller (e.g., controller 402), provided to the controller via a user device, or otherwise associated with and retained by the controller.

In some instances, a lookup table of predetermined values, thresholds, ranges, and other information may be stored by a controller (e.g., the controller 402), and the controller may determine an appropriate action based on one or more of the variables discussed herein. In addition, the controller may include pre-stored lookup tables. Furthermore, the controller may be in communication with a network and may be capable of downloading lookup tables. The controller may select threshold values (a threshold value associated with, e.g., a membrane element flux, a membrane output, a membrane rejection value, a membrane salt passage value, an RTD value, and combinations thereof) from the lookup tables based on a number of factors including a determined pressure, flow rate, conductivity, total dissolved solids, pH level, the temperature of the water at various locations, and/or other similar factors.

Referring again to FIG. 5, the controller 402 may include electronic components such as one or more processors 404, a memory 406 (e.g., random access memory (RAM)), an input/out device 408, and a power supply 410 (e.g., battery or AC adapter plug). The controller 402 may be able to download, store, and/or execute software having computer executable instructions. The software may include one or more modules. The one or more modules may include, for example, algorithms to monitor and/or store the measurements or other data received from one of more of the system components such as the sensors, valves, feeders, or pumps or may monitor and/or store real-time and historic flow patterns and usage data. The controller 402, via the one or more modules, may also perform calculations or other data analysis or modeling process to determine various outcomes. The outcomes may include, for example, turning one or more of the system components of the water treatment system on or off at certain times or intervals or placing one or more of the system components in standby mode.

In some cases, the controller 402, using one or more algorithms, can coordinate the functions of the pump 230, 330 with the various methods for cleaning or preserving the membrane element 234, 334. For example, the controller 402 can trigger or initiate dispensing of the chemical additive during the permeate flush process. In such instances, the chemical additive (e.g., the polyphosphate compound, the acid component, the caustic compound, the oxidizing compound, the enzyme, the detergent, etc.) can be introduced into the membrane element 234, 334 when the water flow rate is low or very low and the water is relatively pure (e.g., the chemical additive can be provided to the permeate water imparted with a low flow rate). As a result of the controller 402 employing one or more algorithms, dispensing of the chemical additive can be controlled such that the quantity of chemical used during the cleaning process can be lowered, thereby saving resources. In some instances, the controller 402 can trigger or initiate dispensing of the chemical additive during a first portion of the permeate flush process so that a second portion of the permeate flush process does not include the chemical additive. For example, the chemical additive may only be provided to the permeate stream during a beginning portion of the permeate flush. As an additional example, the chemical additive may only be provided to the permeate stream for no more than about one-third, or no more than about half, or no more than about two-thirds, or no more than about three-quarters of a total time that the permeate flush is implemented. In such cases, the permeate stream alone may be provided to the membrane element 234, 334 during a remainder of the total time of the permeate flush process. As yet another example, if the permeate flush is carried out for 30 minutes, the chemical additive may be provided to (e.g., doscd to) the permeate only during the first 20 minutes of the permeate flush, while the permeate rinse alone is provided to the membrane element 234, 334 during the final 10 minutes of the permeate flush process. In this way, the membrane element 234, 334 may not be in contact with the chemical additive for long periods of time, as contacting the membrane element 234, 334 with the chemical additive for extended time periods may be harmful to the membrane element 234, 334 and/or interfere with performance of the system 200, 300 (e.g., the chemical additive may diffuse across the membrane element 234, 334 after extended contact times).

In some instances, the controller 402 can trigger dispensing of the chemical additive after a fixed number of RO cycles. For example, the controller 402 can trigger dispensing of the chemical additive after no more than about 10 RO cycles, or no more than about 20 RO cycles, or no more than about 50 RO cycles, or no more than about 100 RO cycles, or no more than about 250 RO cycles, or no more than about 500 RO cycles. As an additional example, the controller 402 can trigger dispensing of the chemical additive after no more than 10 RO cycles, or no more than 20 RO cycles, or no more than 50 RO cycles, or no more than 100 RO cycles, or no more than 250 RO cycles, or no more than 500 RO cycles. In some cases, the controller 402 can trigger dispensing of the chemical additive after a greater number of cycles or a fewer number of cycles than those recited herein. In other instances, the controller 402 can trigger dispensing of the chemical additive after a fixed period of time. For example, the controller 402 can trigger dispensing of the chemical additive after every no more than about 5 hours, or no more than about 25 hours, or no more than about 50 hours, or no more than about 100 hours. As an additional example, the controller 402 can trigger dispensing of the chemical additive after every no more than 5 hours, or no more than 25 hours, or no more than 50 hours, or no more than 100 hours. In other cases, the controller 402 can trigger dispensing of the chemical additive after greater or less amounts of time than the time periods recited herein. In yet other instances, the controller 402 can trigger dispensing of the chemical additive when the monitoring of the membrane element 234, 334 indicates that the membrane element 234, 334 has become fouled (e.g., by monitoring pressure and flux of the membrane element 234, 334).

In some embodiments, the controller 402 may be able to self-diagnose or troubleshoot problems that arise without input from a user. Artificial intelligence or machine learning may be used to learn different patterns of usage to predict future behavior.

In some embodiments, the one or more modules may include a training module that may be designed to execute instructions related to one or more data analysis and modeling processes. In some embodiments, the training module may generate and iteratively train the machine learning training model to provide dynamic data analysis and outcomes, and the advanced analytics may be used to perform system and/or component diagnostics, generate alerts, notifications, or action items, provide customized recommendations according to user or service provider settings or preferences, and similar processes.

The controller 402 may be in communication with a remote device 490 such that the controller 402 can send or receive electronic signals from the remote device 490. The remote device 490 can be used to direct the controller 402 to start, stop, pause, or change various operational phases, including the membrane flush process, a membrane rinse process, a membrane soak process, and/or a membrane clean-in-place process described herein.

Additionally, the controller 402 may communicate information to the user of the water treatment system, a system servicer, or another person or company. The display 450 of the controller can alert the user when a cleaning cycle is in progress or when chemicals in the feeder or dosing tank are low. In some instances, the display 450 can provide the user with information regarding the health or estimated remaining lifetime of the membrane element 234, 334. In some instances, the information may be provided in the form of a battery image indicating a health percentage of the membrane element 234, 334. In some instances, when the system needs servicing, an alert (e.g., an indicative LED light on the device) or warning may be sent by the controller 402 to the display 450 or to the remote device 490 (e.g., a mobile phone, tablet, laptop or desktop computer). In certain cases, the alert or warning may comprise graphical symbols or words that may help a user determine the issue being experienced by the membrane element 234, 334 or another system component. For example, the alert or warning may identify or describe a system level issue (e.g., if the system pressure is too high or too low, if a leak has been detected) or a system component problem (e.g., a prefiltration unit is not working or is not operating efficiently). In some instances, the alert is a color-coded LED light on a given system component including, by way of example, the prefiltration unit 210, 310, the feeder 228, 328, the membrane element 234, 334, and/or the pump 230, 330. In some instances, alerts provided via an LED light may include providing a series of flashes of the LED light that indicate a problem and then specify the code of the problem by the number and/or length of the flashes. In some instances, the alert can indicate health of the system 200, 300 or component by the color emitted by the LED light or displayed on the display 450 or the remote device 490. For example, alerts utilizing a green color may denote good health of a particular component, alerts utilizing a yellow color may denote failing health of a particular component, and alerts utilizing a red color may denote end-of-life and the necessity of replacing a particular component. In various cases, the display 450 may utilize text or pictograms to denote the health of the system and components. In some instances, information regarding health of the membrane can be sent to the controller 402 and to the remote device 490. In such instances, the health of the membrane element 234, 334 may be depicted as a battery icon with a remaining life percentage provided within the battery icon.

The alert may be followed by, or may occur simultaneously with, the controller 402 taking an automatic action to address the issue. For example, if the system pressure is too high or too low (as measured by, e.g., pressure sensors 206, 306), the controller 402 may shut the water treatment system 200, 300 down and/or open or close certain valves or flow restrictor tubes (e.g., valves 242, 239, 308a, 308b, 329a, 329b, 339, 342a, 342b) in the system 300 to reduce or increase pressure. Additionally, or alternatively, the alert may provide a potential solution to the problem with or without any automatic action by the controller 402. For example, if a prefiltration unit 210, 310 is not working, the alert may suggest that the prefiltration unit 210, 310 be serviced or replaced. In addition, if the prefiltration unit is not performing efficiently, the alert may suggest, for example, that a filter cartridge of one of the prefiltration units 210, 310 be replaced. In such scenarios, the water treatment system may continue normal operation unless a user or other operator instructs the controller 402 to shut down the water treatment system or take other action.

In some embodiments, one or more metrics or characteristics (e.g., historic water usage data, system pressure, TDS concentration, or water flow rates) may be used as parameters in one or more processes to iteratively train a training model or a plurality of machine learning training models. One skilled in the art will understand that processes for “iteratively training the machine learning training model” may include machine learning processes, artificial intelligence processes, and other similar advanced machine learning processes. In various embodiments, the iteratively trained machine learning model(s) can be designed to perform various advanced data analysis and modeling processes. In some embodiments, these processes can be performed by multiple machine learning models, or multiple aspects of a single machine learning model (e.g., an ensemble model), or a combination thereof. In one non-limiting embodiment, the machine learning training model(s) can be designed to generate, train, and execute a plurality of nodes, neural networks, gradient boosting algorithms, mutual information classifiers, random forest classifications, and other machine learning and artificial intelligence-related algorithms. It will be appreciated by one skilled in the art that the system and processes described herein can include different and/or additional details, data, measurements, parameters, metrics, and/or characteristics than those described herein.

For example, in some embodiments, if water usage is high during certain intervals of the day, the control system 400 may activate the water treatment system to enter certain phases of the operational cycle during low water usage times. For example, if water usage is high during the morning and/or afternoon, the controller 402 may activate the water treatment system to process high TDS water that may be stored in the tank through the membrane element to produce more membrane permeate and/or the controller 402 may activate the water treatment system to perform a membrane permeate flush of the membrane element during the night when there is less demand on the system.

In addition, if the water treatment system is not being used regularly (e.g., the user is on vacation or is traveling frequently), then certain components of the system, for example, the membrane element, may be adversely affected due to stagnation. To combat stagnation, the controller 402 may activate certain operational cycles of the system (e.g., the membrane permeate flush) if the water treatment system is not used within a certain period of time (e.g., 24 hours, 48, hours, 72 hours, 96 hours, etc.). Furthermore, seasonal changes may affect inlet water chemistry or temperature. For example, the pH, total alkalinity, and temperature of the inlet water may decrease in the winter and increase in the summer. The controller 402 may learn when the seasonal change is likely to occur and recalibrate system components or modify calculations performed by the controller 402 to account for the seasonal changes.

In some embodiments, the measurements or other data collected by the sensors may provide information regarding the performance, integrity, or “health” of the membrane element, which may assist in the operation of the water treatment system. Membrane element and water treatment system performance may decline over time due to a variety of factors including, but not limited to, membrane fouling, filter media loading, and chemical additive depletion. These types of issues are undesirable not only because a reduction in the water treatment system performance may lower system efficiency, but also because they may produce a poor experience for the user. Therefore, it may be beneficial to monitor and optimize system performance. Analyzing real-time data and adjusting processing conditions may lead to improvements in the operation and efficiency of the membrane element or other system components such as the prefiltration unit or chemical additive feeder, which in turn may improve the longevity of the components and the overall performance of the water treatment system. The analysis may either be performed locally via the controller 402 or remotely.

Additionally, the controller 402 may communicate information to the user of the water treatment system, a system servicer, or other person or company. For example, an alert or warning may be sent by the controller 402 to the display 450 or to another user device such as a mobile phone, tablet, laptop or desktop computer identifying or describing a system level issue (e.g., the system pressure is too high or too low or a leak has been detected) or a system component problem (e.g., the prefiltration unit is not working or is not operating efficiently). The alert may be followed by, or may occur simultaneously, with the controller 402 taking an automatic action to address the issue. For example, if the system pressure is too high or too low, the controller 402 may shut the water treatment system down and/or open or close certain valves in the system to reduce or increase pressure. Additionally, or alternatively, the alert may provide a potential solution to the problem with or without any automatic action by the controller 402. For example, if a prefiltration unit is not working, the alert may suggest that the prefiltration unit be serviced or replaced, or if the prefiltration unit is not performing efficiently, the alert may suggest, for example, that a filter cartridge of one of the prefilter elements be replaced. In such scenarios, the water treatment system may continue normal operation unless a user or other operator instructs the controller 402 to shut down the water treatment system or take other action.

In some embodiments, flowmeters may be used to determine when a certain operational cycle may be triggered. For example, one or more flowmeters may be placed on an outlet feed line, which may provide water to a point of use, and/or on a membrane permeate line. A flowmeter on the outlet feed line may monitor the water consumed, and a flowmeter on the membrane permeate line may monitor the amount of membrane permeate produced. After a certain amount of water has been consumed, which may be monitored by the flowmeter on the outlet feed line, the water treatment system may be activated to start processing inlet water through the membrane element. After a determined amount of membrane permeate has been produced through the membrane element, which may be monitored by the flowmeter on the membrane permeate line, the water treatment system may shut off and return to standby mode until the cycle may be triggered again.

In some embodiments, flowmeters may be used to observe permeate flow rate over a period of time to determine if the performance of the water treatment system (e.g., the membrane element) is decreasing. For example, the membrane permeate flow rate may decrease from 4 gallons per minute (GPM) (15 liters per min (L/min)) in Week 1, to 3.75 GPM (14 L/min) in Week 2, to 3.5 GPM (13 L/min) in Week 3, to 3 GPM (11 L/min) in Week 4. At the same time, pressure in a membrane feed line may increase over the same time frame, e.g., from 200 pounds per square inch (PSI) (1379 kilopascals (kPa)) in Week 1, to 203 PSI (1400 kPa) in Week 2, to 206 PSI (1420 kPa) in Week 3, and 212 PSI (1462 kPa) in Week 4. The controller 402 may identify this trend and change certain operating metrics, characteristics, or parameters or send a communication to a user or system servicer to perform maintenance on the water treatment system.

In some embodiments, one or more pressure sensors may be disposed or otherwise associated with different locations of the water treatment system's plumbing to provide feedback on the water treatment system's performance. For example, the inlet and outlet pressures of a prefiltration unit or post-filtration unit of the water treatment system may be measured by one or more pressure sensors disposed at a location that is before and/or after the prefiltration unit. A significant drop in pressure across the prefiltration unit during flow events may signify that the filter media may be clogged and lowering system performance. Communicating the need for a new filter cartridge for the prefiltration unit to a user or system servicer in a timely manner may help prevent future performance loss and cause the water treatment system to operate better. In addition, depending on the location of the pressure sensors, the data provided by the pressure sensors may determine if the water treatment system is operating safely. If the water treatment system is not operating within a certain threshold (over or under a certain pressure parameter), the water treatment system may be shut down. Pressure measurements provided by the one or more sensors may also be used to trigger the water treatment system cycle to turn off or enter a standby mode. For example, a pressure sensor on an outlet feed line may sense a reduced pressure in the line when the water in the outlet feed line reduces in total dissolved solids, which may indicate that a sufficient amount of membrane permeate has been produced, which in turn may trigger the pump to stop operating.

In some embodiments, one or more TDS sensors may measure TDS or conductivity in the various lines to track ions in solution. The data received from the one or more TDS sensors may be used to evaluate membrane rejection, concentration factor, and other metrics or characteristics that may indicate whether the membrane element may be operating efficiently or if the processing parameters need adjustment. In some instances, a TDS sensor may be placed on the inlet water line to monitor the TDS levels of the inlet water. Another TDS sensor may be placed on the outlet side of the membrane element and/or the retentate line. The TDS levels of the inlet water may be compared to the TDS levels of the membrane permeate exiting the membrane element and/or the retentate. If there is a change in the TDS levels of the membrane permeate (e.g., there is an at least 10% rise or decline in the TDS levels of the membrane permeate while the inlet water TDS levels remain constant) or the TDS levels of the retentate (e.g., there is an at least 10% decrease in the TDS levels of the retentate while the inlet water TDS levels remain constant, or if there is at least a 10% change in the TDS levels of the retentate while the inlet water TDS levels remain constant), then the controller 402 may provide an alert to the user or system servicer (e.g., via the display 405 or via another device) that the membrane is not functioning properly.

In some embodiments, the pump may be turned on or off based on data received from the one or more sensors in the water treatment system. For example, one or more TDS sensors may be used inside the tank to trigger the pump to start producing membrane permeate when there is a rise in TDS of the water within the tank. For example, a TDS sensor may be placed at a center portion of the tank. As the amount of high TDS water increases in the tank, the TDS sensor may register a change in TDS of the water in the center portion of the tank. If the amount of TDS in the water at the center portion of the tank rises by a certain percent (e.g., at least 10%, at least 15%, at least 20%, etc.), then the pump may be triggered/turned on to start circulating high TDS water located in the bottom portion of the tank through the membrane element to produce membrane permeate. Another TDS sensor may be placed at the bottom portion of the tank and, as the level of TDS of the water begins to decrease by a certain percent in the bottom portion of the tank (e.g., because high TDS water in the bottom portion of the tank may have been circulated through the membrane element to produce membrane permeate that fills the top portion of the tank), the pump may be triggered to turn off. Alternatively, the pump may be activated using one or more flowmeters to trigger the pump on when a significant portion of the low TDS water has been used from the tank. In some embodiments, the water treatment system may use one or more flowmeters to totalize water used since the last time the pump was run and the tank refilled with low TDS water. By using the totalized water and the current flow demand at the point of use, a logic circuit may determine when to turn on the pump. As it may be preferable to turn on the pump sooner in high-demand cases, the totalized water, tank volume, and current flow may be used to calculate the time remaining for low TDS water in the tank. When the time remaining for low TDS water drops below a certain threshold, the pump may be started. Furthermore, a flowmeter monitoring water consumed may also be used to turn the pump off. The controller 402 with inputs of a known tank volume, membrane element production rate, and desired flush volume along with the real-time readings from the flowmeter monitoring water use tracks the level of membrane permeate water present in the tank at any given time. When the controller 402 determines the water treatment system has completely refilled the tank and flushed enough membrane permeate past the membrane element, the pump may be shut off.

In some embodiments, one or more temperature sensors may be used to sense influent water temperatures and downstream temperatures to determine the quantity of water to process. The temperature sensors may be used to identify when the water in the tank has been fully processed as the downstream temperatures may be compared to the inlet temperature and when the downstream and/or the inlet temperature are within a chosen parameter the water treatment system may shut off and return to standby mode. Additionally, temperature sensors may be used to sense higher water temperatures and create variations in the processing of water and flushing of the membrane element. As temperatures increase, the water treatment system could identify the rise in temperature and adjust how long the membrane element is flushed and whether changes in the operational cycle are used to reduce potential scaling at higher water temperatures.

In some embodiments, one or more ORP probes may be placed on an inlet and an outlet side of the prefiltration unit and used to monitor the one or more prefilter elements. For example, the one or more ORP probes may monitor the sediment filter or activated carbon filter performance and indicate when the sediment filter or activated carbon filter may no longer be removing contaminants.

In some embodiments, one or more colorimeter sensors may be placed at various locations in the water treatment system. The one or more colorimeter sensors may measure the different concentrations of contaminants or other solutes dissolved in the water and trigger the system to turn on and off according to certain parameters or conditions selected by the user or the control system 400.

In other embodiments, one or more pH sensors may be placed on the inlet line and outlet feed line to measure the differences in pH of the water entering and exiting the water treatment system. Certain parameters or conditions selected by the user or the control system 400 may trigger the water treatment system to start and stop an operational cycle of the water treatment system to improve the quality of the water in the tank.

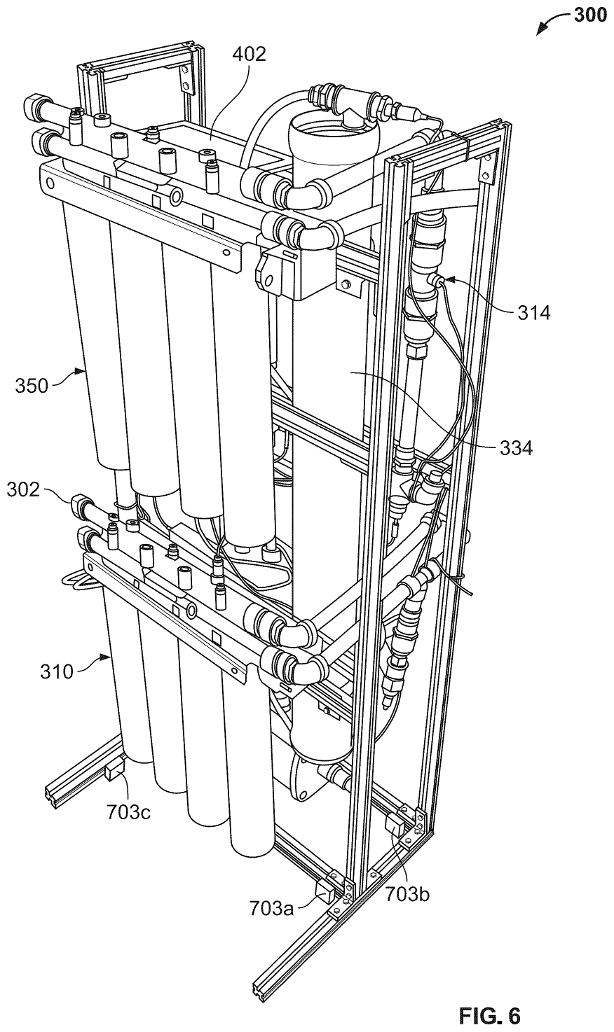

In further embodiments, the one or more sensors of the water treatment system (e.g., 100, 200, 300) may include, for example, one or more moisture sensors 703a, 703b, and 703c. In some embodiments, more than three moisture sensors may be used; in other embodiments, less than three moisture sensors may be used. The one or more moisture sensors 703a, 703b, and 703c may be disposed at various positions on or around the water treatment system as shown in FIG. 6. Additionally, or alternatively, the moisture sensors 703a, 703b, and 703c may be disposed at different locations in the residential or commercial property. For example, the one or more moisture sensors 703a, 703b, and 703c may be disposed in the same room or area as the water treatment system, on the same floor as the water treatment system, but in a different room or area, or on a floor below the water treatment system. The moisture sensors 703a, 703b, and 703c may be electronically connected to and/or in electronic communication with the controller 402.

The one or more moisture sensors 703a, 703b, and 703c are designed to sense the presence of water or other fluids. The presence of water or other fluids may indicate a leak or a flooding event. If the one or more moisture sensors sense the presence of water or another fluid, the one or more moisture sensors 703a, 703b, and 703c may send a signal to the controller 402. In response to receiving the signal from the one or more moisture sensors 703a, 703b, and 703c, the controller 402 may shut down the water treatment system, for example, by sending a signal to stop the pump and/or to close one or more valves. For example, the controller 402 may send a signal to close a valve on the inlet line to prevent water from entering the water treatment system. Additionally, or alternatively, the controller 402 may send a signal to close a valve on the outlet feed line to prevent water from exiting the water treatment system. By shutting down the water treatment system, the flow of water may be interrupted, which may reduce the potential for water damage.

In other embodiments, one or more pressure sensors may monitor the pressure in the water treatment system to determine if there are abnormal pressure increases or decreases. For example, if the pressure in the inlet line or the outlet feed line is greater than or about 100 pounds per square inch (PSI) (689 kPa) or the pressure in the membrane feed line is greater than or about 250 PSI (1724 kPa), then the controller 402 may send or otherwise indicate a warning. If a high-pressure event occurs in the system (e.g., the pressure in the inlet line or the outlet feed line is greater than or about 150 PSI/1034 kPa), the water treatment system via the controller 402 may close a valve, for example, on the inlet water line, which may protect one or more components of the water treatment system as well as the plumbing, appliances, and/or structure of the residential or commercial building from the high-pressure event. Additionally, or alternatively, during a high-pressure event, the water treatment system may open a valve to relieve pressure in the water treatment system. Relieving or reducing pressure may protect the water treatment system and/or the plumbing, appliances, or structure of the residential or commercial building.

If a low-pressure event occurs (e.g., there is insufficient pressure to operate the water treatment system without causing damage), then the water treatment system via the controller 402 may stop normal operation and default to a nonoperating standby mode until the low-pressure situation is resolved.

In some embodiments, the water treatment system may use a pressure decay test during times of low usage to detect leaks. For example, during a low usage time (e.g., at night or early morning) the water treatment system may close one or more valves to create a substantially closed system. For example, to detect a leak in the water treatment system, a valve disposed on the inlet line and a valve disposed on the outlet feed line may both be closed, via the controller, to create the closed system. In another instance, to detect a leak in the residential or commercial property, only the valve disposed on the inlet line may be closed, via the controller. Once the system is substantially closed, the water treatment system may then use one or more pressure sensors disposed at various locations in the water treatment system to determine if there is a decrease in pressure during a time period (e.g., there is at least or about a 10-50% decrease in pressure over at least or about 1-5 minutes). If a certain decrease in system pressure is observed during the predefined time period, then the pressure decrease may indicate that there is a leak in the water treatment system (or the residential or commercial property). The controller may then close or keep closed one or more valves (e.g., the valve on the inlet line and the valve on the outlet feed line) to prevent damage to one or more components of the water treatment system or to the plumbing, appliances and/or structure of the residential or commercial property. The controller may also identify which valves may be closed in the event of a leak.

FIG. 7 illustrates an operational cycle 501 according to some embodiments of the water treatment systems of FIGS. 2, 3A-3C, and 4A, 4B, and 4D. At a high level, some embodiments of the water treatment systems disclosed herein may operate according to the operational cycle 501. The operational cycle 501 may include four phases: Phase I, Phase II, Phase III, and Phase IV.

As shown in FIG. 7, the operational cycle 501 may begin at a Phase I. In Phase I, consumption of water at a point of use (POU) (not shown) such as a facet, fixture, or toilet, may commence. When water consumption commences, a change in pressure in the line going from an outlet 548 of a water treatment system 500 to the POU may cause water to flow to the POU. The pressure change may also cause untreated inlet water to enter the water treatment system through an inlet 502. The untreated inlet water may flow into a prefiltration unit 510. The prefiltration unit 510 may filter the untreated inlet water producing a prefiltered water. The prefiltered water may flow into a bottom portion of a tank 518. The flowing of the prefiltered water (denser, higher TDS water) into the bottom portion of the tank 518 may cause membrane permeate (less dense, lower TDS water) at the top portion of the tank 518 to flow out of tank. The membrane permeate flowing out of the top of the tank 518 may flow through the outlet 548 of the water treatment system toward the POU.

As the membrane permeate from the top portion of the tank 518 begins to flow out toward the outlet 548, the amount of prefiltered water entering the tank may rise, as depicted in Phase II. As the amount of prefiltered water entering the tank increases, membrane permeate may continue to flow out of the top portion of the tank 518.

When the level of prefiltered water in the tank 518 reaches a certain threshold (e.g., reaches a certain volume within the bottom portion of the tank), the pump 530 may be activated in Phase II. When the pump 530 is activated, untreated inlet water may flow into the prefiltration unit 510. The prefiltered water produced by the prefiltration unit 510 may flow toward the pump 530, rather than directly into the tank 518. The prefiltered water may then be directed toward the membrane element 534 either via pressure changes in the system or by the pump 530. The membrane element 534 may remove solutes from the prefiltered water producing a membrane permeate (water with no solutes) that may exit the membrane element 534, and a retentate (water with solutes) that may be discharged from the water treatment system via a retentate line 536. If water consumption is high, then the membrane permeate may flow directly from the membrane element 534 out of the outlet 548 to the POU, thereby bypassing the tank 518.

Otherwise, if the amount of water being consumed is not high or has stopped, then membrane permeate may flow from the membrane element 534 into the tank 518 for later use as shown in Phase III. In Phase III, once consumption of the water has ceased, the prefiltered water that had previously entered the bottom portion of the tank 518 directly from the prefiltration unit 510, may be processed by the membrane element 534. The prefiltered water may flow from the bottom portion of the tank 518 toward the pump 530 and through the membrane element 534 for processing. The membrane permeate that may be produced from the processing of the prefiltered water from the tank 518, may flow into the top portion of the tank 518 for storage, and any retentate may be discharged from the water treatment system via the retentate line 536.

Once all the prefiltered water in the tank 518 has been processed (e.g., the tank is full or mostly full of membrane permeate), the water treatment system may then move to Phase IV in the operational cycle 501. In Phase IV, the stored membrane permeate may be used to clean or flush the membrane element 534. The membrane permeate stored in the tank 518 may flow out of the tank 518, toward the membrane element 534. The pump 530 may be activated to direct the membrane permeate toward the membrane element 534 to clean the membrane element 534. In some embodiments, pressure in the various lines of the water treatment system may be sufficient to cause the membrane permeate to flow out of the tank 518 and toward the membrane element 534 to clean the membrane element 534 with the pump 530 turned off. The membrane permeate used to clean the membrane element 534 may be discharged from the water treatment system via the retentate line 536.

Once the membrane element 534 has been flushed, the water treatment system may go into a standby mode (not shown). In standby mode, none of the system components are activated. However, water may still flow through the system, between components, and/or out of the outlet 548 to a point of use. In some embodiments, water may not flow from the prefiltration unit 510 to the pump 530 or membrane element 534 when the system 500 is in standby mode.

When consumption of water commences again, the operational cycle 501 may move to Phase I.

In some instances, consumption of water may be so high that the water treatment system cannot keep up with the demand (e.g., all the membrane permeate stored in the tank is used up and the system is unable to produce more membrane permeate at a rate fast enough to keep up with consumption). In such instances, in some embodiments of the water treatment systems, inlet water may pass through the prefiltration unit into the tank and directly out of the water treatment system. The direction of water flow may be determined automatically by changes in pressure in the lines of the water treatment system without any input from the system (e.g., activating the pump or opening/closing valves). Thus, POUs of the residence or commercial property may always be receiving at least prefiltered water (e.g., water that has been filtered by a prefiltration unit such as a sediment filter, activated carbon filter, or a combination thereof), some of which may be membrane permeate. Once the water consumption decreases, the water treatment system may return to its usual operational cycle (e.g., operational cycle 501). Furthermore, more than one tank or a larger tank may be used in any of the disclosed embodiments to scale the system up if there is a high demand for membrane permeate water.

The systems and methods for extending the health and lifespan of a membrane element as described herein may be incorporated or used in any of the described systems 100, 200, and 300. The descriptions of systems and methods for extending the health and lifespan of the membrane element are exemplary and not exhaustive.

In some embodiments of any of the water treatment systems described herein, (e.g., the systems 200, 300), a membrane flush may be used to clean the membrane element 234, 334, which in turn may help extend the lifetime of the membrane element 234, 334. In some instances, the membrane flush comprises providing a high-pressure water stream to the membrane element 234, 334 via the membrane feed line 232, 332. In other instances, the membrane flush comprises providing a high flow rate water stream to the membrane element 234, 334 via the membrane feed line 232, 332. Flushing the membrane element 234, 334 can rinse away the concentrated solutions of salts that have stagnated near the surface of the membrane element and prevent the salts from forming a precipitate layer on the surface of the membrane element 234, 334.

The flush process may be carried out after each use of the membrane element 234, 334, or the flush process may be carried out on a set schedule (e.g., the flush process may be initiated at predetermined intervals, after a predetermined number of gallons or liters of water has been processed by the membrane element, and/or after a predetermined number of permeate production cycles). In addition, different types of solutions or water streams may be used when flushing the membrane element 234, 334. For example, the flush process can include or use low TDS water (e.g., prefiltered water), untreated water (e.g., inlet water), water processed by the membrane element 234, 334 (i.e., membrane permeate), prefiltered water provided with the chemical additive, and/or a water stream dosed with the chemical additive (e.g., citric acid). A membrane flush may help minimize the build-up of scale on the membrane element 234, 334 because the surface of the membrane element may not be continuously or substantially continuously exposed to high TDS water. In some instances, the membrane element 234, 334 may be flushed with low TDS water immediately after the operational cycle stops (e.g., when the membrane element 234, 334 stops producing low TDS permeate). In some instances, the membrane flush may occur when the system 200, 300 completes Phase III of the operational cycle 501, as described with reference to FIG. 7. Flushing the membrane element 234, 334 can push the water that is saturated or supersaturated with minerals away from the membrane element 234, 334 and into a retentate line 236, 336 and to the subsequent drain 241, 341. In some instances, the membrane permeate stored in the tank 218, 318 can be directed to the membrane element 234, 334 to dislodge the water that is saturated or supersaturated with minerals from the membrane element 234, 334. In some instances, flushing the membrane element 234, 334 with membrane permeate after any operational cycles may prevent the formation of mineral precipitates on the membrane element 234, 334. In some instances, flushing the membrane element 234, 334 is carried out for at least about 1 minute, or at least about 5 minutes, or at least about 10 minutes, or at least about 20 minutes, or at least about 30 minutes, or at least about 40 minutes, or at least about 60 minutes, or at least about 90 minutes. In other instances, flushing the membrane element 234, 334 is carried out for at least 1 minute, or at least 5 minutes, or at least 10 minutes, or at least 20 minutes, or at least 30 minutes, or at least 40 minutes, or at least 60 minutes, or at least 90 minutes.

In various instances, the systems and methods as described in FIGS. 1, 2, 3A-3C, and 4A-4E can include a permeate flush carried out at time intervals of at least about 30 minutes, or at least about 1 hour, or at least about 3 hours, or at least about 6 hours, at least about 12 hours, at least about 1 day, or at least about 3 days, or at least about 5 days, or at least about one week, or at least about two weeks, or at least about one month. In some instances, the systems and methods as described in FIGS. 1, 2, 3A-3C, and 4A-4E can include a permeate flush at intervals of at least 30 minutes, at least 1 hour, at least 3 hours, at least 6 hours, at least 12 hours, or at least 1 day, or at least 3 days, or at least 5 days, or at least one week, or at least two weeks, or at least one month.

In some instances, the water provided to the membrane element 234, 334 as part of the flush process may be the membrane permeate produced by the membrane element 234, 334. For example, the membrane element 234, 334 may be provided with membrane permeate as described in Phase IV of the operational cycle 501 (see FIG. 7) and further described herein.

In some instances, the retentate valve or flow restrictor tube 239, 339 may be designed to initiate a physical cleaning process of the membrane element 234, 334. The retentate valve or flow restrictor tube 239, 339 can be actuated (e.g., opened or closed, either partially or fully) to alter the amount of water flowing through the retentate line 236, 336 and, thereby, the amount of water flowing through the membrane element 234, 334. For example, the retentate valve can be opened to increase the flow rate of the retentate, thereby increasing the flow rate of water through the membrane element 234, 334. In such instances, the increased water flow through the membrane element 234, 334 may help dislodge particulates, biofilms, scale, and other materials that have accumulated within the membrane element 234, 334 and/or on the surface of the membranes of the membrane element 234, 334.

In some embodiments of the water treatment system 200, 300 a membrane element soak may be used to clean the membrane element 234, 334. In some instances, the membrane element soak comprises providing a water solution to the membrane element 234, 334 via the membrane feed line 232, 332. Such soak processes may help extend the lifespan of the membrane element 234, 334.

In some instances, flushing of the membrane element 234, 334 is carried out for at least about 1 minute to at least about 30 minutes. In other instances, flushing the membrane element 234, 334 is carried out for at least about 1 minute to at least about 1 hour, or longer. In some instances, flushing of the membrane element 234, 334 is carried out for at least 1 minute to at least 30 minutes. In other instances, flushing the membrane element 234, 334 is carried out for at least 1 minute to at least 1 hour, or longer.

Soaking the membrane element 234, 334 with water can dislodge the concentrated solutions of salts stagnated near the surface of the membrane element 234, 334, dissolve already-formed scale, and help prevent the salts from forming a precipitate layer on the surface of the membrane element 234, 334. The soaking process can utilize different types of solutions or water streams. For example, the membrane element soak may utilize low TDS water (e.g., prefiltered water), untreated water (e.g., inlet water), water processed by the membrane element 234, 334 (i.e., permeate water), prefiltered water with additive, and/or water dosed with the chemical additive (e.g., the caustic compound, the acidic compound, and/or the oxidizing compound). In some instances, the membrane element 234, 334 is soaked with low TDS water immediately after the operational cycle stops (e.g., when the membrane element 234, 334 stops producing low TDS permeate). Regardless of the water or solution used, the soaking process can remove scale and concentrated salts from the membrane element 234, 334. Then, the scale and concentrated salts can be provided to the retentate line 236, 336 and, ultimately, the drain 241, 341. Furthermore, soaking the membrane element 234, 334 can prevent formation of scale on the surface of the membrane element 234, 334.

In some instances, the soaking of the membrane element 234, 334 is carried out for at least about 5 minutes, or at least about 10 minutes, or at least about 20 minutes, or at least about 30 minutes, or at least about 40 minutes, or at least about 1 hour, or at least about 2 hours, or at least about 3 hours, or at least about 6 hours, or at least about 7 hours, or at least about 9 hours, or at least about 12 hours. In other instances, the soaking of the membrane element 234, 334 is carried out for at least 5 minutes, or at least 10 minutes, or at least 20 minutes, or at least 30 minutes, or at least 40 minutes, or at least 1 hour, or at least 2 hours, or at least 3 hours, or at least 6 hours, or at least 7 hours. In multiple instances, the soaking is carried out for at least about 3 hours to at least about 6 hours. In some instances, the soaking is carried out for at least 3 hours to at least 6 hours. In some instances, the soaking of the membrane element 234, 334 is carried out for at least about 24 hours or at least about 48 hours. In other instances, the soaking of the membrane element 234, 334 is carried out for at least 24 hours or at least 48 hours. In some instances, the soaking of the membrane element 234, 334 is carried out in between uses for at least a few days (e.g., when a user is on vacation). In various instances, the soaking of the membrane element 234, 334 is carried out for at least about 2 days, or at least about 3 days, or at least about 5 days, or at least about a week, or at least about 2 weeks, or at least about 3 weeks, or at least about 4 weeks. In various instances, the soaking of the membrane element 234, 334 is carried out for at least 2 days, or at least 3 days, or at least 5 days, or at least a week, or at least 2 weeks, or at least 3 weeks, or at least 4 weeks. Referring again to FIGS. 2-4E, in some instances, chemical agents can be introduced into the flush or rinse of the membrane element 234, 334 at the end of the operational cycle (e.g., the end of operational cycle 501) and then allowed to soak the membrane element 234, 334 during periods of inactivity.

In some instances, the chemical agent is allowed to soak the membrane element 234, 334 for at least about 1 minute, or at least about 5 minutes, or at least about 10 minutes, or at least about 20 minutes, or at least about 30 minutes, or at least about 40 minutes, or at least about 60 minutes, or at least about 90 minutes, or at least about 1 hour, or at least about 2 hours, or at least about 3 hours, or at least about 6 hours, or at least about 7 hours. In other instances, the chemical agent is allowed to soak the membrane element 234, 334 is for at least 1 minute, or at least 5 minutes, or at least 10 minutes, or at least 20 minutes, or at least 30 minutes, or at least 40 minutes, or at least 60 minutes, or at least 90 minutes, or at least 1 hour, or at least 2 hours, or at least 3 hours, or at least 6 hours, or at least 7 hours. In multiple instances, the chemical agent is allowed to soak the membrane element for at least about 3 hours to at least about 6 hours. In some instances, the chemical agent is allowed to soak the membrane element for at least 3 hours to at least 6 hours. In various instances, the chemical agent is allowed to soak the membrane element 234, 334 for at least about 24 hours or at least about 48 hours. In some instances, the chemical agent is allowed to soak the membrane element 234, 334 for at least 24 hours or at least 48 hours. In some instances, the chemical agent is allowed to soak the membrane element 234, 334 in between uses for at least a few days (e.g., when a user is on vacation). In various instances, the chemical agent is allowed to soak the membrane element 234, 334 for at least about 2 days, or at least about 3 days, or at least about 5 days, or at least about a week, or at least about 2 weeks, or at least about 3 weeks, or at least about 4 weeks. In various instances, the chemical agent is allowed to soak the membrane element 234, 334 for at least 2 days, or at least 3 days, or at least 5 days, or at least a week, or at least 2 weeks, or at least 3 weeks, or at least 4 weeks.

Soaking the membrane element 234, 334 with the chemical additive can allow a significant amount of time for chemical and/or enzymatic processes to take place. In some instances, the water treatment system 200, 300 is restarted, the pump 230, 330 turns on, and the materials that have been dissolved or dislodged from the membrane element 234, 334 and spacer are then carried out of the membrane element 234, 334 via the retentate line 236, 336 and to the subsequent drain 241, 341.

A forward membrane flush process can be used to clean the membrane element 234, 334 and help extend the lifespan of the membrane element 234, 334. The water treatment system 200, 300 may include a retentate valve (not illustrated) or a flow restrictor tube 239, 339 that is in fluid communication with the retentate line 236, 336. The retentate valve or the flow restrictor tube 239, 339 may control or regulate the amount of retentate leaving the water treatment system 200, 300 via the retentate line 236, 336 and provided to the drain 241, 341. In the forward membrane flush process, the flow of water (i.e., the retentate from the membrane element 234, 334) through the flow restrictor tube 239, 339 can be increased. Increasing the flow of water through the flow restrictor tube 239, 339 can increase the flow of water through the feed side of the membrane element 234, 334. The elevated water flow can dislodge particulates, biofilms, and scale that have collected on the feed side of the membrane element 234, 334 and within the feed spacer. The dislodged particulates, biofilms, and scale can be removed via the retentate line 236, 336 along with the retentate and provided to the subsequent drain 241, 341. In some instances, a backward membrane flush can be used in addition to or in place of the forward membrane flush. The backward membrane flush can comprise a membrane flush in which the flushing fluid flows in the opposite direction compared to fluid flow during normal operation of the membrane element 234, 334.

Elements of the water treatment system 200, 300, including the membrane element 234, 334, may be cleaned using one or more clean-in-place processes. Generally, a clean-in-place process may include the automated or semi-automated circulation of water streams or cleaning solutions (e.g., chemical additives) through the internal surfaces of system components such as the membrane element 234, 334. In addition, the clean-in-place process may not require disassembly of the membrane element 234, 334 or any other components of the system 200, 300 cleaned via the clean-in-place process.

An example clean-in-place process is provided herein. The clean-in-place process may include pre-rinsing the water filtration membrane with water to remove loose contaminants, introducing and circulating one or more chemical additives to dissolve or dislodge scaling and biofilms on or in the membrane element 234, 334, and rinsing of the membrane element 234, 334 to flush out residual chemicals and contaminants. In some cases, an additional rinse of the membrane element 234, 334 may be provided to help ensure removal the chemical additive. The clean-in-place process may enable efficient and repeatable cleaning of the membrane element 234, 334, which may help reduce system 200, 300 downtime, maintain optimal performance of the membrane element 234, 334, and extend the operational life of the membrane element 234, 334.

In various instances, the forward membrane flush process can be performed alone from time to time, or as part of a clean-in-place effort. For example, the forward membrane flush process may be used after treatment of the membrane element 234, 334 with a chemical additive (e.g., a caustic compound, an acidic compound, and/or an oxidizing compound). As an additional example, the forward membrane flush process may be performed as a physical cleaning process comprising providing permeate to the membrane element 234, 334. In some instances, in conjunction with a clean-in-place effort, the forward flush process may dislodge and remove contaminants that were partially broken down by the chemical additive. In multiple instances, the water treatment system 200, 300 may pulse the water provided in the forward flush in an on-off fashion or by using alternating periods of high-flow and low-flow operation to dislodge contaminants on the surface of the membrane element 234, 334. In certain cases, the forward membrane flush process can utilize a high-velocity water stream comprising permeate water and/or feed water to help dislodge contaminants from the surface of the membrane element 234, 334. In some instances, the high-velocity water stream may be imparted with a low pressure, although higher-pressure water streams may also be utilized. In other cases, the forward membrane flush process can be provided in the form of a pulsing water stream comprising the permeate water and/or the feed water to help dislodge contaminants from the surface of the membrane element 234, 334. In certain cases, the pulsing water stream may be imparted with a high velocity, although lower-velocity water streams may also be utilized. In some instances, in addition to the various forward flushing processes described herein, other mechanical treatments may dislodge and remove the contaminants from the membrane element 234, 334 with the retentate flow. Such mechanical treatments may include microbubbles, backward membrane flushing, and vibration of the membrane element 234, 334. In various instances, the pump 230, 330 may be designed to provide the various water streams used in the membrane flush process to the membrane element 234, 334. For example, the pump 230, 330 may be designed to provide a high-velocity water stream, a pulsed water stream, a low-flow water stream, and/or a high-flow water stream to the membrane element 234, 334. In certain cases, the fifth valve 229b, 342b may be designed to provide a high-velocity water stream, a pulsed water stream, a low-flow water stream, and/or a high-flow water stream to the membrane element 234, 334. In some cases, the high-velocity water stream, the pulsed water stream, the low-flow water stream, and/or the high-flow water stream provided to the membrane element 234, 334 by the pump 230, 330 and/or the fifth valve 229b, 342b may comprise permeate that is provided from the tank 218, 318. Additionally, the pump 230, 330 may be off while the fifth valve 229b, 342b provides the aforementioned water streams to the membrane element 234, 334, although the pump 230, 330 may also be on during the membrane flush process. It is to be understood that the pump 230, 330 and the fifth valve 229b, 342b may operate in conjunction with or independently of each other and one or more of the other valves provided in the water treatment systems 200, 300 when providing the high-velocity water stream, the pulsed water stream, the low-flow water stream, and/or the high-flow water stream to the membrane element 234, 334.

In some cases, the controller 402 may be designed to direction actuation of the pump 230, 330, and/or the fifth valve 229b, 342b to provide a permeate water stream to the membrane element 234, 334 during the clean-in-place process (or other cleaning processes). For example, the fifth valve 229b, 342b may be opened partially or fully to provide permeate from the tank 218, 318 to the membrane element 234, 334 while also turning off the pump 230, 330. It is to be appreciated that the pump 230, 330 may also be on while permeate is being provided to the membrane element 234, 334.

In some instances, the water treatment system 200, 300 may change the flow rate of the retentate (and thus the amount of retentate produced by the membrane element 234, 334) by adjusting the retentate valve or flow restrictor tube 239, 339, which controls the flow of the retentate to the drain 241, 341. In turn, adjusting the retentate flow may alter the recovery of the membrane element 234, 334, even as the membrane flux changes. Specifically, the retentate flow and the permeate flow generated by the membrane element 234, 334 are proportional; thus, a change in the retentate flow rate may affect the membrane flux. In some instances, adjusting the retentate valve or the flow restrictor tube 239, 339 may change the membrane element 234, 334 recovery, even as the water quality (e.g., the TDS level) provided to the water treatment system 200, 300 changes. For example, by adjusting the quantity of retentate flowing through the retentate valve or the flow restrictor tube 239, 339, the recovery of the membrane element 234, 334 can be reduced as the TDS content or the hardness of the inlet water increases. In other instances, by adjusting the quantity of retentate allowed to flow through the retentate line 236, 336, the recovery of the membrane element 234, 334 can be reduced when the membrane flux decreases (indicating fouling).

As the membrane flux decreases and the retentate flow is held constant, the recovery of the water treatment system 200, 300 may decrease, but in some cases, the system may be configured to increase the retentate flow and decrease the recovery even more to help keep permeate quality constant. In other instances, through use of adjusting the flow of retentate through the retentate line 236, 336, the water treatment system 200, 300 can optimize water use and decrease the quantity of retentate when the membrane flux decreases to help keep a recovery of the membrane element 234, 334 substantially constant.

In various instances, the temperature of the water within or provided to the membrane element 234, 334 can be increased using the temperature control element 280, 381 to increase the solubility of some compounds. The increased temperature may also be detrimental to biofilms. The increased temperature may speed up the reaction kinetics of chemical reactions and can be used in conjunction with chemical treatments of membrane elements 234, 334, including when chemical additives such as pH adjusting compositions, oxidizing compounds, enzymes, and/or chelating agents are used. In some instances, the temperature control element 280, 381 can be connected to the membrane feed line 232, 332 via the one or more pipes 282, 382 and heat the membrane feed line 232, 332.

In some instances, the temperature of the water within or provided to the membrane element 234, 334 can be increased using the temperature control element 280, 381 to at least about 15° C., or at least about 20° C., or at least about 25° C., or at least about 30° C., or at least about 35° C., or at least about 40° C., or at least about 45° C., or at least about 50° C., or at least about 55° C., or at least about 60° C., or at least about 65° C., or at least about 70° C., or at least about 75° C., or at least about 80° C., or at least about 85° C., or at least about 90° C., or at least about 95° C. In other instances, the temperature of the water within or provided to the membrane element 234, 334 can be increased using the temperature control element 280, 381 to at least 15° C., or at least 20° C., or at least 25° C., or at least 30° C., or at least 35° C., or at least 40° C., or at least 45° C., or at least 50° C., or at least 55° C., or at least 60° C., or at least 65° C., or at least 70° C., or at least 75° C., or at least 80° C., or at least 85° C., or at least 90° C., or at least 95° C.

In various instances, the temperature of the water within or provided to the membrane element 234, 334 can be decreased using the temperature control element 280, 381 to increase the solubility of some compounds. For example, the temperature of the water within or provided to the membrane element 234, 334 can be decreased using the temperature control element 280, 381 to no more than about 20° C., or no more than about 15° C., or no more than about 10° C., or no more than about 5° C., or no more than about 0° C. As an additional example, the temperature of the water within or provided to the membrane element 234, 334 can be decreased using the temperature control element 280, 381 to no more than 20° C., or no more than 15° C., or no more than 10° C., or no more than 5° C., or no more than 0° C.

In some embodiments, the chemical additive may be an anti-scaling agent to reduce corrosion or scale on a feed side of a membrane element. In some instances, the chemical additive may be added for the purpose of flushing, rinsing, or soaking the membrane element 234, 334 with the chemical additive. In various instances, the chemical additive may include a polyphosphate compound, a chelating agent, an acidic compound, an antiscalant compound, a caustic compound, an oxidizing compound, a prebiotic, and/or an enzymatic cleaner. For example, the chemical additive may be selected from the group consisting of a polyphosphate compound, a chelating agent, an acidic compound, an antiscalant compound, a caustic compound, an oxidizing compound, a prebiotic, an enzymatic cleaner, and combinations thereof.

The chemical additive may be added for the purpose of inhibiting scale formation. In various instances, the chemical additive can have a percent scale inhibition of at least about 40%, or at least about 50%, or at least about 60%, or at least about 70%, or at least about 80%, or at least about 90%, or at least about 95%, or at least about 100% as compared to a system in which no chemical additive is provided. In various instances, the chemical additive can have a percent scale inhibition of at least 40%, or at least 50%, or at least 60%, or at least 70%, or at least 80%, or at least 90%, or at least 95%, or at least 100% as compared to a system in which no chemical additive is provided.

The prefiltration unit 210, 310 and the feeder 228, 328 may introduce or add the chemical additive to the inlet water or the prefiltered water, respectively. For example, the feeder 228, 328 may provide the polyphosphate compound or citric acid to the water stream in the additive line 226, 326. In some instances, the addition of the chemical additive may occur after the water stream in the additive line 226, 326 has been pressurized by the pump 230, 330 (i.e., when the feeder 228, 328 is positioned downstream of the pump 230, 330). As an additional example, the prefiltration unit 210, 310 may provide the polyphosphate compound or citric acid to the water stream in the prefiltered water line 212, 312. Furthermore, in some embodiments of the system 200, 300, the chemical additive released by the prefiltration unit 210, 310 or the feeder 228, 328 may be used to maintain membrane element 234, 334 health. In some embodiments, when the prefiltered water flows through or passes the feeder 228, 328, the chemical additive may be added or introduced to the prefiltered water in the additive line 226, 326. The chemical additive may dissolve or otherwise degrade in the prefiltered water.

In some instances, the polyphosphate compound may be incorporated into a membrane flush, rinse, soak, or clean-in-place process. In various instances, the polyphosphate compound may include one or more polyphosphates. The polyphosphate compound retained within the feeder 228, 328 may include pyrophosphates, hexametaphosphate (HMP), orthophosphates, or a blend of several types of polyphosphates.

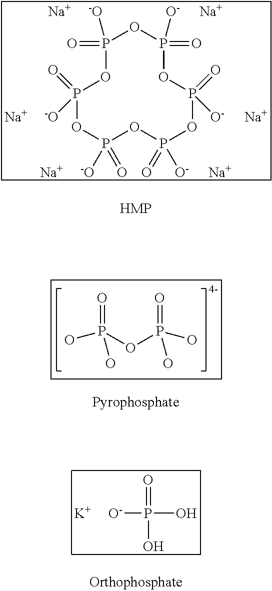

The polyphosphate compound may include crystalline pyrophosphate, metaphosphate, tripolyphosphate, glassy beaded HMP, and glassy polyphosphate blends. In some cases, other organic ions besides the polyphosphate may be used for a similar function for example polyacrylic acids, carboxylic acids, polymaleic acids, organo-phosphates, phosphonates, and anionic polymers. In some instances, the polyphosphate compound may be a blend of HMP and silicate in glassy bead form. In some instances, the polyphosphate compound is suspended in a “netting” within the feeder 228, 328 or the prefiltration unit 210, 310, the netting configured to help improve the polyphosphate's absorption into the water stream provided to the feeder 228, 328 or the prefiltration unit 210, 310. In some instances, the polyphosphate compound can tolerate temperatures up to about 90° C.

In some instances, the concentration of the polyphosphate compound provided by the feeder 228, 328 or the prefiltration unit 210, 310 imparts the water with a concentration of the polyphosphate compound of at least about 0.01 ppm to no more than about 10 ppm. In some instances, the concentration of the polyphosphate compound is at least about 1 ppm to no more than about 10 ppm. In some instances, the concentration of the polyphosphate compound is at least about 2 ppm to no more than about 5 ppm. In some instances, the concentration of the polyphosphate compound is at least about 0.01 ppm, or at least about 0.1 ppm, or at least about 0.25 ppm, or at least about 0.5 ppm, or at least about 1 ppm, or at least about 5 ppm, or at least about 9 ppm.

In some instances, the concentration of the polyphosphate compound provided by the feeder 228, 328 or the prefiltration unit 210, 310 imparts the water with a concentration of the polyphosphate compound of at least 0.01 ppm to no more than 10 ppm. In some instances, the concentration of the polyphosphate compound is at least 1 ppm to no more than about 10 ppm. In some instances, the concentration of the polyphosphate compound is at least 2 ppm to no more than 5 ppm. In some instances, the concentration of the polyphosphate compound is at least 0.01 ppm, or at least 0.1 ppm, or at least 0.25 ppm, or at least 0.5 ppm, or at least 1 ppm, or at least 5 ppm, or at least 9 ppm.

In some instances, the polyphosphate compound may control or impede scale formation on the surface of the membrane element 234, 334 when the water provided to the membrane element 234, 334 is imparted with a hardness value of over about 85 mg/L, or over about 170 mg/L, or over about 340 mg/L, or over about 510 mg/L. In some instances, the polyphosphate compound can impede or control scale formation in water imparted with a hardness value of over 85 mg/L, or over 170 mg/L, or over 340 mg/L, or over 510 mg/L. In various instances, the polyphosphate compound can help control scale formation on the surface of the membrane element 234, 334 at a concentration of less than about 1 ppm, and in water imparted with a hardness value of over about 510 mg/L. In various instances, the polyphosphate compound prevents scale at a concentration of less than 1 ppm, and in water imparted with a hardness value of over 510 mg/L.

In some instances, the polyphosphate introduced into the membrane element system may inhibit CaCO₃ scale formation according to the method TM0374-2016-G by at least about 20%, or at least about 30%, or at least about 40%, or at least about 50%, or at least about 60%, or at least about 70%, or at least about 80%, or at least about 90%, or at least about 100%.

In some instances, the polyphosphate introduced into the membrane element system may inhibit CaCO₃ scale formation according to the method TM0374-2016-G by at least 20%, or at least 30%, or at least 40%, or at least 50%, or at least 60%, or at least 70%, or at least 80%, or at least 90%, and at least 100%.

In some instances, the polyphosphate compound may be introduced into the water stream ahead of the membrane element 234, 334 via the feeder 228, 328 or the prefiltration unit 210, 310. Imparting the water provided to the membrane element 234, 334 with a polyphosphate compound can help sequester divalent ions and prevent the ions from precipitating on the membrane element 234, 334 as scale, allowing the polyphosphate to function similarly to a chelating agent The ions sequestered by the polyphosphate compound can be carried out with the retentate stream in the retentate line 236, 336 and to the drain 241, 341. In addition, the polyphosphate compound can interfere with scale formation. Water imparted with a polyphosphate compound concentration of less than about 1 ppm (e.g., less than about 0.1 ppm, or less than about 0.01 ppm) may help prevent scale from forming thermodynamically stable solids on the surface of the membrane element 234, 334. Thermodynamically stable solids (e.g., crystalline structures of minerals) are harder to remove from the membrane element 234, 334 than amorphous mineral material. Therefore, preventing formation of thermodynamically stable solids can help improve the performance and extend the lifetime of the membrane element 234, 334.

In some instances, instead of using the feeder 228, 328 or the prefiltration unit 210, 310 to introduce the polyphosphate compound to their respective water streams, the water treatment system 200, 300 may introduce the polyphosphate compound into the rinse water at other locations. In each case, the polyphosphate may be introduced to the water stream using a feeder, a cartridge, or another appropriate dosing mechanism. In some instances, the polyphosphate compound may be introduced to the inlet water by the addition of the polyphosphate to the inlet line 204, 304, and/or to the prefiltered water in the prefiltered water line 212. In other instances, the polyphosphate compound may be introduced to the permeate water of the permeate flush line 252, 352. In some instances, the water treatment system 200, 300 may introduce the polyphosphate compound into only the rinse water (i.e., water used to rinse the membrane element 234, 334). In some instances, the water treatment system 200, 300 may be configured to add the polyphosphate to the rinse water and the inlet water, wherein a higher concentration of polyphosphate is added to the rinse water than compared to the inlet water.

In some instances, a chelating agent may be incorporated into a membrane flush, rinse, soak, or clean-in-place process. In various instances, the chelating agents can include citric acid, ethylenediaminetetraacetic acid (EDTA) sodium gluconate, sodium galactarate, sodium citrate, and N-(2-Hydroxyethyl)ethylenediaminetriacetic acid (HEDTA). In some instances, the chelating agents may be provided as an acid or as a salt (e.g., sodium or potassium salts). The ability of the chelating agent to bind with dissolved cations can increase the dissolution of scale on the membrane element 234, 334 by reducing the concentration of ions in solution. In some instances, using a chelating agent at an optimal pH to ensure that the chelating agent is in its most effective form may be beneficial. The optimal pH may depend on the target ion as well as the identity of the chelating agent. The chelating agent may also be introduced into the flush water to contact the membrane element 234, 334 during periods of inactivity. In some instances, the chelating agent may be used to soak the membrane element 234, 334.

In some instances, the acidic compound may be incorporated into a membrane flush, rinse, soak, or clean-in-place process. In some instances, the acidic compound may be provided as citric acid, acetic acid, sulfuric acid, phosphoric acid, hydrochloric acid, fumaric acid, lactic acid, malic acid, nitric acid, methanesulfonic acid, hydrofluoric acid, tartaric acid, and combinations thereof. The acidic compound can include citric acid. In various cases, citric acid may be added into the prefiltered water via the feeder 228, 328 and the additive line 226, 326 to be provided to the membrane element 234, 334 to help increase the lifetime of the membrane element 234, 334. In other cases, the citric acid is added to the inlet water provided to the prefiltration unit 210, 310.

It may be beneficial to add the acidic compound (e.g., citric acid) upstream of the membrane element 234, 334 (e.g., via the feeder 228, 328) to reduce the pH value of the water provided to the membrane element 234, 334. In various instances, imparting the water provided to the membrane element 234, 334 with a lower pH value may increase the solubility of scale-forming minerals, e.g., calcium carbonate, magnesium carbonate, and calcium phosphate. In some instances, the acidic compound imparts the water provided to the membrane element with a pH value of no more than about 2, or no more than about 3, or no more than about 4, or no more than about 5, or no more than about 6, or no more than about 7, or no more than about 7.5.

In some instances, the acidic compound imparts the water provided to the membrane element with a pH value of no more than 2, or no more than 3, or no more than 4, or no more than 5, or no more than 6, or no more than 7, or no more than 7.5.

In some instances, the acidic compound may be stored in the feeder 228, 328 and introduced into the feed water through the additive line 226, 326 and to the membrane feed line 232. The acidic compound may be introduced during the reverse osmosis process, lowering the pH of the water being treated, and reducing the potential for many ions to form scale on the surface of the membrane element 234, 334.

In some instances, a reduction in pH value of the water or solution in the membrane feed line 232 by at least about 0.5 may increase the solubility of scale-forming compounds significantly and thus reduce scale formation on the surface of the membrane element 234, 334. In some instances, reducing the pH value by at least about 0.5, or by at least about 1, or by at least about 2, or by at least about 3, or by at least about 4, or by at least about 5 may increase the solubility of the scale-forming compounds significantly and thus reduce scale formation. In some instances, reducing the pH value by at least 0.5, or by at least 1, or by at least 2, or by at least 3, or by at least 4, or by at least 5 may increase the solubility of the scale-forming compounds significantly and thus reduce scale formation.

In various instances, a clean-in-place process may be applied where the acid compound may be introduced into the membrane flush or to the rinse water introduced to the membrane element 234, 334 after the reverse osmosis cycle has been stopped. By introducing the acid compound into the permeate flush instead of the feed water, less acid may be used when cleaning the membrane element 234, 334. Furthermore, the pH value of a low TDS water (e.g., the permeate flush) is easier to change. In some instances, the acidic compound in the membrane flush may be introduced directly to the membrane element 234, 334. In some instances, the acidic compound is directed from a dosing tank (not shown) through a dosing conduit (not shown) to the membrane element 234, 334.

A membrane flush imparted with a low pH value may increase the solubility of any minerals that have not already precipitated on the membrane element 234, 334 and may redissolve any scale that has formed on the surface of the membrane element 234, 334. In some instances, the acidic flush water may be used to soak the membrane element 234, 334 when the water treatment system 200, 300 is inactive (e.g., when the system 200, 300 is in the standby mode). Soaking the membrane element 234, 334 with the acidic flush water when the system is inactive may allow significant time for the dissolution of any scale present into the acidic water.

In some instances, the water treatment system 200, 300 may flush the water imparted with a low pH value out of the membrane element 234, 334 prior to the water treatment system 200, 300 going into standby mode to help ensure that water sitting against the membrane element 234, 334 is imparted with a more neutral pH. Minerals can slowly permeate across the membrane element 234, 334 during periods of inactivity and is known as “TDS creep”. In some instances, TDS creep can reduce the stress on the membrane element 234, 334, prevent the membrane element 234, 334 from becoming acidified, or allow the acid to slowly permeate across the membrane element 234, 334, thereby lowering the pH of the permeate water.

In various instances, increasing the temperature of the water and/or acidic flush can increase the solubility of the minerals and the dissolution kinetics, which in turn enhances the scale cleaning capabilities of the water and acidic flush. In addition, increasing the temperature of the water and the acidic flush can also help remove or dislodge other materials from the membrane element 234, 334, including organic and bioorganic materials. In various instances, the temperature of the water within the membrane feed line 232, 332 can be increased using the temperature control element 280, 381 in order to increase the solubility of some compounds and speed the kinetics of chemical reactions.

In some instances, the temperature of the water or the acidic flush used when cleaning the membrane element 234, 334 may be increased or decreased, which in turn may improve the cleaning ability of the water and the acidic flush cycle. Some salts can have a higher solubility at increased temperatures, and the increased temperature can also lead to increased kinetics. Other salts (e.g., carbonate salts) may not show improved solubility at increased temperatures. In such instances, the system 200, 300 may be configured to lower the temperature of the water stream provided to the membrane element 234, 334 to help dislodge carbonate species from the membrane surface. In various instances, a pH probe can be integrated for monitoring and regulating the use of acids in cleaning the membrane.

In some instances, antiscalant compounds can be incorporated into a membrane flush, rinse, soak, or clean-in-place process. In some instances, the antiscalant compounds can be added using the feeder 228, 328 to the additive line 226, 326 and may flow through the membrane feed line 232, 332 to the membrane element 234, 334. In some instances, the antiscalant compounds can include water-soluble caseins, alginic acids such as sodium alginate (i.e., extracts of algae), natural celluloses (e.g., Inulin), sulfonated polysaccharides (e.g., carrageenan), pectin, flavonoids, phytochemicals, polymers of maleic or acrylic acid, and edible polymers. In multiple instances, the antiscalant compounds can be used to prevent scaling similarly to the use of the polyphosphate as described previously.

In various instances, a caustic compound can be incorporated into a membrane flush, rinse, soak, or clean-in-place process. In some instances, the caustic compound can be added using the feeder 228, 328 to the additive line 226, 326 and may flow through the membrane feed line 232, 332 to the membrane element 234, 334. The caustic compound can include sodium hydroxide, potassium hydroxide, sodium carbonate, or another alkalinity source. The caustic compound can increase the pH value of the water, thereby causing the water to be imparted with an alkaline pH value. Typically, organic matter can be difficult to remove from the surface of the membrane element 234, 334 and the organic matter can reduce the membrane flux. The caustic compounds can be especially effective for removing biological matter, including by way of example biofilm growth and dissolved organic matter found in surface water sources (e.g., tannin and lignin). Thus, treating the membrane element 234, 334 with water imparted with an alkaline pH value can help break down and dislodge organic material from the membrane surface, thereby allowing the organic material to be flushed away with the retentate. Removing the organic matter from the surface of the membrane element 234, 334 can help restore the high flux of the membrane element 234, 334. In some instances, a pH probe can be integrated into the system 200, 300 and may be disposed at various points in the water treatment system 200, 300 to monitor and regulate the use of caustic compounds in cleaning the membrane. For example, the pH probe could be provided in any location where the sensors 206, 214, 216, 222, 306, 314, 316, 322 may be positioned in the system 200, 300. As an additional example, the pH probe could be provided adjacent or proximate to any of the sensors 206, 214, 216, 306, 314, 316.

In some instances, an oxidizing compound can be incorporated into a membrane flush, rinse, soak, or clean-in-place process. In some instances, the oxidizing compound can be added using the feeder 228, 328 to the additive line 226, 326 and may flow through the membrane feed line 232, 332 to the membrane element 234, 334. The oxidizing compound can include chemicals such as chlorine (e.g., hypochlorite ions, hypochlorous acid), ozone, peroxides, nitric acid, permanganate compounds, or potassium chlorate. Use of oxidizing compounds with polyamide nanofiltration and RO membranes should be monitored, since the membrane selective layer is sensitive to oxidation. In some instances, a sensor such as an oxidation reduction potential (ORP) probe can be incorporated into the system 200, 300 and may be disposed at various points in the water treatment system 200, 300 to monitor or regulate the use of oxidizing compounds. For example, the ORP probe may be provided in any location where the sensors 206, 214, 216, 222, 306, 314, 316, 322 may be positioned in the system 200, 300. As an additional example, the ORP probe may be provided adjacent or proximate to any of the sensors 206, 214, 216, 222, 306, 314, 316, 322.

In some instances, the prebiotic can be incorporated into a membrane flush, rinse, soak, or clean-in-place process. For example, in some instances, the prebiotic can be added using the feeder 228, 328 to the additive line 226, 326 and may flow through the membrane feed line 232, 332 to the membrane element 234, 334. The prebiotic may include a dose of microorganisms and associated nutrients to establish a favorable microflora that may prevent the establishment of destructive biofilms on the membrane element 234, 334. In some instances, the prebiotic can break down established biofilms. In various instances, the selected prebiotic can have a limited effect on the membrane flux. The prebiotic may include various microorganism species that can secrete, by way of example, nitrogen oxide (NO), hydrogen peroxide, lactic acid, and/or bacteriocins, which may prevent the establishment of biofilms or degrade biofilms present on the membrane element 234, 334. In some cases, the microorganism can belong to, for example, genera Lactobacillus, Bifidobacterium, or any other suitable species or genus.

In some instances, an enzyme cleaner can be incorporated into a membrane flush, rinse, soak, or clean-in-place process. In some instances, the enzyme cleaner can be added using the feeder 228, 328 to the additive line 226, 326 and may flow through the membrane feed line 232, 332 to the membrane element 234, 334. Enzyme cleaners can be used to break down organic material that may reduce membrane flux. The enzyme cleaner can include proteases, lipases, amylases, or other enzymes with similar characteristics and functionalities. In some instances, the enzyme cleaner can be introduced during the flush or rinse processes, or the enzyme cleaner can be dosed into the inlet water periodically. After the enzyme cleaner has broken down the organic materials into more soluble compounds, those organic materials can be flushed out of the membrane element 234, 334 along with the retentate.

In various instances, other chemical additives can be used to clean the membrane element 234, 334, including commercial or proprietary cleaners. In some instances, the other chemical additives can be added using the feeder 228, 328 to the additive line 226, 326 and flow through the membrane feed line 232, 332 to the membrane element 234, 334. In some instances, the other chemical additives can include Kleen MCT, KyperSperse MDC/MSI, AMI cleaners, AWC chemical solutions, PermaClean solutions, Nalco solutions, Vitec™ antiscalants, RoQuest™, RoCide™, and RoClean™. Detergents can also be used to clean the membrane element, remove contaminants, and dissolve organic matter. In some instances, detergents can be more effective when combined with caustic compounds or oxidizing compounds. In some instances, sanitizing agents can kill biofilms present on membranes and can work with chemical additives (e.g., caustic compounds) to remove the biofilms from the membrane surfaces and spacers.

In various instances, the water treatment system 200, 300 may utilize a cleaning cycle that is executed at fixed, predetermined times of day and/or at predefined intervals (e.g., after a defined number of operational cycles). The cleaning cycle may include any of the physical or chemical cleaning methods as described herein. In some instances, the predefined intervals may be no more than about 30 minutes, or no more than about 1 hour, or no more than about 3 hours, or no more than about 6 hours, or no more than about 12 hours, or no more than about 1 day, or no more than about a week, or no more than about a month. In some instances, the predefined intervals may be no more than 30 minutes, or no more than 1 hour, or no more than 3 hours, or no more than 6 hours, or no more than 12 hours, or no more than 1 day, or no more than weekly, or no more than monthly. In some instances, the predefined intervals may be after at least every operational cycle, or at least after every 2 operational cycles, or at least after every 3 operational cycles, or at least after every 5 operational cycles, or at least after every 10 operational cycles, or at least after every 15 operational cycles of the system 200, 300.

In some instances, the cleaning cycle may occur at nighttime when water use is low, such that the chemical additive may soak the membrane element 234, 334 for a longer period compared to daytime settings before the water treatment system 200, 300 returns to use. In some instances, multiple cleaning programs or methods may be implemented, for example running an acid rinse after one cycle, a first chemical additive rinse after another cycle, and a second chemical additive rinse after a further cycle. In some instances, it may be necessary to run multiple cleaning programs or methods, for example running an acid rinse after one cycle, a caustic compound rinse after another cycle, and/or an oxidizing compound rinse after another additional cycle. The ratio, selection, and frequency of running multiple cleaning programs may be determined manually, determined by the control system 400, based upon membrane flux, varied depending on test results of the water supply (e.g., increased TDS content of the water supply), and/or based upon a municipal water report or regional water chemistry.

Since membrane stagnation is a risk factor for reducing the total lifetime of the membrane element 234, 334, in some instances, the water treatment system 200, 300 may run in vacation mode wherein when the membrane is stagnant for a given period of time, a membrane flush cycle is initiated. The flush cycle can comprise flushing the membrane element 234, 334 with permeate water or water provided with the chemical additive.

In some instances, the flush cycle of the membrane element 234, 334 may be carried out for at least about 1 minute, or at least about 5 minutes, or at least about 10 minutes, or at least about 20 minutes, or at least about 30 minutes, or at least about 40 minutes, or at least about 60 minutes, or at least about 90 minutes. In other instances, the flush cycle of the membrane element 234, 334 may be carried out for at least 1 minute, or at least 5 minutes, or at least 10 minutes, or at least 20 minutes, or at least 30 minutes, or at least 40 minutes, or at least 60 minutes, or at least 90 minutes.

The control system 400 as described in FIGS. 1-5 may activate the cleaning cycle if the water treatment system 200, 300 is stagnant for a predetermined amount of time. In some instances, vacation mode may be initiated using a remote device (e.g., a user can use a cell phone to trigger vacation mode). In some instances, the vacation mode and subsequent permeate flush cycle may be triggered by a period of stagnancy lasting at least about 12 hours, or at least about 18 hours, or at least about 24 hours, or at least about 36 hours, or at least about 48 hours, or at least about 72 hours. In some instances, the vacation mode and subsequent permeate flush cycle can be triggered by a period of stagnancy lasting at least 12 hours, or at least 18 hours, or at least 24 hours, or at least 36 hours, or at least 48 hours, or at least 72 hours.

Eventually, membrane fouling may cause the need for membrane element replacement; however, the systems and methods as described herein may be configured to extend the membrane element lifetime. In various instances, the membrane element lifetime can be extended by at least about 1 month, or at least about 2 months, or at least about 3 months, or at least about 6 months, or at least about 1 year, or at least about 2 years, or at least about 4 years, or at least about 5 years, or at least about 10 years. In various instances, the membrane element lifetime is extended by at least 1 month, or at least 2 months, or at least 3 months, or at least 6 months, or at least 1 year, or at least 2 years, or at least 4 years, or at least 5 years, or at least 10 years.

The reverse osmosis process may remove ions, TDS, unwanted particles, micropollutants, bacteria, viruses, and other contaminants using pressure to force the untreated water through a partially permeable water filtration membrane. As the untreated water is passed through the partially permeable membrane, the ions, TDS, unwanted particles, micropollutants, bacteria, viruses, and other contaminants may be trapped by the RO membrane and the resulting water that passes through the RO membrane may be free or substantially free of the various contaminants. During the reverse osmosis process, the pump 230, 330 located on a feed side of the membrane element 234, 334 may be used to direct the prefiltered water toward the membrane element 234, 334. The membrane element 234, 334 may further filter the prefiltered water to remove hardness minerals and other impurities.

In some embodiments, when the pump 230, 330 is activated, the pump 230, 330 may increase the rate at which water flows into the membrane feed line 232, 332 toward the membrane element 234, 334. Increasing the flow rate of water into the membrane feed line 232, 332 may increase pressure in the membrane feed line 232, 332. The increased pressure, in turn, may aid in pushing solvent in the membrane feed line 232, 332 through the pores formed within the surface of the membrane retained within the membrane element 234, 334.

In order to monitor the health of the membrane element, diagnostic testing can be employed to determine when the membrane element needs to be replaced or when to initiate membrane flush, forward membrane flush, clean-in-place, or soaking of the membrane element 234, 334 in permeate water and/or water dosed with the chemical additive. There are multiple ways to monitor the health of the membrane element. In some cases, the flux across the membrane can be monitored by measuring the permeate flow out of the membrane element 234, 334, such as by using the flowmeters 208b, 214c, 314a, 314b.

Measurement of the permeate flow, in conjunction with a measurement of the pressure of the water provided to the membrane element 234, 334 may allow for determination of the membrane flux. In some instances, the membrane flux of a membrane element (e.g., the membrane elements 234, 334) may be determined when the membrane element 234, 334 is installed in the system 200, 300. In other instances, the user can provide an initial flux value to the control system 400. Over time, the determined membrane flux may not only change as the quality of the water being treated changes, but also as the membrane element 234, 334 becomes fouled or scaled. In some instances, if the determined membrane flux has decreased by at least about 25% from the initial flux value, or at least about 30% from the initial flux value, or at least about 35% from the initial flux value, or at least about 40% from the initial flux value, or at least about 45% from the initial flux value, or at least about 50% from the initial flux value, or at least about 55% from the initial flux value, or at least about 60% from the initial flux value, or at least about 65% from the initial flux value, or at least about 70% from the initial flux value, or at least about 75% from the initial flux value, a clean-in-place process or another cleaning process can be initiated. In other instances, if the determined membrane flux has decreased by at least 25% from the initial flux value, or at least 30% from the initial flux value, or at least 35% from the initial flux value, or at least 40% from the initial flux value, or at least 45% from the initial flux value, or at least 50% from the initial flux value, or at least 55% from the initial flux value, or at least 60% from the initial flux value, or at least 65% from the initial flux value, or at least 70% from the initial flux value, or at least 75% from the initial flux value, a clean-in-place process or another cleaning process can be initiated. In some instances, the clean-in-place process may be initiated when the determined membrane flux has decreased by somewhat smaller or even larger values than those recited herein.

Measuring parameters of the inlet water may also be utilized to determine when membrane cleaning should commence and what membrane cleaning processes should be initiated. In some instances, the feed pressure of the water stream provided to the membrane element 234, 334 can be monitored by pressure sensors 206a, 306a and analyzed by the control system 400 using a pump curve to estimate the membrane productivity. The feed water pressure can change during the RO generation cycle, as the membrane flux can be higher when treating water with low dissolved solids than when treating water with higher dissolved solids. Therefore, when the system begins a water purification cycle and turns on the pump 230, 330, the pressure as measured by pressure sensors 206a, 306a can be lower than the pressure may be later in the purification cycle when the membrane is processing the incoming feed water with a higher dissolved mineral content. As a result, there is a benefit of increased energy efficiency.

In various instances, once the higher mineral content water in the tank has been processed through the membrane element and the pump 230, 330 has begun to draw already processed water back into the membrane element 234, 334, the pressure at the membrane feed can drop. This drop in pressure can be used to alert the system that the water processing step is complete, and the pump 230, 330 can be turned off. In some instances, the determined pressure curve during the processing cycle can be used to the determine health or remaining lifetime of the membrane element 234, 334 and possible fouling of the membrane element 234, 334. The pressure at the membrane element 234, 334 during the processing of clean or low TDS water may also be used to determine the degree of contamination of the membrane surface and thus the loss of membrane flux.

In various cases, the determined pressure curve, along with the outlet flow measured to the home or end user can be used to measure an output of the membrane element 234, 334, since the length of time of the a use cycle can be compared to the volume of the tank 218, 318 and the flow of water through the outlet 248, 348. Therefore, the average output of the membrane element 234, 334 can be determined by a simple mass balance.

In another instance, a life or a health of the membrane element 234, 334 can be monitored by determining the membrane rejection and/or the proportion of salt that passes through the membrane element 234, 334. Measuring membrane rejection and/or the salt passage rate may include measuring the TDS concentration of the inlet water and comparing the measured TDS concentration of the inlet water to the TDS concentration of the permeate. In some instances, when the salt passage increases by about 50% to about 100% from an initial value (or when the membrane rejection drops below about 60% to about 95%, or below about 70% to about 90%, or below about 80% to about 90%), the membrane element 234, 334 may need to be flushed or otherwise cleaned. For example, the initial value of salt passage through an RO membrane can be about 5%, and a measured value of salt passage of about 7.5% or about 10% may indicate that the RO membrane needs cleaning. As an additional example, the initial value of salt passage through an NF membrane can be about 20%, and a measured value of salt passage of about 30% or about 40% may indicate that the NF membrane needs cleaning. After cleaning, if the flux is still high while the salt passage has increased by at least about 50% to at least about 100% of the initial value (or when the membrane rejection drops below about 60% to about 95%, or below about 70% to about 90%, or below about 80% to about 90%), the membrane element 234, 334 may be damaged and in need of replacement.

In certain instances, an increase in a salt passage through a membrane element 234, 334 of at least about 25% to at least about 100% (or at least about 25% to at least about 100%), or more, may indicate that the membrane element 234, 334 needs cleaning. For example, an increase in a salt passage through a membrane element 234, 334 of at least about 25%, or at least about 30%, or at least about 35%, or at least about 40%, or at least about 45%, or at least about 50%, or at least about 55%, or at least about 60%, or at least about 65%, or at least about 70%, or at least about 75%, or at least about 80%, or at least about 85%, or at least about 90%, or at least about 95%, or at least about 100% may indicate that the membrane element 234, 334 needs cleaning. As an additional example, an increase in a salt passage through a membrane element 234, 334 of at least 25%, or at least 30%, or at least 35%, or at least 40%, or at least 45%, or at least 50%, or at least 55%, or at least 60%, or at least 65%, or at least 70%, or at least 75%, or at least 80%, or at least 85%, or at least 90%, or at least 95%, or at least 100% may indicate that the membrane element 234, 334 needs cleaning.

In certain instances, when the membrane rejection of the membrane element 234, 334 has fallen below about 90% (or 90%), the membrane element 234, 334 may need cleaning. For example, if the membrane rejection of the membrane element 234, 334 is imparted with a value of no more than about 92%, or no more than about 90%, or no more than about 88%, or no more than about 85%, or no more than about 80%, or no more than about 75%, or no more than about 70%, or no more than about 65%, or no more than about 60%, or no more than about 50%, the membrane element 234, 334 may need cleaning. As an additional example, if the membrane rejection of the membrane element 234, 334 is imparted with a value of no more than 92%, or no more than 90%, or no more than 88%, or no more than 85%, or no more than 80%, or no more than 75%, or no more than 70%, or no more than 65%, or no more than 60%, or no more than about 50%, the membrane element 234, 334 may need cleaning.

In various instances, Residence Time Distribution (RTD) testing can be used as a diagnostic tool to monitor a remaining life and/or the performance of the membrane element 234, 334. During RTD testing, a chemical tracer may be provided to the incoming water flow from the feeder 228, 328 or to any of the conduits upstream of the membrane element 234, 334, including the prefiltered water line 212, 312, the additive line 226, 326, or the inlet line 204, 304. The retentate may then be monitored to determine when the chemical tracer elutes from the membrane element 234, 334. In some instances, provided that the inlet water has a relatively low content of other dissolved solids, the chemical tracer may comprise a pulse of a dissolved salt (e.g., sodium chloride) and the retentate water can be monitored with a TDS meter (e.g., the one or more TDS sensors 216, 316b), or a dissolved solids meter. In various instances, the RTD testing can be incorporated into the permeate flush cycle, such that water imparted with a low TDS concentration that is provided from the tank 218, 318 can be introduced into the membrane element 234, 334. In certain instances, pulse spread or change in elution time may be a function of a size of the membrane element 234, 334 and/or a size of the overall system 200, 300.

In some instances, various parameters of the membrane element 234, 334 can be determined by comparing the feed and/or inlet pulse of the chemical tracer to the time and/or shape of the concentrate curve once the chemical tracer elutes, as compared to the permeate curve of the chemical tracer. The parameters determined may include the mean residence time, the variance, the feed volume, the dead volume, and the membrane rejection. The values of these parameters may be used to determine conditions negatively impacting membrane health, including feed channel narrowing, uneven flow distribution in the membrane element 234, 334, and membrane fouling.

In some cases, the RTD testing can use a photoreactive chemical or dye as the chemical tracer instead of a dissolved salt. A photoelectric cell may be used to measure the concentrate curves and, in some instances, could be positioned within or coupled to the membrane permeate line 238, 338. In some instances, using a photoelectric cell can allow for measurement of the chemical tracer independently of other dissolved minerals, and the photoelectric cell can measure the concentrate curves with higher accuracy compared to chemical tracers provided as salts.

In other embodiments, one or more pH sensors may be coupled to or in fluid communication with the inlet line 204, 304 and the outlet feed line 246, 346 in order to measure the differences in pH of the water entering and exiting the water treatment system 200, 300. In various embodiments, the pH sensor can be coupled to or in fluid communication with the feeder 228, 328 and/or positioned proximate to the membrane element 234, 334 to monitor the change in pH value of the water in the retentate line 236, 336 or the membrane permeate line 238, 338 after the chemical additive is introduced. Certain parameters or conditions selected by the user or the control system 400 may trigger the water treatment system to start and stop an operational cycle of the water treatment system to improve the quality of the water in the tank 218, 318.

As described with reference to the water treatment systems 200, 300 (see FIGS. 2, 3A-3C, and 4A-4E), in some instances the chemical additive introduced by the feeder 228, 328 may include glassy beaded HMP, a blend of HMP and silicate in glassy form, and/or a blend of polyphosphates.

Various polyphosphates can have different dissolution rates. All the polyphosphate compounds are highly soluble in water, but the rate at which they dissolve can be at least partially dependent on their form, molecular weight, and binder matrix. For example, after an overnight dwell in 1 L of deionized water, using 10 grams each of glassy beaded HMP, a blend of HMP and silicate in glassy bead form, and blend of polyphosphates, the solutions had a solubility of 20 mg/L, 200 mg/L and >10000 mg/L total phosphate respectively.

Furthermore, membrane elements that separate and concentrate salts in water can cause reversible and irreversible precipitation or fouling of a surface of the membrane element 234, 334. The layer of precipitate can the block flow of water through the membrane element 234, 334, which can reduce permeate flow. Reversible precipitation can be removed using some of the techniques described herein including flushing, rinsing, or soaking the membrane element with permeate water, low TDS water, and/or chemical additives. In some instances, when operating the membrane element at high recovery (e.g., 80%), the likelihood of membrane element precipitation reducing permeate flow is higher since the concentration of salts adjacent to the membrane is higher.

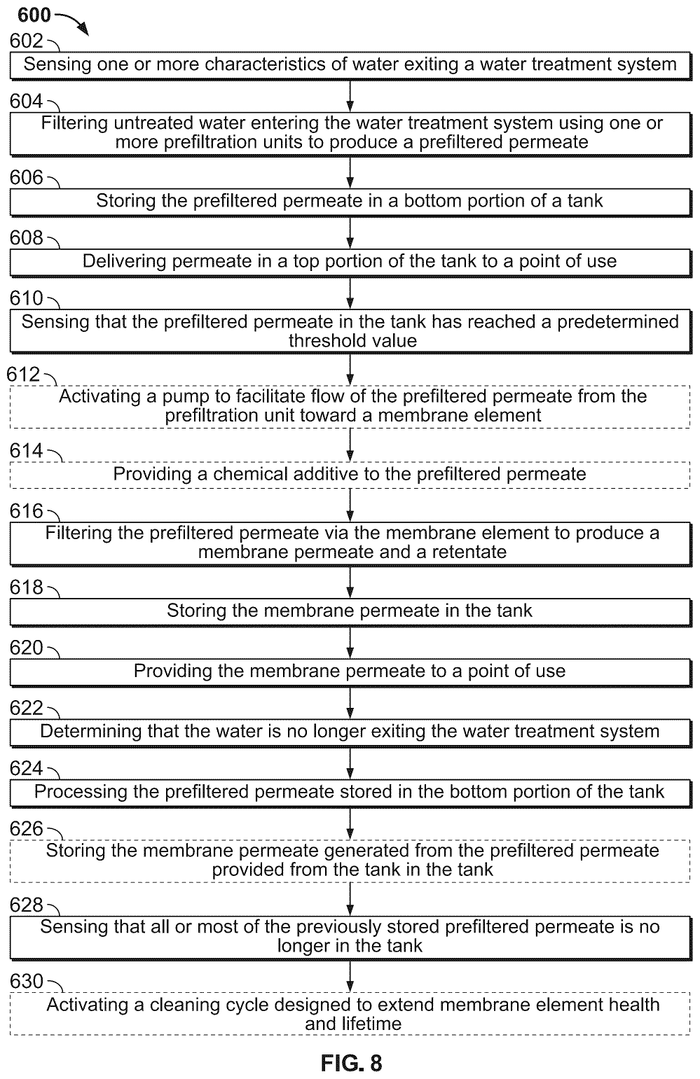

FIG. 8 is a flowchart of an embodiment of a method of treating water 600 using the water treatment systems of FIGS. 1, 2, 3A-3C, and 4A, 4B, and 4D. The method may begin at a step 602. At the step 602, the water treatment system may use one or more sensors to sense one or more characteristics of water exiting the water treatment system through an outlet of the water treatment system. The water may be exiting through the outlet in response to water being consumed at a point of use (POU). In some embodiments, the one or more sensors may be a pressure sensor, a TDS sensor, a flowmeter, or a combination thereof. Thus, the one or more characteristics may be a pressure value, a flow rate, a conductivity value, a total dissolved solids concentration, and/or other quantifiable or measurable characteristics of the water exiting through the outlet. For example, the one or more characteristics sensed or measured by the one or more sensors may be selected from the group consisting of a pressure value, a flow rate, a conductivity value, a total dissolved solids concentration, and combinations thereof.

At a step 604, inlet water, which may be untreated water (e.g., hard water), may enter the water treatment system via an inlet. The inlet water may be untreated water from an external source such as a municipal water source or a well. The inlet water may enter the water treatment system in response to a change in pressure in the water treatment system due to water exiting the water treatment system through the outlet and/or through the activation of a pump provided with the system. Additionally, or alternatively, one or more valves in the water treatment system may be opened or closed by a controller to enable the inlet water to enter the water treatment system via the inlet. The inlet water may flow from the inlet to a prefiltration unit where the inlet water may be filtered. The prefiltration unit may filter the inlet water via one or more filter elements, producing a prefiltered water that may flow out of the prefiltration unit.

At a step 606, the prefiltered water, or a portion thereof, may flow into a bottom portion of a tank. The tank may also store an amount of membrane permeate in a top portion of the tank. The prefiltered water, or a portion thereof, may optionally be stored in the tank.

At a step 608, the prefiltered water flowing into the bottom of the tank may push or force any membrane permeate stored in the top portion of the tank out of the tank. As such, the membrane permeate may flow towards the outlet of the water treatment system (and thus toward the POU).

At a step 610, one or more sensors of the water treatment system may sense that the prefiltered water or the membrane permeate that may be stored in the tank has reached a predetermined threshold value. The predetermined threshold value may be a value corresponding to a certain volume of prefiltered water in the tank and/or a certain volume of membrane permeate in the tank. The predetermined threshold value may also be a value corresponding to a certain level of TDS in the water stored in the tank or exiting the tank. The predetermined threshold value may be calculated using measurements from one or more TDS sensors or pressure sensors disposed in the tank or on a line in fluid communication with the tank. The predetermined threshold value may also be calculated using measurements from one or more flowmeters disposed on a line in fluid communication with the tank.

At a step 612, a pump in the water treatment system may be activated via the controller in response to the prefiltered water and/or the membrane permeate reaching the predetermined threshold value. Upon activation of the pump, prefiltered water may flow from the prefiltration unit toward a membrane element, rather than directly into the tank. Additionally, or alternatively, one or more valves in the water treatment system may be opened or closed by the controller to enable the prefiltered water to flow toward the membrane element with or without activation of the pump.

At a step 614, a chemical additive may be optionally added to the prefiltered water by a feeder as the prefiltered water flows passed or through the feeder. Alternatively, the chemical additive may be added by the prefiltration unit at step 604.

At a step 616, the prefiltered water (with or without the chemical added) may flow through a membrane element. The membrane element may filter the prefiltered water, thereby producing a membrane permeate and a retentate. The retentate may be discharged from the water treatment system via a retentate line.

At a step 618, the membrane permeate may flow from the membrane element into a top portion of the tank, where the membrane permeate, or a portion thereof, may be optionally stored.

At a step 620, the membrane permeate may flow from the top portion of the tank to a POU via an outlet of the water treatment system. Additionally, or alternatively, the membrane permeate may flow directly to the POU at step 620 and bypass the tank at step 618. The membrane permeate may flow directly out of the outlet to the POU if, for example, water consumption is high. Whether the membrane permeate flows to the top of the tank or directly to the POU via the outlet may be determined by changes in pressure in the various lines.

In some embodiments, the membrane permeate may optionally flow past a mineralization unit which may re-mineralize the membrane permeate before the membrane permeate exits the water treatment system via the outlet.

At a step 622, one or more sensors may sense that water consumption has stopped, and water is no longer exiting the water treatment system via the outlet. The sensors may be in communication with the controller and may communicate with the controller when the water consumption has stopped.

At a step 624, when the controller receives a communication that the water consumption has stopped, the controller may open and/or close one or more valves in the water treatment system to direct the prefiltered water out of the bottom portion of the tank. The prefiltered water the flows to the membrane element to be processed into membrane permeate.

At a step 626, the membrane permeate that may be produced from the processing of the prefiltered water from the tank, may flow into the top portion of the tank for optional storage, and any retentate may be discharged from the water treatment system via the retentate line.

At a step 628, the one or more sensors may sense that all or most of the prefiltered water previously stored in the tank is no longer in the tank.

Optionally, the system may activate a step 630 wherein the system implements cleaning cycle to extend the health and lifetime of membrane element. In some instances, the cleaning cycle may comprise physical cleaning processes and/or chemical cleaning processes. The physical cleaning processes may include a membrane flush process, a membrane rinse process, and/or a membrane soak process using feed water or permeate water. Chemical processes may include membrane flush, rinse, soak, or clean-in-place processes using a chemical additive. In some instances, the chemical additive introduced by the feeder may include a chelation agent, a polyphosphate compound, and/or an acidic compound. In some instances, the chemical additive can be incorporated into a cleaning cycle including a membrane flush, rinse, soak, or clean-in-place process.

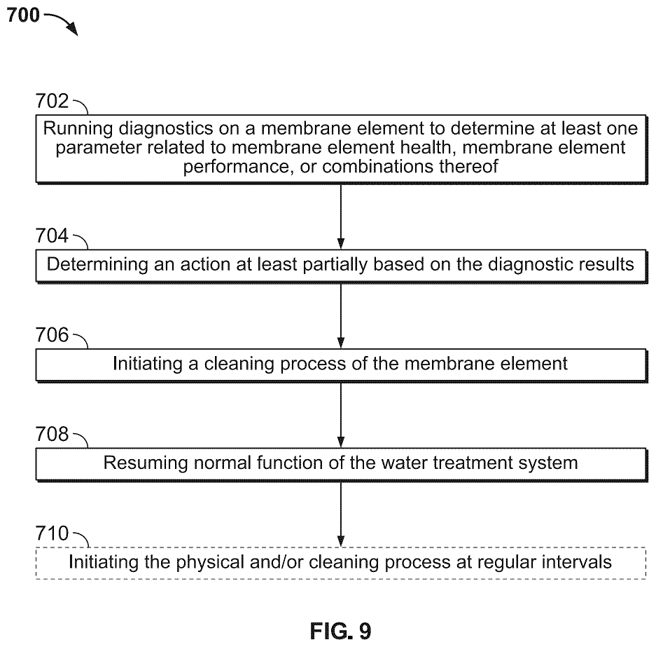

Referring to FIG. 9, a flowchart of an embodiment of a method 700 for extending membrane element lifetime and health in a water treatment system (e.g., a residential saltless water treatment system) is provided. The method 700 may include a step 702 of running diagnostics to determine membrane element health and performance. The method 700 can include a step 704 of choosing an action depending on the diagnostic results. The method 700 can include a step 706 of initiating a cleaning process of the membrane element. The method 700 may include a step 708 of resuming the normal function of the water treatment system. The method 700 may also include a step 710 of initiating a physical cleaning process and/or chemical cleaning process (e.g., initiating a permeate membrane flush) of the membrane element.

In some instances, the membrane element comprises an RO membrane element or an NF membrane element as described with reference to FIGS. 2, 3A-3C, and 4A-4E. The step 702 can be applied to the water treatment systems 200 and 300 as described with reference to FIGS. 2, 3A-3C, and 4A-4E.

In various instances, in order to monitor the health of the membrane element, diagnostic testing can be employed to determine when the membrane element needs to be replaced or when to initiate a physical cleaning process and/or chemical cleaning process. The step 702 may including running a diagnostic based on at least one parameter associated with the performance of the water treatment system, where the chosen parameter may be related to the health and life of the membrane element within the water treatment system. For example, the at least one parameter may be related to the salinity of the water passing through the membrane, as the amount of salt passing through the membrane may be related to a rate at which the membrane fouls. Further, the at least one parameter may be measured at any point during the operation of the water treatment system. In some instances, the at least one parameter may be measured multiple times, such that a value of the parameter at any given point in time may be compared to a historic value of the at least one parameter. Additionally, in certain instances, each measured value of the at least one parameter may be collected to form a historic record of the parameter over time. In some instances, the at least one parameter may include more than one parameter (e.g., a first parameter and a second parameter).

In various instances, the step 702 of running diagnostics comprises measuring flux across the membrane element, measuring membrane TDS output, measuring the characteristics of the feed water, measuring membrane rejection, measuring membrane pressure upstream of the membrane element, and measuring an RTD. In some instances, the step 702 of running diagnostics includes measuring various parameters of the at least one parameter using one or more sensors, in which the one or more sensors are placed in the inlet line, additive line, membrane feed line, permeate line, retentate line, and/or the outlet line. In some cases, the sensors can be provided as TDS sensors, flowmeters, temperature sensors, or pH sensors.

In some instances, the step 702 of running diagnostics comprises measuring the flux across the membrane. The flex may be determined by measuring the permeate flow out of the membrane element 234, 334 using, e.g., flowmeters 208b, 214c, 314a, 314b in conjunction with a measurement of the feed pressure provided to the membrane element. In some cases, the determined membrane flux can decrease over time as the membrane element becomes fouled or scaled. In some instances, if the determined membrane flux has decreased by at least about 25% from the initial flux value, or at least about 30% from the initial flux value, or at least about 35% from the initial flux value, or at least about 40% from the initial flux value, or at least about 45% from the initial flux value, or at least about 50% from the initial flux value, or at least about 55% from the initial flux value, or at least about 60% from the initial flux value, or at least about 65% from the initial flux value, or at least about 75% from the initial flux value, a clean-in-place process or another cleaning process can be initiated. In other instances, if the determined membrane flux has decreased by at least 25% from the initial flux value, or at least 30% from the initial flux value, or at least 35% from the initial flux value, or at least 40% from the initial flux value, or at least 45% from the initial flux value, or at least 50% from the initial flux value, or at least 55% from the initial flux value, or at least 60% from the initial flux value, or at least 65% from the initial flux value, or at least 75% from the initial flux value, a clean-in-place process or another cleaning process can be initiated. In some instances, the clean-in-place process may be similar to the clean-in-place process described with reference to FIGS. 4A-4E.

In some instances, the step 702 of measuring membrane output comprises measuring a determined pressure curve, along with the outlet flow measured to the home or end user, since the length of time of the use cycle can be compared to the volume of the tank 218, 318 and the flow of water to the home or end user during the cycle. Therefore, an average output of the membrane can be determined by a simple mass balance.

In some instances, the step 702 of measuring characteristics of the feed water comprises measuring membrane element feed pressure. In turn, the step 702 may include monitoring the pressure of the water stream provided to the membrane element 234, 334 using pressure sensors 206a, 306a and analyzing obtained data using the control system 400. The control system 400 may use the obtained data to create a pressure curve to estimate the membrane productivity. The feed water pressure can change during the membrane element generation cycle, as the membrane flux can be higher when treating water with low dissolved solids than when treating water with higher dissolved solids.

In various instances, once the higher mineral content water in the tank has been processed through the membrane element and the pump has begun to draw already processed water back into the membrane element, the pressure at the membrane feed can drop. This drop in pressure can be used to alert the system that the water processing step is complete, and the pump can be turned off. In some instances, the pressure curve determined during the processing cycle can be used to determine membrane health and possible fouling. The pressure at the membrane element during the processing of clean or low TDS water can be used to determine the degree of contamination of the membrane surface, and thus the loss of membrane flux.

In some cases, the step 702 of measuring membrane life or health may include determining the membrane rejection and/or the proportion of salt that passes through the membrane element. Measuring membrane rejection and/or the salt passage rate may include measuring the TDS concentration of the inlet water and comparing the TDS concentration of the inlet water to the TDS concentration of the permeate over time. In some instances, when the salt passage increases by about 50% to about 100% from an initial value when comparing the TDS concentration of the inlet water to the TDS concentration of the permeate water (or when the membrane rejection drops below about 60% to about 95%, or below about 70% to about 90%, or below about 80% to about 90%), the membrane element may need to be flushed or otherwise cleaned. For example, the initial value of salt passage through an RO membrane can be about 5%, and a measured value of salt passage of about 7.5% or about 10% may indicate that the RO membrane needs cleaning. As an additional example, the initial value of salt passage through an NF membrane can be about 20%, and a measured value of salt passage of about 30% or about 40% may indicate that the NF membrane needs cleaning. After cleaning, if the flux is still high while the salt passage has increased by at least about 50% to at least about 100% of the initial value (or when the membrane rejection drops below about 60% to about 95%, or below about 70% to about 90%, or below about 80% to about 90%), the controller 402 may determine that the membrane element has become damaged and needs to be replaced.

In some instances, the step 702 of measuring RTD includes providing a chemical tracer to the incoming water flow from a feeder or any conduits positioned upstream of the feeder, including a prefiltered permeate line, an additive line, or the inlet line. The retentate may be monitored to determine when the chemical tracer elutes from the membrane element. In some instances, the chemical tracer may comprise introducing a pulse of a dissolved salt (e.g., sodium chloride) and the retentate water can be monitored with a TDS sensor or dissolved solids meter, provided that the water used has a relatively low content of other dissolved solids. In various instances, the RTD testing can be incorporated into the permeate flush cycle, where low dissolved solids water from the treated tank can be introduced into the membrane element. In certain instances, pulse spread or change in elution time may be a function of a size of the membrane element and/or an overall size of the system.

In some cases, the RTD testing can use a photoreactive chemical or dye as a chemical tracer instead of a dissolved salt. A photoelectric cell can be used to measure the concentrate curves and, in some instances, could be positioned within or coupled to the permeate line after the membrane element. In some instances, using a photoelectric cell may allow independent measurement of other dissolved minerals and can measure the concentrate curves with higher accuracy compared to chemical tracers including salt forms.

In some instances, various parameters of the membrane elements can be determined by comparing the feed/inlet pulse of the chemical tracer to the time/shape of the concentrate curve once the solute elutes compared to the permeate curve of the solute. The parameter values determined may include the mean residence time, the variance, the feed volume, the dead volume, and the membrane rejection. The parameter values can then be used to determine conditions negatively impacting membrane health including feed channel narrowing, uneven flow distribution in the membrane element and membrane fouling.

In some instances, the action of the step 704 may include initiating a physical cleaning process and/or chemical cleaning process. For example, the action may include initiating a physical cleaning process; initiating a chemical cleaning process; maintaining normal function of the water treatment system; resuming normal function of the water treatment system; initiating the physical cleaning process at regular intervals; and initiating the chemical cleaning process at regular intervals. The step 704 can also comprise choosing to replace the membrane element and proceeding to the step 708.

In various instances, the step 710 may include initiating a physical cleaning process and/or chemical cleaning process at regular or predetermined intervals (e.g., predetermined time intervals, predetermined numbers of RO cycles). The physical cleaning processes and/or chemical cleaning processes may include mechanical, temperature, and/or time-based cleaning techniques. The physical cleaning processes may include a membrane flush process, a membrane rinse process, and/or a membrane soak process using feed water or permeate water. The chemical processes may include a membrane flush, rinse, soak, or clean-in-place processes using a chemical additive. The chemical additive may comprise a chelation agent, a polyphosphate compound, an acidic compound, an anti-scaling agent, and/or a prebiotic. In various cases, the methods for physical and chemical cleaning processes are described with reference to the systems and methods of FIGS. 1, 2, 3A-3C, and 4A-4E.

In certain instances, the methods described herein (e.g., the methods 600, 700) may include fewer steps or additional steps than explicitly recited. In addition, the steps of the methods described herein may be performed in any order. Further, any of the steps provided in the methods described herein may be omitted.

Further, in some instances, one or more of the above processes or methods may use machine learning (ML), artificial intelligence (AI), or similar techniques, to iteratively train the controller(s) described above (e.g., the controller 402). The iterative training of the controller may improve the performance of the system based on one or more feedback parameters, characteristics, or similar. For example, in some instances, ML/AI may be used to predict when the performance of the membrane element may be improved by cleaning. In other instances, ML/AI can be used to determine or predict when the pump may need to be activated and/or how long the pump should be activated, such that the pump may be operated more efficiently. This can be beneficial for overall efficiency of the water treatment system.

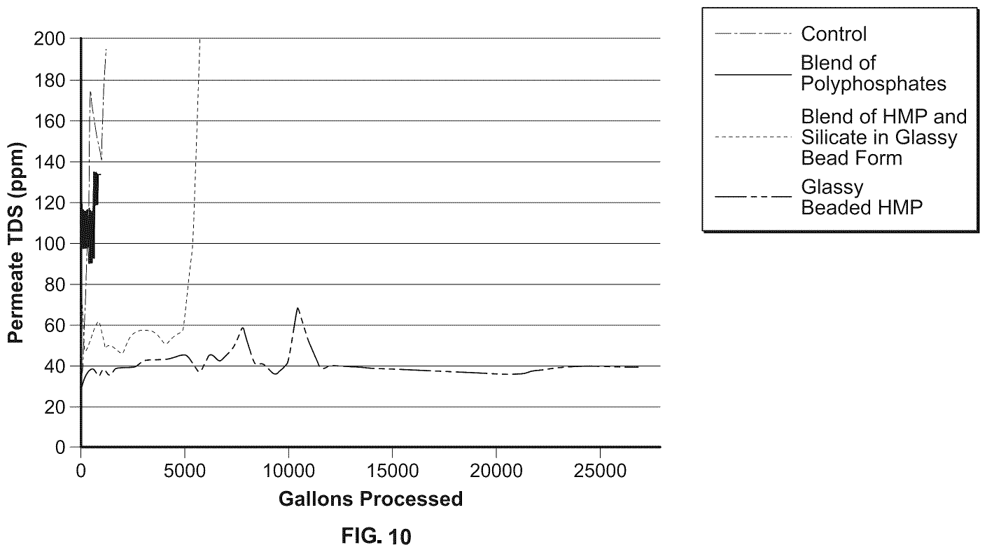

Turning to FIG. 10, performance of a membrane within a RO membrane element was monitored as various polyphosphates were dosed to the water provided to the membrane. Specifically, FIG. 10 depicts the volume of water processed by the membrane element 234, 334 (in gallons) versus the TDS content of the water when glassy beaded HMP, a blend of HMP and silicate in glassy form, and a blend of polyphosphates were used. MRS-600 units were operated using artificially prepped water imparted with a hardness value of 200 ppm, and the artificially prepped water was introduced to the membrane at a rate of 600 gallons per day (gpd) (approximately 2270 liters per day) under cyclical operational conditions (i.e., 4-minute tank emptying and 9-minute tank filling). Additionally, transmembrane pressure and outlet TDS were regularly monitored to track performance, as well as the inlet side total phosphate. Failure was defined as when the TDS value of the permeate rapidly increased. FIG. 10 shows that the blend of polyphosphates failed at 800 gallons (approximately 3030 liters), which was worse than the failure point of the control (1000 gallons, or approximately 3790 liters). The blend of HMP and silicate in glassy bead form performed better, with a failure point near 5000 gallons (approximately 18,930 liters). The glassy beaded HMP prevented membrane failure up to more than about 25000 gallons (approximately 94,640 liters) processed, at which time the experiment was terminated.

In some instances, the polyphosphate products can be characterized using the NACE method TM0374-2016-G which measures the polyphosphate's absolute ability to keep calcium in solution under scaling conditions of a calcium concentration of 599 mg/L provided at 70° C. for 24 hours. The results were relative to a blank control, in both calcium carbonate and calcium sulfate brines. Test water was imparted with polyphosphate concentrations of 1 ppm and 20 ppm and said test waters were tested to gauge calcium sensitivity. Table 2 shows that glassy beaded HMP is the most effective under scaling conditions of a calcium concentration of 599 mg/L provided at 70° C. for 24 hours and is more effective at 1 ppm. Additionally, Table 4 shows that glassy-beaded HMP has very high affinity for calcium.

TABLE 2

Percent Inhibition

| Polyphosphate Type | Dosage | CaCO₃ | CaSO₄ |
|---|---|---|---|
| Glassy beaded HMP | 1 ppm | 99.5% | 95.7% |
| | 20 ppm | 58.4% | 39.1% |
| Blend of HMP and | 1 ppm | 32.3% | 9.9% |
| silicate in glassy bead | 20 ppm | 57.1% | 85.6% |
| form | | | |
| Blend of | 1 ppm | 32.3% | 21.9% |
| polyphosphates | 20 ppm | 57.1% | 81.9% |

As mentioned above, the water treatment system (100, 200, 300) may include one or more RO membranes, which may be spiral wound RO membranes having feed spacers imparted with a certain thickness and/or structure. Through testing, thinner feed spacers (e.g., feed spacers imparted with a thickness of about 17 mil or less) have been found to have several unexpected benefits.

Table 3 provides test results of spiral wound 4040 RO membranes, each RO membrane including feed spacers having a diamond-shaped structure but a different feed spacer thickness. Specifically, the spiral would 4040 RO membranes had diamond-shaped feed spacers with a thickness of 34 mil, 17 mil, and 13 mil. The RO membranes were evaluated to determine the rate at which they rejected unwanted components of inlet water (i.e., total dissolved solids and ions increasing water hardness) and the volume of permeate output (i.e., the permeate flux). The RO membrane having 34 mil feed spacer thickness was provided as a comparator for the RO membranes having 17 mil and 13 mil feed spacer thicknesses. The test was performed under 120 pounds per square inch (PSI) of pressure and at an 80% water recovery. Table 3 shows that by reducing the thickness of the feed spacer (e.g., to 17 mil or less) the membrane permeate output drastically improved while the TDS and hardness rejection of the RO membrane remained relatively constant. While a spiral wound 4040 RO membrane with a thinner feed spacer has more surface area, so an increase in membrane permeate output is to be expected, the increase in membrane permeate output was a magnitude much larger than the relative increase in surface area caused by using the thinner feed spacers (e.g., a membrane permeate output increase of 146% versus a surface area increase of 43% for 17 mil and a membrane permeate output increase of 163% versus a surface area increase of 54% for 13 mil). Without being bound to a particular theory, it is believed that the increased performance in membrane permeate production can be attributed to the higher feed and retentate velocity induced in the water by passing the water through the thinner feed spacer channels. In addition, the thinner feed spacers consist of a diamond-shaped structure which has a smaller unit size than larger feed spacers. Without being bound to a particular theory, it is believed that the smaller unit size of the diamond-shaped feed spacers creates a higher density of turbulizing features, which reduces the concentration of ions on the membrane surface. The improved membrane performance (e.g., an increase in permeate production with a relatively small increase in the surface area) is a unique result that only occurs at high water recoveries (e.g., 80% recovery or higher).

TABLE 3

| Feed Spacer Size | 34 mil | 17 mil | 13 mil |
|---|---|---|---|
| TDS rejection % | 93.3 | 91.8 | 92.1 |
| Hardness rejection % | 96.6 | 97.6 | 96.2 |
| Permeate flow, gallons per | 1.23 | 3.02 | 3.24 |
| minute (GPM) | | | |
| Permeate flow increase | Control | 146% | 163% |
| Surface Area, square feet (ft²) | 78.5 | 112 | 121 |
| Surface Area Increase | Control | 43% | 54% |

As described with reference to the water treatment systems 200, 300 (e.g., see FIGS. 2-4E), in some instances the chemical additive introduced by the feeder 228, 328 may include glassy beaded HMP, a blend of HMP and silicate in glassy form, and/or a blend of polyphosphates.

Various polyphosphates can have different dissolution rates. All polyphosphates are highly soluble in water, but the rate at which they dissolve can at least partially depend on their form, molecular weight, and binder matrix. For example, it was determined that after an overnight dwell in 1 L of deionized water, using 10 grams each of glassy beaded HMP, a blend of HMP and silicate in glassy bead form, and blend of polyphosphates, the solutions had a solubility of 20 mg/L, 200 mg/L and >10000 mg/L total phosphate, respectively.

Turning to FIG. 10, performance of a membrane within a RO membrane element was monitored as various polyphosphates were dosed to the water provided to the membrane. Specifically, FIG. 10 depicts the volume of water processed by the membrane element 234, 334 (in gallons) versus the TDS content of the water when glassy beaded HMP, a blend of HMP and silicate in glassy form, and a blend of polyphosphates were used. MRS-600 units were operated using artificially prepped water imparted with a hardness value of 200 ppm, and the artificially prepped water was introduced to the membrane at a rate of 600 gallons per day (gpd) (approximately 2270 liters per day) under cyclical operational conditions (i.e., 4 minute tank emptying and 9 minute tank filling). Additionally, transmembrane pressure and outlet TDS were regularly monitored to track performance, as well as the inlet side total phosphate. Failure was defined as when the TDS value of the permeate rapidly increased. FIG. 10 shows that the blend of polyphosphates failed at 800 gallons (approximately 3030 liters), which was worse than the failure point of the control (1000 gallons, or approximately 3790 liters). The blend of HMP and silicate in glassy bead form performed better, with a failure point near 5000 gallons (approximately 18,930 liters). The glassy beaded HMP prevented membrane failure up to more than about 25000 gallons (approximately 94,640 liters) processed, at which time the experiment was terminated.

In some instances, the polyphosphate products can be characterized using the NACE method TM0374-2016-G which measures the polyphosphate's absolute ability to keep calcium in solution under scaling conditions of a calcium concentration of 599 mg/L provided at 70° C. for 24 hours. The results were relative to a blank control, in both calcium carbonate and calcium sulfate brines. Test water was imparted with polyphosphate concentrations of 1 ppm and 20 ppm and said test waters were tested to gauge calcium sensitivity. Table 4 shows that glassy beaded HMP is the most effective under scaling conditions of a calcium concentration of 599 mg/L provided at 70° C. for 24 hours and is more effective at 1 ppm. Additionally, Table 4 shows that glassy beaded HMP has very high affinity for calcium.

TABLE 4

Percent Inhibition

| Polyphosphate Type | Dosage | CaCO₃ | CaSO₄ |
|---|---|---|---|
| Glassy beaded HMP | 1 ppm | 99.5% | 95.7% |
| | 20 ppm | 58.4% | 39.1% |
| Blend of HMP and | 1 ppm | 32.3% | 9.9% |
| silicate in glassy bead | 20 ppm | 57.1% | 85.6% |
| form | | | |
| Blend of | 1 ppm | 32.3% | 21.9% |
| polyphosphates | 20 ppm | 57.1% | 81.9% |

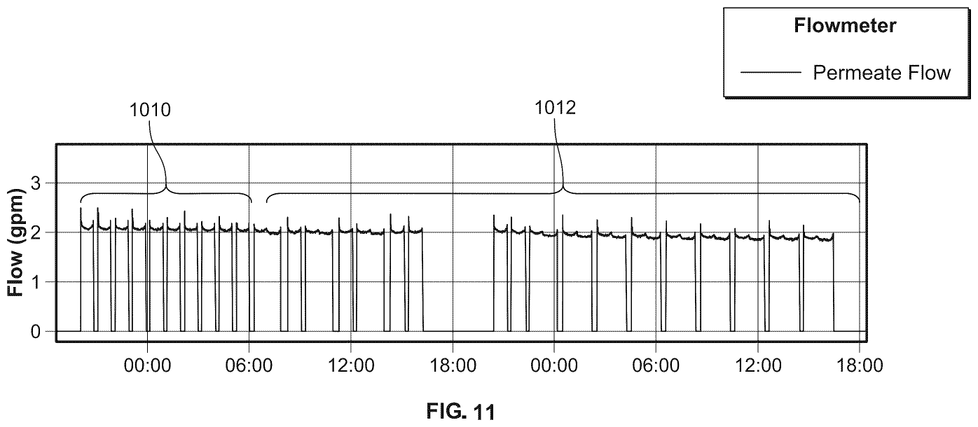

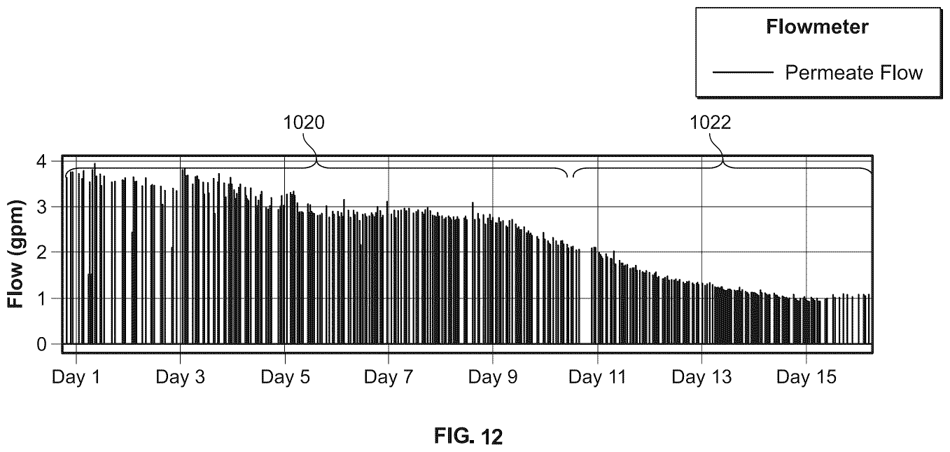

FIGS. 11 and 12 demonstrate that consistent permeate flushing can maintain a desired permeate flow rate. Consistent flushing can be defined as flushing that is repeated at defined time intervals or after a set number of water processing operations. FIG. 11 depicts the permeate flow rate (in gallons per minute (GPM)) of a water treatment system during a first time period 1010 wherein the flush process is consistent as compared to a second time period 1012 wherein the flush process is inconsistent (i.e., not regularly provided or not provided at all). It was determined that, when the permeate flush was consistently applied as in the first time period 1010, no substantial decline in the permeate flow rate was observed. However, when the permeate flush between processing cycles is inconsistent, as in the second time period 1012, the permeate flow consistently decreases over time.

FIG. 11 depicts the permeate flow rate in another system installation during a first time period 1020 wherein the flush process is consistent compared to a second time period 1022 when a flush process was not used. Subsequently, the non-use of flushing during the second time period 1022 led to a rapid decline of the permeate flow rate compared to when the system was flushing at regular intervals during the first time period 1020. Thus, FIGS. 10 and 11 illustrate that flushing the membrane element surface with solution can be beneficial for membrane health. If the flush is not maintained at regular intervals, especially when operating the membrane element at high recovery, then a decline in permeate flow rate can result.

Various properties of the water treatment systems and methods described with reference to FIGS. 1-12 were described in association with one or more values or one or more ranges of values. It is to be understood that each property described herein with reference to numerical values or ranges may be imparted with a discrete value, or a range of values, consistent with all values recited with reference to said property. In addition, each property described herein with reference to numerical values or ranges may be imparted with a discrete value, or range of values, falling within any minimum and maximum value or range recited with reference to said property.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

1. A water treatment system comprising:
a source of an inlet water;
a prefiltration unit in fluid communication with the source, the prefiltration unit designed to provide a prefiltered water to a prefiltered water line;
a feeder in fluid communication with the prefiltered water line downstream of the prefiltration unit, wherein the feeder is designed to deliver a chemical additive to the prefiltered water;
a pump in fluid communication with the prefiltered water line and a permeate flush line, the pump designed to increase a flow rate of water in a membrane feed line; and
a membrane element including an inlet that is in fluid communication with the pump via the membrane feed line, wherein the membrane element produces a permeate comprising water imparted with a first concentration of solutes and a retentate comprising water imparted with a second concentration of solutes.

2. The water treatment system of claim 1 further including:
a first sensor in fluid communication with the source, wherein the first sensor is designed to measure a first parameter of the inlet water;
a second sensor in fluid communication with the membrane element, wherein the second sensor is designed to measure a second parameter of the permeate; and
a controller in communication with the first sensor and the second sensor, the controller designed to receive the first parameter and the second parameter,
wherein the controller determines whether to initiate a chemical cleaning or a physical cleaning of the membrane element based at least partially on the first parameter and the second parameter,
wherein each of the chemical cleaning and the physical cleaning is designed to mitigate membrane fouling.

3. The water treatment system of claim 2, wherein:
the chemical cleaning of the membrane element is selected from the group consisting of a membrane flush, a membrane rinse, a membrane soak, a clean-in-place process, and combinations thereof,
the controller directs delivery of the chemical additive to the membrane element during the chemical cleaning of the membrane element,
the controller directs delivery of the permeate to the inlet of the membrane element during the chemical cleaning of the membrane element.

4. The water treatment system of claim 1, wherein the feeder is designed to provide the chemical additive during a chemical cleaning of the membrane element, and the chemical additive is selected from the group consisting of a polyphosphate compound, a chelating agent, an acidic compound, an antiscalant compound, a caustic compound, an oxidizing compound, a prebiotic, an enzymatic cleaner, and combinations thereof.

5. The water treatment system of claim 1, wherein:
the permeate flush line is in fluid communication with the membrane feed line,
a valve is in fluid communication with the permeate flush line,
the valve is designed to selectively provide the permeate to the inlet of the membrane element during a physical cleaning and a chemical cleaning of the membrane element.

6. The water treatment system of claim 1 further including a controller designed to initiate a physical cleaning of the membrane element, wherein the physical cleaning is selected from the group consisting of a membrane flush, a membrane rinse, a membrane soak, and combinations thereof.

7. The water treatment system of claim 6 further comprising a valve in fluid communication with the membrane element and the permeate flush line, wherein at least one of the pump and the valve provides a high-velocity water stream to the membrane element during the membrane flush.

8. The water treatment system of claim 6 further comprising a valve in fluid communication with the membrane element and the permeate flush line, wherein at least one of the pump and the valve provides a pulsed water stream to the membrane element during the membrane flush.

9. A water treatment system comprising:
a source of untreated water in fluid communication with an inlet line of the water treatment system;
a pump in fluid communication with the source of untreated water;
a membrane element in fluid communication with the pump via a membrane feed line, the membrane element configured to produce a permeate stream and a retentate stream, wherein the permeate stream is provided to a permeate line and the retentate stream is provided to a retentate line;
an outlet line in fluid communication with the permeate line;
a first sensor in fluid communication with the membrane element, the first sensor configured to sense a first parameter corresponding to a health of the membrane element; and
a controller in electrical communication with the first sensor, wherein the controller is configured to initiate a cleaning of the membrane element.

10. The water treatment system of claim 9, wherein the controller is configured to initiate the cleaning of the membrane element when the first parameter crosses a threshold value, and the threshold value is indicative of membrane fouling.

11. The water treatment system of claim 9, wherein the cleaning of the membrane element comprises a membrane flush provided as a high-velocity water stream to the membrane element through the membrane feed line.

12. The water treatment system of claim 9, wherein:
the cleaning of the membrane element comprises a soak of the membrane element,
the soak includes providing an aqueous solution to the membrane element through the membrane feed line,
the aqueous solution comprises at least one of low TDS water, prefiltered water, untreated water, permeate water, and water dosed with a chemical additive.

13. The water treatment system of claim 9 further including a retentate valve configured to control a flow of the retentate stream provided from the water treatment system, wherein the retentate valve is designed to selectively increase a flow rate of water through the membrane element.

14. The water treatment system of claim 9, wherein the controller is configured to initiate the cleaning of the membrane element when the first parameter crosses a threshold value, and the first parameter is selected from the group consisting of a membrane element flux, a TDS output of the membrane element, a membrane rejection value, a membrane salt passage value, a pressure upstream of the membrane element, an RTD value, and combinations thereof.

15. The water treatment system of claim 9 further including:
a prefiltration unit positioned downstream of the source of untreated water and upstream of the membrane element; and
a tank downstream of the membrane element,
wherein the tank is configured to store prefiltered water from the prefiltration unit and the permeate stream from the membrane element.

16. The water treatment system of claim 15 further including:
a permeate flush line in fluid communication with the tank and the membrane element; and
a valve in fluid communication with the permeate flush line,
wherein the controller is configured to actuate the valve to provide permeate to the membrane element during the cleaning of the membrane element.

17. The water treatment system of claim 9, wherein the cleaning of the membrane element includes providing a chemical additive to the membrane element, and the chemical additive is selected from the group consisting of a polyphosphate compound, a chelating agent, an acidic compound, an antiscalant compound, a caustic compound, an oxidizing compound, a prebiotic, an enzymatic cleaner, and combinations thereof.

18. A method of treating water, the method comprising:
providing a water treatment system including a membrane element;
performing diagnostics at a first time period to determine a membrane element performance, thereby determining a first diagnostic result;
performing diagnostics at a second time period to determine the membrane element performance, thereby determining a second diagnostic result; and
choosing an action depending on at least one of the first diagnostic result and the second diagnostic result, wherein the action comprises at least one of:
initiating a physical cleaning process;
initiating a chemical cleaning process;
maintaining normal function of the water treatment system;
resuming normal function of the water treatment system;
initiating the physical cleaning process at regular intervals; and
initiating the chemical cleaning process at regular intervals.

19. The method of claim 18, wherein performing diagnostics comprises at least one of measuring flux across the membrane element, measuring TDS output of the membrane element, measuring characteristics of water provided to the membrane element, measuring membrane rejection, measuring pressure upstream of the membrane element, and determining an RTD value.

20. The method of claim 18, wherein initiating the physical cleaning process and initiating the chemical cleaning process each comprise utilizing mechanical cleaning techniques, temperature-based cleaning techniques, and time-based cleaning techniques.
